(19) United States
(12) Patent Application Publication
(10) Pub. No.: US 2023/0307634 A1
(43) Pub. Date: Sep. 28, 2023

(54) LITHIUM ION BATTERY, ELECTRONIC DEVICE, AND VEHICLE

(71) Applicant: SEMICONDUCTOR ENERGY LABORATORY CO., LTD., Atsugi-shi (JP)

(72) Inventors: Jo SAITO, Atsugi-shi (JP); Kaori OGITA, Isehara (JP); Yohei MOMMA, Isehara (JP); Kazutaka KURIKI, Ebina (JP); Shuhei YOSHITOMI, Ayase (JP); Yasuhiro JINBO, Isehara (JP); Tetsuya KAKEHATA, Isehara (JP); Shunpei YAMAZAKI, Tokyo (JP)

(21) Appl. No.: 18/190,365

(22) Filed: Mar. 27, 2023

(30) Foreign Application Priority Data
Mar. 28, 2022 (JP) 2022-052082

(51) Int. Cl. H01M 4/525; H01M 10/0525; H01M 10/0569; H01M 4/131

(52) U.S. Cl. CPC H01M 4/525; H01M 10/0525; H01M 10/0569; H01M 4/131; H01M 2300/004

(57) ABSTRACT

A lithium ion battery having excellent charge characteristics and discharge characteristics even in a low-temperature environment is provided. The lithium ion battery includes a positive electrode active material and an electrolyte. The positive electrode active material contains cobalt, oxygen, magnesium, aluminum, and nickel. The electrolyte contains lithium hexafluorophosphate, ethylene carbonate, ethyl methyl carbonate, and dimethyl carbonate. Second discharge capacity of the lithium ion battery is higher than or equal to 70% of first discharge capacity. The first discharge capacity is obtained by performing first charge and first discharge at 20° C., and the second discharge capacity is obtained by performing second charge and second discharge at −40° C. The first discharge and the second discharge are constant current discharge with 20 mA/g per positive electrode active material weight.

### BACKGROUND OF THE INVENTION

### 1. Field of the Invention

The invention disclosed in this specification and the like (hereinafter sometimes referred to as “the present invention” in this specification and the like) relates to a power storage device, a secondary battery, and the like. In particular, the present invention relates to a lithium ion battery.

The present invention relates to an object, a method, or a manufacturing method. The present invention relates to a process, a machine, manufacture, or a composition of matter. The present invention relates to a semiconductor device, a display device, a light-emitting device, a power storage device, a lighting device, an electronic device, a vehicle, or a manufacturing method thereof.

### 2. Description of the Related Art

In recent years, a variety of power storage devices such as lithium ion batteries, lithium ion capacitors, and air batteries have been actively developed. In particular, demand for lithium ion batteries with high output and high energy density has rapidly grown with the development of the semiconductor industry, for portable information terminals such as mobile phones, smartphones, and laptop computers; portable music players; digital cameras; medical equipment; electric motor vehicles such as hybrid vehicles (HVs), electric vehicles (EVs), and plug-in hybrid vehicles (PHVs); and the like. The lithium ion batteries are essential for today's information society as rechargeable energy supply sources.

In a lithium ion battery, charge characteristics and/or discharge characteristics change depending on a charging environment and/or a discharging environment of the battery. For example, it is known that the discharge capacity of a lithium ion battery changes depending on a discharge temperature.

Thus, a lithium ion battery having excellent battery characteristics even in a low-temperature environment is required (e.g., see Patent Document 1).

### REFERENCE

[Patent Document 1] Japanese Published Patent Application No. 2015-026608

### SUMMARY OF THE INVENTION

Patent Document 1 describes that a lithium ion battery capable of operating even in a low-temperature environment (e.g., 0° C. or lower) can be obtained with the use of the nonaqueous solvent described in Patent Document 1. However, even the lithium ion battery described in Patent Document 1 does not have a high charge capacity when discharging in a low-temperature environment at the time of this application, and further improvement is desired.

In order to achieve a lithium ion battery capable of operating even in a low-temperature environment, it is required to develop not only a nonaqueous solvent (electrolyte) but also a positive electrode and a negative electrode suitable for a lithium ion battery capable of operating even in a low-temperature environment. More specifically, in the case of a positive electrode, development of a positive electrode active material suitable for a lithium ion battery capable of operating even in a low-temperature environment is required.

An object of one embodiment of the present invention is to provide a positive electrode active material applicable to a lithium ion battery having excellent discharge characteristics even in a low-temperature environment. Specifically, an object of one embodiment of the present invention is to provide a positive electrode active material applicable to a lithium ion battery with high discharge capacity and/or discharge energy density even when discharging in a low-temperature environment.

Note that in this specification and the like, a low-temperature environment is lower than or equal to 0° C. In the case where a low-temperature environment is stated in this specification and the like, a given temperature lower than or equal to 0° C. can be selected. For example, one selected from lower than or equal to 0° C., lower than or equal to −10° C., lower than or equal to −20° C., lower than or equal to −30° C., lower than or equal to −40° C., lower than or equal to −50° C., lower than or equal to −60° C., lower than or equal to −80° C., and lower than or equal to −100° C. can be selected.

Another object of one embodiment of the present invention is to provide a lithium ion battery having excellent discharge characteristics even in a low-temperature environment. Another object of one embodiment of the present invention is to provide a lithium ion battery having excellent charge characteristics even in a low-temperature environment.

Specifically, an object is to provide a lithium ion battery with high discharge capacity and/or discharge energy density even when discharging in a low-temperature environment (e.g., lower than or equal to 0° C., preferably lower than or equal to −20° C., further preferably lower than or equal to −30° C., still further preferably lower than or equal to −40° C., yet further preferably lower than or equal to −50° C., most preferably lower than or equal to −60° C.). Another object is to provide a lithium ion battery with a low rate of decrease in discharge capacity value when discharging in a low-temperature environment (e.g., lower than or equal to 0° C., preferably lower than or equal to −20° C., further preferably lower than or equal to −30° C., still further preferably lower than or equal to −40° C., yet further preferably lower than or equal to −50° C., most preferably lower than or equal to −60° C.) with respect to the discharge capacity value when discharging at 25° C. Another object is to provide a lithium ion battery with a low rate of decrease in discharge energy density value when discharging in a low-temperature environment (e.g., lower than or equal to 0° C., preferably lower than or equal to −20° C., further preferably lower than or equal to −30° C., still further preferably lower than or equal to −40° C., yet further preferably lower than or equal to −50° C., most preferably lower than or equal to −60° C.) with respect to the discharge energy density value when discharging at 25° C.

Another object is to provide a secondary battery with high charge voltage. Another object is to provide a highly safe or highly reliable secondary battery. Another object is to provide a secondary battery which hardly deteriorates. Another object is to provide a long-life secondary battery. Another object is to provide a novel secondary battery.

Another object is to provide a novel substance, active material, or power storage device or a manufacturing method thereof.

Note that the description of these objects does not preclude the existence of other objects. In one embodiment of the present invention, there is no need to achieve all the objects. Other objects can be derived from the descriptions of the specification, the drawings, the claims, and the like.

One embodiment of the present invention is a lithium ion battery including a positive electrode active material and an electrolyte. The positive electrode active material contains cobalt, oxygen, magnesium, aluminum, and nickel. The electrolyte contains lithium hexafluorophosphate, ethylene carbonate, ethyl methyl carbonate, and dimethyl carbonate. Second discharge capacity of the lithium ion battery is higher than or equal to 70% of first discharge capacity. The first discharge capacity is obtained by performing first charge at 20° C. and then performing first discharge at 20° C. The second discharge capacity is obtained by performing second charge at −40° C. and then performing second discharge at −40° C. Each of the first discharge and the second discharge is performed by constant current discharge with current of 20 mA/g per positive electrode active material weight.

In the lithium ion battery described in the above, the positive electrode active material contains magnesium and aluminum in a surface portion. The surface portion is a region from a surface of the positive electrode active material to a depth of 50 nm. The positive electrode active material preferably includes a region where distribution of magnesium is closer to the surface than distribution of aluminum.

In the lithium ion battery described in any of the above, the positive electrode active material has a layered rock-salt crystal structure of a space group R-3m. The surface portion includes a basal region having a surface of the positive electrode active material parallel to a (001) plane of the layered rock-salt crystal structure, and an edge region having a surface of the positive electrode active material exposed in a direction intersecting with the (001) plane. The edge region contains nickel. Distribution of magnesium and distribution of nickel preferably include a region overlapping with each other in the edge region.

Note that the basal region does not substantially contain nickel in some cases.

In the lithium ion battery described in any of the above, the median diameter of the positive electrode active material is preferably greater than or equal to 1 μm and less than or equal to 12 μm.

In the lithium ion battery described in any of the above, in the electrolyte, the volume ratio of the ethylene carbonate, the ethyl methyl carbonate, and the dimethyl carbonate is preferably x:y:100−x−y (note that 5≤x≤35 and 0<y<65) when a total content of the ethylene carbonate, the ethyl methyl carbonate, and the dimethyl carbonate is 100 vol %.

In the lithium ion battery described in any of the above, the electrolyte preferably contains the lithium hexafluorophosphate of more than or equal to 0.5 mol/L and less than or equal to 1.5 mol/L with respect to the total content of the ethylene carbonate, the ethyl methyl carbonate, and the dimethyl carbonate.

Another embodiment of the present invention is an electronic device including the lithium ion battery described in any of the above.

Another embodiment of the present invention is a vehicle including the lithium ion battery described in any of the above.

One embodiment of the present invention can provide a composite oxide (positive electrode active material) applicable to a lithium ion battery having excellent discharge characteristics even in a low-temperature environment. Specifically, a positive electrode active material applicable to a lithium ion battery with high discharge capacity and/or discharge energy density even when discharging in a low-temperature environment can be provided.

One embodiment of the present invention can provide a lithium ion battery with high discharge capacity and/or discharge energy density even when discharging in a low-temperature environment (e.g., lower than or equal to 0° C., preferably lower than or equal to −20° C., further preferably lower than or equal to −30° C., still further preferably lower than or equal to −40° C., yet further preferably lower than or equal to −50° C., most preferably lower than or equal to −60° C.). A lithium ion battery can be provided with a low rate of reduction in discharge capacity value when discharging in a low-temperature environment (e.g., lower than or equal to 0° C., preferably lower than or equal to −20° C., further preferably lower than or equal to −30° C., still further preferably lower than or equal to −40° C., yet further preferably lower than or equal to −50° C., most preferably lower than or equal to −60° C.) with respect to the discharge capacity value when discharging at 25° C. A lithium ion battery can be provided with a low rate of decrease in discharge energy density value when discharging in a low-temperature environment (e.g., lower than or equal to 0° C., preferably lower than or equal to −20° C., further preferably lower than or equal to −30° C., still further preferably lower than or equal to −40° C., yet further preferably lower than or equal to −50° C., most preferably lower than or equal to −60° C.) with respect to the discharge energy density value when discharging at 25° C.

Another embodiment of the present invention can provide a secondary battery with high charge voltage. A highly safe or highly reliable secondary battery can be provided. A secondary battery which hardly deteriorates can be provided. A long-life secondary battery can be provided. A novel secondary battery can be provided.

Another embodiment of the present invention can provide a novel substance, active material, or power storage device or a manufacturing method thereof.

### BRIEF DESCRIPTION OF THE DRAWINGS

In the accompanying drawings:

FIG. 1A is a cross-sectional view illustrating an inner structure of a secondary battery, and FIG. 1B is a cross-sectional view illustrating a positive electrode and an electrolyte of the secondary battery;

FIGS. 2A and 2B are cross-sectional views illustrating a positive electrode active material;

FIGS. 3A to 3F are cross-sectional views illustrating the positive electrode active material;

FIGS. 4A to 4D show formation methods of the positive electrode active material;

FIG. 5 shows a formation method of the positive electrode active material;

FIGS. 6A to 6C show formation methods of the positive electrode active material;

FIGS. 7A to 7D are cross-sectional views illustrating an example of the positive electrode of the secondary battery;

FIG. 8A is an exploded perspective view of a coin-type secondary battery, FIG. 8B is a perspective view of the coin-type secondary battery, and FIG. 8C is a cross-sectional perspective view thereof;

FIG. 9A illustrates an example of a cylindrical secondary battery, FIG. 9B illustrates an example of a cylindrical secondary battery, FIG. 9C illustrates an example of a plurality of cylindrical secondary batteries, and FIG. 9D illustrates an example of a power storage system including a plurality of cylindrical secondary batteries;

FIGS. 10A and 10B illustrate examples of a secondary battery, and FIG. 10C illustrates the internal state of the secondary battery;

FIGS. 11A to 11C illustrate an example of a secondary battery;

FIGS. 12A and 12B illustrate the appearances of a secondary battery;

FIGS. 13A to 13C illustrate a method for fabricating a secondary battery;

FIG. 14A illustrates a structure example of a battery pack, FIG. 14B illustrates a structure example of the battery pack, and FIG. 14C illustrates a structure example of the battery pack;

FIG. 15A is a perspective view of a battery pack of one embodiment of the present invention, FIG. 15B is a block diagram of a battery pack, and FIG. 15C is a block diagram of a vehicle including a battery pack;

FIGS. 16A to 16D illustrate examples of transport vehicles, and FIG. 16E illustrates an example of an artificial satellite;

FIGS. 17A and 17B illustrate power storage devices of one embodiment of the present invention;

FIG. 18A illustrates an electric bicycle, FIG. 18B illustrates a secondary battery of the electric bicycle, and FIG. 18C illustrates a motor scooter;

FIGS. 19A to 19D illustrate examples of electronic devices;

FIG. 20A illustrates examples of wearable devices, FIG. 20B is a perspective view of a watch-type device, and FIG. 20C illustrates a side surface of the watch-type device;

FIG. 21 is a graph showing particle size distribution of lithium cobalt oxide described in Example 1;

FIG. 22 is a graph showing discharge curves of discharge capacity measurement at each temperature described in Example 3; and

FIG. 23 is a graph showing discharge capacity measurement results at −40° C. at each discharge rate described in Example 3.

### DETAILED DESCRIPTION OF THE INVENTION

Embodiments of the present invention will be described in detail with reference to the drawings as appropriate. However, the present invention is not limited to the description below, and it is easily understood by those skilled in the art that modes and details can be modified in various ways without departing from the spirit and scope of the present invention. Therefore, in the embodiments and examples of the present invention described below, reference numerals denoting the same portions are used in common in different drawings.

Furthermore, the embodiments and examples described below can be implemented by being combined with any of the embodiments, examples, and the like described in this specification and the like unless otherwise mentioned.

Electronic devices in this specification and the like refer to every device including a power storage device, and an electro-optical device including a power storage device, an information terminal device including a power storage device, and the like are all electronic devices.

Power storage devices in this specification and the like refers to every element and device having a function of storing electric power. For example, a power storage device (also referred to as a secondary battery) such as a lithium ion battery, a lithium ion capacitor, and an electric double layer capacitor are included.

In this specification and the like, a space group is represented using the short symbol of the international notation (or the Hermann-Mauguin notation). In addition, the Miller index is used for the expression of crystal planes and crystal orientations. An individual plane that shows a crystal plane is denoted by “( )”. In the crystallography, a bar is placed over a number in the expression of space groups, crystal planes, and crystal orientations; in this specification and the like, because of format limitations, crystal planes, crystal orientations, and space groups are sometimes expressed by placing a minus sign (−) in front of a number instead of placing a bar over the number. Furthermore, an individual direction that shows an orientation in crystal is denoted by “[ ]”, a set direction that shows all of the equivalent orientations is denoted by “< >”, an individual plane that shows a crystal plane is denoted by “( )”, and a set plane having equivalent symmetry is denoted by “{ }”. A trigonal system represented by the space group R-3m is generally represented by a composite hexagonal lattice for easy understanding of the structure and is also represented by a composite hexagonal lattice in this specification and the like unless otherwise specified. In some cases, not only (hkl) but also (hkil) is used as the Miller index. Here, i is −(h+k).

In addition, a given integer of 1 or more is represented by h, k, i, or l in some cases. Examples of (001) include (001), (003), and (006).

The space group of a crystal structure is identified by XRD, electron diffraction, neutron diffraction, or the like. Thus, in this specification and the like, belonging to a space group or being a space group can be rephrased as being identified as a space group.

In this specification and the like, a theoretical capacity of a positive electrode active material refers to the amount of electricity obtained when all lithium that can be inserted into and extracted from the positive electrode active material is extracted. For example, the theoretical capacity of LiCoO₂ is 274 mAh/g, the theoretical capacity of LiNiO₂ is 275 mAh/g, and the theoretical capacity of LiMn₂O₄ is 148 mAh/g.

The remaining amount of lithium that can be inserted into and extracted from a positive electrode active material can be represented by x (occupancy rate of Li in lithium sites) in a compositional formula, e.g., LiₓCoO₂. In the case of a positive electrode active material in a secondary battery, x can be represented by (theoretical capacity−charge capacity)/theoretical capacity. For example, when a secondary battery using LiCoO₂ as a positive electrode active material is charged to 219.2 mAh/g, the positive electrode active material can be represented by Li_{0.2}CoO₂, i.e., x=0.2. Note that “x in LiₓCoO₂ is small” means, for example, x≤0.24, and means, for example, 0.1<x≤0.24 in consideration of the practical range of using LiₓCoO₂ as the positive electrode active material of the secondary battery.

Lithium cobalt oxide which almost satisfies the stoichiometric proportion is LiCoO₂ with x of 1. Even after discharge of a secondary battery ends, the lithium cobalt oxide can be called LiCoO₂ with x of 1. In general, in a lithium ion battery using LiCoO₂, the discharge voltage rapidly decreases until the discharge voltage to be 2.5 V. For this reason, in this specification and the like, for example, a state in which voltage becomes 2.5 V (counter electrode is lithium) at current of 100 mA/g or lower is regarded as a state in which discharge ends with x of 1. Accordingly, for example, in order to obtain lithium cobalt oxide with x of 0.2, charge may be performed at 219.2 mAh/g in a state in which discharge ends.

Charge capacity and/or discharge capacity used for calculation of x in LiₓCoO₂ is preferably measured under the condition where there is no influence or small influence of a short circuit and/or decomposition of an electrolyte. For example, data of a secondary battery that is measured while a sudden change in voltage that seems to be derived from a short circuit is not preferably used for calculation of x.

A structure is referred to as a cubic close-packed structure when three layers of anions are shifted and stacked like “ABCABC” in the structure. Accordingly, anions do not necessarily form a cubic lattice structure. At the same time, actual crystals always have a defect and thus, analysis results are not necessarily consistent with the theory. For example, in an electron diffraction pattern or a fast Fourier transform (FFT) pattern of a TEM image or the like, a spot may appear in a position slightly different from a theoretical position. For example, anions may be regarded as forming a cubic close-packed structure when a difference in orientation from a theoretical position is 5° or less or 2.5° or less.

In this specification and the like, a layered rock-salt crystal structure of a composite oxide containing lithium and a transition metal refers to a crystal structure in which a rock-salt ion arrangement where cations and anions are alternately arranged is included and lithium and the transition metal are regularly arranged to form a two-dimensional plane, so that lithium can diffuse two-dimensionally. Note that a defect such as a cation or anion vacancy may exist. In the layered rock-salt crystal structure, strictly, a lattice of a rock-salt crystal is distorted in some cases.

In this specification and the like, a rock-salt crystal structure refers to a structure in which cations and anions are alternately arranged. Note that a cation or anion vacancy may exist.

In this specification and the like, uniformity refers to a phenomenon in which, in a solid made of a plurality of elements (e.g., A, B, and C), a certain element (e.g., A) is distributed with similar nature in specific regions. Specifically, it is acceptable for the specific regions to have substantially the same concentration of the element. For example, a difference in the concentration of the element between the specific regions can be 10% or less. Examples of the specific regions include a surface portion, a surface, a projection, a depression, and an inner portion.

In this specification and the like, segregation refers to a phenomenon in which, in a solid made of a plurality of elements (e.g., A, B, and C), a certain element (e.g., B) is spatially non-uniformly distributed. Alternatively, segregation refers to a state where a concentration of a certain element in a certain region is different from that in other regions, and may be rephrased as uneven distribution, precipitation, unevenness, deviation, a mixture of a high-concentration portion and a low-concentration portion, or the like.

In this specification and the like, a superficial portion of a particle of an active material and the like is, for example, a region of 50 nm or less, preferably 35 nm or less, further preferably 20 nm or less, most preferably 10 nm or less in depth from the surface toward an inner portion. A plane generated by a slipping or a crack can be considered as a surface. In this specification and the like, a region at a position deeper than the surface portion is referred to as an inner portion in some cases. In this specification and the like, a grain boundary refers to a portion where particles adhere to each other, a portion where crystal orientation changes inside a particle (including a central portion), a portion including many defects, a portion with a disordered crystal structure, or the like. The grain boundary can be regarded as a plane defect. The vicinity of a grain boundary refers to a region positioned within 20 nm, preferably 10 nm from the grain boundary. In this specification and the like, particles are not necessarily spherical (with a circular cross section). Other examples of the cross-sectional shapes of particles include an ellipse, a rectangle, a trapezoid, a triangle, a quadrilateral with rounded corners, and an asymmetrical shape, and a particle may have an indefinite shape.

### Embodiment 1

In this embodiment, a lithium ion battery having excellent charge characteristics and discharge characteristics even in a low-temperature environment is described.

### [Lithium Ion Battery]

A lithium ion battery of one embodiment of the present invention includes a positive electrode, a negative electrode, and an electrolyte. In the case where an electrolyte solution is used as the electrolyte, a separator is provided between the positive electrode and the negative electrode. An exterior body covering at least part of peripheries of the positive electrode, the negative electrode, and the electrolyte may be further provided.

In this embodiment, description is made focusing on a structure of a lithium ion battery which is necessary to realize excellent discharge characteristics and/or excellent charge characteristics even in a low-temperature environment (e.g., lower than or equal to 0° C., preferably lower than or equal to −20° C., further preferably lower than or equal to −30° C., still further preferably lower than or equal to −40° C., yet further preferably lower than or equal to −50° C., most preferably lower than or equal to −60° C.). Specifically, a positive electrode active material that is contained in a positive electrode and an electrolyte are mainly described. A method for forming the positive electrode active material contained in a lithium ion battery is described in Embodiment 2, and other structures of the lithium ion battery of one embodiment of the present invention are described in detail in Embodiment 3.

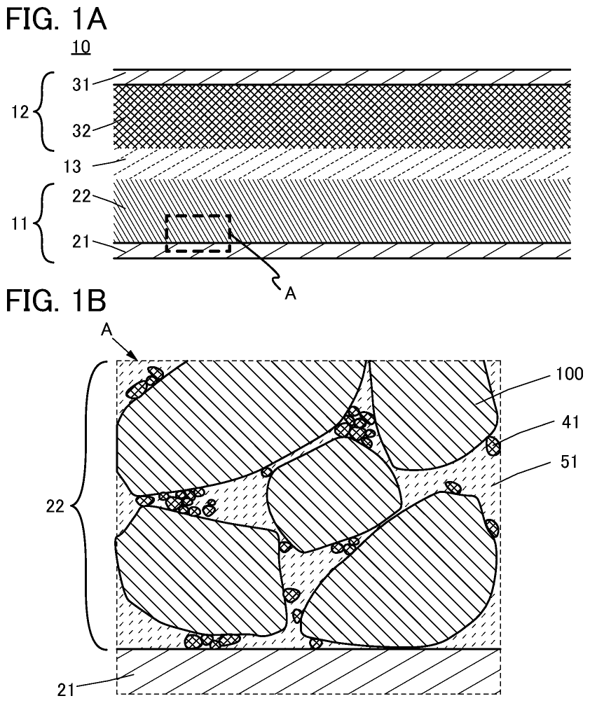

FIG. 1A is a schematic cross-sectional view illustrating an inner structure of a lithium ion battery 10. The lithium ion battery 10 includes a positive electrode 11, a negative electrode 12, and a separator 13. The positive electrode 11 includes a positive electrode current collector 21 and a positive electrode active material layer 22 over the positive electrode current collector 21, and the negative electrode 12 includes a negative electrode current collector 31 and a negative electrode active material layer 32. As illustrated, the positive electrode active material layer 22 and the negative electrode active material layer 32 are provided to face each other with the separator 13 therebetween. Although not illustrated in FIG. 1A, electrolytes are contained in a space included in the positive electrode active material layer 22, a space included in the separator 13, and a space included in the negative electrode active material layer 32.

Note that one positive electrode 11, one negative electrode 12, and one separator 13 are illustrated in FIG. 1A; however, the structure of the lithium ion battery of one embodiment of the present invention is not limited thereto. Two positive electrodes 11, two negative electrodes 12, and two separators 13 may be provided, or more than two of each of the positive electrodes 11, the negative electrodes 12, and the separators 13 may be stacked. Not a stacked-layer structure illustrated in FIG. 1A but a wound structure may be employed.

FIG. 1B is an enlarged view illustrating a portion A surrounded by a dashed line in FIG. 1A.

The positive electrode active material layer 22 contains a positive electrode active material 100 and a conductive material 41. Although not illustrated, the positive electrode active material layer 22 may include a binder other than the positive electrode active material 100 and the conductive material 41.

The space included in the positive electrode active material layer 22 is preferably filled with an electrolyte 51 as illustrated. For example, the proportion of the space included in the positive electrode active material layer 22 filled with the electrolyte 51 is preferably higher than or equal to 60%, further preferably higher than or equal to 70%, still further preferably higher than or equal to 80%, yet further preferably higher than or equal to 90%, yet still further preferably higher than or equal to 95%, most preferably higher than or equal to 99%. Note that the space included in the positive electrode active material layer 22 refers to a region other than a solid component (e.g., a positive electrode active material or a conductive material) in the positive electrode active material layer 22.

Although detailed descriptions are omitted, the space included in the negative electrode active material layer 32 is preferably filled with the electrolyte 51 as in the case of the positive electrode active material layer 22. For example, the proportion of the space included in the negative electrode active material layer 32 filled with the electrolyte 51 is preferably higher than or equal to 60%, further preferably higher than or equal to 70%, still further preferably higher than or equal to 80%, yet further preferably higher than or equal to 90%, yet still further preferably higher than or equal to 95%, most preferably higher than or equal to 99%. Note that the space included in the negative electrode active material layer 32 refers to a region other than a solid component (e.g., a negative electrode active material or a conductive material) in the negative electrode active material layer 32.

By filling with the electrolyte 51 throughout the positive electrode active material layer 22 and the negative electrode active material layer 32 in this manner, a region where the electrolyte and each of the positive electrode active material and a negative electrode active material are in contact with each other can be increased. That is, a lithium ion battery can have excellent charge characteristics and discharge characteristics in a low-temperature environment.

In charge at a low temperature, an energy barrier at the time of extracting lithium ions from a positive electrode active material tends to high. That is, it can be said that overvoltage required for extracting lithium ions from the positive electrode active material becomes larger as the temperature of charging environment becomes lower. That is, the positive electrode active material might be exposed to high voltage (a higher potential than a lithium potential) in charge at a low temperature. In other words, in charge at a low temperature, charge capacity might be decreased when the positive electrode active material is not exposed to high voltage.

Thus, a positive electrode active material that can withstand a high voltage and obtain high charge capacity in charge at a low temperature is preferably used for a positive electrode active material contained in a lithium ion battery having excellent charge characteristics and discharge characteristics even in a low-temperature environment.

For an electrolyte contained in a lithium ion battery having excellent charge characteristics and discharge characteristics in charge and/or discharge (charge and discharge) even in a low-temperature environment, a material with high lithium ion conductivity even in a low-temperature environment (e.g., 0° C., preferably −20° C., further preferably −30° C., still further preferably −40° C., yet further preferably −50° C., most preferably −60° C.) is preferably used.

A positive electrode active material and an electrolyte that are preferable for a lithium ion battery having excellent charge characteristics and discharge characteristics even in a low-temperature environment are described in detail below.

### [Positive Electrode]

The positive electrode includes a positive electrode active material layer and a positive electrode current collector. The positive electrode active material layer contains a positive electrode active material and may further contain at least one of a conductive material and a binder.

### <Positive Electrode Active Material>

The positive electrode active material has functions of taking and releasing lithium ions in accordance with charge and discharge. For a positive electrode active material used as one embodiment of the present invention, a material with less deterioration (or a material with slight increase in resistance) due to charge and/or discharge in a low-temperature environment even at high charge voltage can be used. Specifically, a positive electrode active material (composite oxide) with a particle diameter (strictly, median diameter (D50)) of less than or equal to 12 μm (preferably less than or equal to 10.5 μm, further preferably less than or equal to 8 μm) obtained by the formation method described in Embodiment 1 can be used. This positive electrode active material contains any one or more of an additive element X, an additive element Y, and an additive element Z. Details of the additive elements X, Y, and Z are described in <Contained element>.

Note that when the particle diameter of the positive electrode active material is too small, application might be difficult to perform in the formation of the positive electrode. Alternatively, when the particle diameter of the positive electrode active material is too small, the surface area becomes too large, which might cause an excessive side reaction between a positive electrode active material surface and the electrolyte. Alternatively, when the particle diameter of the positive electrode active material is too small, a large amount of conductive material functioning as a conduction path between particles needs to be mixed, which might lead to a decrease in capacity. Accordingly, the particle diameter (median diameter (D50)) of the positive electrode active material is preferably larger than or equal to 1 μm.

The particle diameter can be measured with a particle size analyzer or the like using a laser diffraction and scattering method. D50 is a particle diameter when accumulation of particles accounts for 50% of a particle size distribution curve in a measurement result of the particle size distribution. The measurement of the size of a particle is not limited to laser diffraction particle size distribution measurement, and the major diameter of the cross section of the particle may be measured by SEM analysis, TEM analysis, or the like. Note that an example of a method for measuring D50 by SEM analysis, TEM analysis, or the like includes a method for measuring 20 or more particles to make a particle size distribution curve, and setting a particle diameter when the accumulation of particles accounts for 50% as D50.

Note that unless otherwise specified, charge voltage in this specification and the like refers to the maximum value of a voltage applied between a positive electrode and a negative electrode of a battery in charge. In the description of a crystal structure of a positive electrode active material, charge voltage is shown with reference to the potential of a lithium metal. In this specification and the like, high charge voltage is charge voltage, for example, higher than or equal to 4.5 V, preferably higher than or equal to 4.55 V, further preferably higher than or equal to 4.6 V, higher than or equal to 4.65 V, or higher than or equal to 4.7 V. Note that for the positive electrode active material, two or more kinds of materials having different particle diameters and/or compositions can be used as long as the materials have less deterioration due to charge and discharge even at high charge voltage. In this specification and the like, the term “having different compositions” includes not only the case where the elements contained in the materials have different compositions but also the case where the ratios of the elements contained in the materials are different even though the elements have the same composition.

As described above, high charge voltage in this specification and the like is the voltage higher than or equal to 4.6 V with reference to the potential when a lithium metal is used for the negative electrode; however, high charge voltage is the voltage higher than or equal to 4.5 V with reference to the potential when a carbon material (e.g., graphite) is used for the negative electrode. In short, charge voltage higher than or equal to 4.6 V is referred to as high charge voltage in the case of using a lithium metal as the negative electrode in a half cell, and charge voltage higher than or equal to 4.5 V is referred to as high charge voltage in the case of using a carbon material (e.g., graphite) for the negative electrode in a full cell.

Even when charge voltage is high, a material with less deterioration (or a material with slight increase in resistance) due to charge and discharge in a low-temperature environment (e.g., 0° C., preferably −20° C., further preferably −30° C., still further preferably −40° C., yet further preferably −50° C., most preferably −60° C.) is used as the positive electrode active material, whereby a lithium ion battery with high discharge capacity even in a low-temperature environment can be obtained. Alternatively, a lithium ion battery can be obtained in which the discharge capacity value in a low-temperature environment (e.g., 0° C., preferably −20° C., further preferably −30° C., still further preferably −40° C., yet further preferably −50° C., most preferably −60° C.) is higher than or equal to 50% (preferably higher than or equal to 60%, further preferably higher than or equal to 70%, still further preferably higher than or equal to 80%, most preferably higher than or equal to 90%) of the discharge capacity value at 20° C. Note that the above value is obtained in the case where both of charge and discharge are performed in a low-temperature environment, and the measurement conditions other than the temperature (hereinafter sometimes referred to as charge and discharge temperature in this specification and the like) of charge and discharge performed in a low-temperature environment are the same as those of charge and discharge performed at 20° C.

More specifically, the discharge capacity under the condition where charge and discharge are performed at 0° C. is preferably higher than or equal to 85%, further preferably higher than or equal to 90%, still further preferably higher than or equal to 95%, yet further preferably higher than or equal to 98% of the discharge capacity under the condition where charge and discharge are performed at 20° C. The discharge capacity under the condition where charge and discharge are performed at −10° C. is preferably higher than or equal to 80%, further preferably higher than or equal to 85%, still further preferably higher than or equal to 90%, yet further preferably higher than or equal to 95% of the discharge capacity under the condition where charge and discharge are performed at 20° C. The discharge capacity under the condition where charge and discharge are performed at −20° C. is preferably higher than or equal to 75%, further preferably higher than or equal to 80%, still further preferably higher than or equal to 85%, yet further preferably higher than or equal to 90% of the discharge capacity under the condition where charge and discharge are performed at 20° C. The discharge capacity under the condition where charge and discharge are performed at −30° C. is preferably higher than or equal to 70%, further preferably higher than or equal to 75%, still further preferably higher than or equal to 80%, yet further preferably higher than or equal to 85% of the discharge capacity under the condition where charge and discharge are performed at 20° C. The discharge capacity under the condition where charge and discharge are performed at −40° C. is preferably higher than or equal to 60%, further preferably higher than or equal to 65%, still further preferably higher than or equal to 70%, yet further preferably higher than or equal to 75% of the discharge capacity under the condition where charge and discharge are performed at 20° C. The above discharge can be performed under the condition of, for example, a current rate being 0.1 C (note that 1 C=200 mA/g). Note that mass used for calculation of the C rate is the mass of the positive electrode active material.

Alternatively, a lithium ion battery with high discharge energy density even in a low-temperature environment (e.g., 0° C., preferably −20° C., further preferably −30° C., still further preferably −40° C., yet further preferably −50° C., most preferably −60° C.) can be obtained. Alternatively, a lithium ion battery can be obtained in which the discharge energy density value in a low-temperature environment (e.g., 0° C., preferably −20° C., further preferably −30° C., still further preferably −40° C., yet further preferably −50° C., most preferably −60° C.) is higher than or equal to 50% (preferably higher than or equal to 60%, further preferably higher than or equal to 70%, still further preferably higher than or equal to 80%, most preferably higher than or equal to 90%) of the discharge energy density value at 20° C. Note that the measurement conditions other than the temperature of charge and discharge performed in a low-temperature environment are the same as those of charge and discharge performed at 20° C.

The charge temperature and discharge temperature described in this specification and the like refer to the charge temperature and discharge temperature of a lithium ion battery, respectively. In the measurement of the battery characteristics at a variety of temperatures, for example, a thermostatic chamber that is stable at desired temperature is used, a battery (e.g., a test battery or a half cell) that is a target of the measurement is installed in the thermostatic chamber, and then the measurement can start after sufficient time (e.g., 1 hour or longer) break until the temperature of the test cell is substantially equal to that of the thermostatic chamber. The method is not necessarily limited thereto.

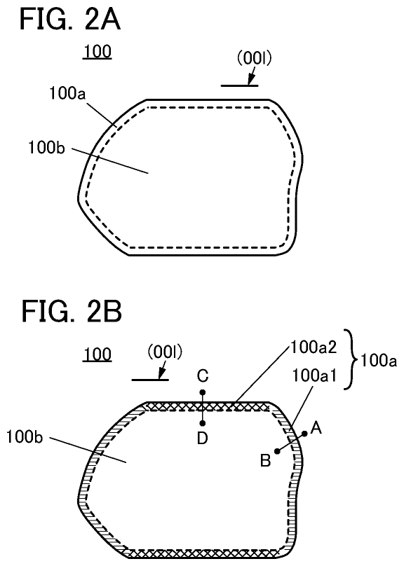

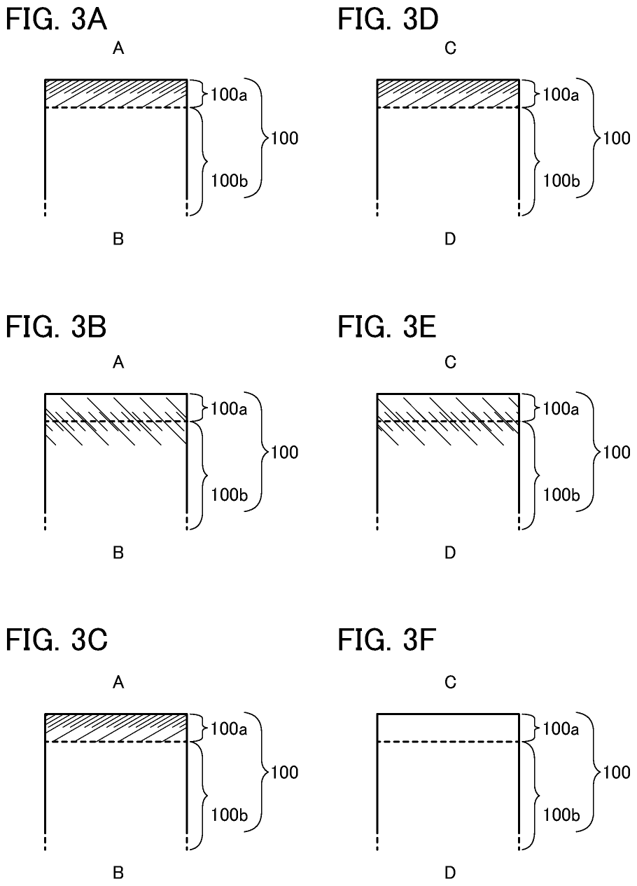

The positive electrode active material 100 with less deterioration due to repetition of charge at high charge voltage and discharge is described with reference to FIGS. 2A and 2B and FIGS. 3A to 3F.

FIGS. 2A and 2B are cross-sectional views of the positive electrode active material 100 of one embodiment of the present invention. FIGS. 3A to 3C illustrate enlarged views of a portion near the line A-B in FIG. 2B. FIGS. 3D to 3F illustrate enlarged views of a portion near the line C-D in FIG. 2B.

As illustrated in FIG. 2A, the positive electrode active material 100 includes a surface portion 100a and an inner portion 100b. In each drawing, the dashed line denotes a boundary between the surface portion 100a and the inner portion 100b.

The surface portion 100a of the positive electrode active material 100 refers to a region of 50 nm or less, preferably 35 nm or less, further preferably 20 nm or less in depth from the surface toward the inner portion, and most preferably 10 nm or less in depth in a perpendicular direction or a substantially perpendicular direction from the surface toward the inner portion. Note that “substantially perpendicular” refers to a state where an angle is greater than or equal to 80° and less than or equal to 100°. A plane generated by a crack can be considered as a surface. The surface portion 100a can be rephrased as the vicinity of a surface, a region in the vicinity of a surface, or a shell.

The inner portion 100b refers to a region deeper than the surface portion 100a of the positive electrode active material. The inner portion 100b can be rephrased as an inner region or a core.

In the case where the positive electrode active material 100 has a layered rock-salt crystal structure of a space group R-3m, the surface portion 100a includes an edge region 100a1 and a basal region 100a2 as illustrated in FIG. 2B. Note that in FIGS. 2A and 2B, the straight line denoted by (001) is parallel to a (001) plane. Here, the edge region 100a1 has a surface exposed in a direction intersecting with the (001) plane, and a region of 50 nm or less, preferably 35 nm or less, further preferably 20 nm or less in depth from the surface toward the inner portion, and most preferably 10 nm or less in depth in a perpendicular direction or a substantially perpendicular direction from the surface toward the inner portion refers to the edge region 100a1. Here, “intersect” means that an angle between a perpendicular line of a first plane (the (001) plane) and a normal of a second plane (a surface of the positive electrode active material 100) is greater than or equal to 10° and less than or equal to 90°, preferably greater than or equal to 30° and less than or equal to 90°.

Moreover, the basal region 100a2 has a surface parallel to the (001) plane, and a region of 50 nm or less, preferably 35 nm or less, further preferably 20 nm or less in depth from the surface toward the inner portion, and most preferably 10 nm or less in depth in a perpendicular direction or a substantially perpendicular direction from the surface toward the inner portion refers to the basal region 100a2. Here, “parallel” means that an angle between the perpendicular line of the first plane (the (001) plane) and the normal of the second plane (the surface of the positive electrode active material 100) is greater than or equal to 0° and less than or equal to 5°, preferably greater than or equal to 0° and less than or equal to 2.5°.

The surface of the positive electrode active material 100 refers to a surface of a composite oxide including the surface portion 100a and the inner portion 100b. Thus, the positive electrode active material 100 does not contain a material to which a metal oxide that does not contain a lithium site contributing to charge and discharge, such as aluminum oxide (Al₂O₃), is attached, or a carbonate, a hydroxy group, or the like which is chemically adsorbed after formation of the positive electrode active material 100. The attached metal oxide refers to, for example, a metal oxide in which a crystal orientation is not aligned with a crystal orientation of the inner portion 100b.

The crystal orientations in two regions being substantially aligned with each other can be judged, for example, from a transmission electron microscope (TEM) image, a scanning transmission electron microscope (STEM) image, a high-angle annular dark field scanning TEM (HAADF-STEM) image, an annular bright-field scanning transmission electron microscope (ABF-STEM) image, an electron diffraction pattern, or the like. It can be judged also from an FFT pattern of a TEM image or an FFT pattern of a STEM image or the like. Furthermore, X-ray diffraction (XRD), electron diffraction, neutron diffraction, and the like can also be used for judging.

Furthermore, an electrolyte, a decomposition product of the electrolyte, an organic solvent, a binder, a conductive material, and a compound originating from any of these that are attached to the positive electrode active material 100 are not contained in the positive electrode active material either.

Since the positive electrode active material 100 is a compound containing oxygen and a transition metal into and from which lithium can be inserted and extracted, an interface between a region where oxygen and the transition metal M (Co, Ni, Mn, Fe, or the like) that is oxidized or reduced due to insertion and extraction of lithium exist and a region where oxygen and the transition metal M do not exist is considered as the surface of the positive electrode active material. A plane generated by slipping and/or a crack also can be considered as the surface of the positive electrode active material. When the positive electrode active material is analyzed, a protective film is attached on its surface in some cases; however, the protective film is not included in the positive electrode active material. As the protective film, a single-layer film or a multilayer film of carbon, a metal, an oxide, a resin, or the like is sometimes used.

Therefore, the surface of the positive electrode active material in, for example, linear analysis by energy dispersive X-ray spectroscopy with a scanning transmission electron microscope (STEM-EDX linear analysis) refers to a point where a value of the amount of the detected transition metal M is equal to 50% of the sum of the average value M_{AVE} of the amount of the detected transition metal Min the inner portion and the average value M_{BG} of the amount of the background transition metal M and a point where a value of the amount of the detected oxygen is equal to 50% of the sum of the average value O_{AVE} of the amount of detected oxygen in the inner portion and the average value O_{BG} of the amount of background oxygen. Note that in the case where the positions of the points are different between the transition metal M and oxygen, the difference is probably due to the influence of a carbonate, a metal oxide containing oxygen, or the like, which is attached to the surface. Thus, the point where the value of the amount of the detected transition metal M is equal to 50% of the sum of the average value M_{AVE} of the amount of the detected transition metal Min the inner portion and the average value M_{BG} of the amount of the background transition metal M can be used. In the case of a positive electrode active material containing a plurality of transition metals M, its surface can be determined using M_{AVE} and M_{BG} of an element whose number is the largest in the inner portion 100b.

The average value M_{BG} of the amount of the background transition metal M can be calculated by averaging the amount in the range greater than or equal to 2 nm, preferably greater than or equal to 3 nm, which is outside a portion in the vicinity of the portion at which the amount of the detected transition metal M begins to increase, for example. The average value M_{AVE} of the amount of the detected transition metal M in the inner portion can be calculated by averaging the amount in the range greater than or equal to 2 nm, preferably greater than or equal to 3 nm in a region where the numbers of the transition metals M and oxygen atoms are saturated and stabilized, e.g., a portion that is greater than or equal to 30 nm, preferably greater than 50 nm in depth from the portion where the amount of the detected transition metal M begins to increase, for example. The average value O_{BG} of the amount of background oxygen and the average value O_{AVE} of the amount of detected oxygen in the inner portion can be calculated in a similar manner.

The surface of the positive electrode active material 100 in, for example, a cross-sectional STEM image is a boundary between a region where an image derived from the crystal structure of the positive electrode active material is observed and a region where the image is not observed. The surface of the positive electrode active material 100 is also determined as the outermost surface of a region where an atomic column derived from an atomic nucleus of a metal element that has a larger atomic number than lithium is observed in the cross-sectional STEM image. Alternatively, the surface refers to an intersection of a tangent drawn at a luminance profile from the surface toward the bulk and an axis in the depth direction in a STEM image. The surface in a STEM image or the like may be judged employing also analysis with higher spatial resolution.

Note that the spatial resolution of STEM-EDX is approximately 1 nm. Thus, in an EDX linear analysis, when a projection appeared in a graph of characteristic X-ray intensity is a projection with half width of less than or equal to 1 nm, the projection can be a measurement noise.

### <Contained Element>

The positive electrode active material 100 contains lithium, cobalt, oxygen, and an additive element. The positive electrode active material 100 can contain lithium cobalt oxide (LiCoO₂) to which an additive element is added. Note that the positive electrode active material 100 of one embodiment of the present invention has a crystal structure described later, and thus the composition of the lithium cobalt oxide is not strictly limited to Li:Co:O=1:1:2.

In order to maintain a neutrally charged state even when lithium ions are inserted and extracted, a positive electrode active material of a lithium ion secondary battery needs to contain a transition metal taking part in an oxidation-reduction reaction. It is preferable that the positive electrode active material 100 of one embodiment of the present invention mainly contain cobalt as a transition metal taking part in an oxidation-reduction reaction. In addition to cobalt, at least one of nickel and manganese may be contained. Using cobalt at greater than or equal to 75 atomic %, preferably greater than or equal to 90 atomic %, further preferably greater than or equal to 95 atomic % as the transition metal contained in the positive electrode active material 100 brings many advantages such as relatively easy synthesis, easy handling, and excellent cycle performance, which is preferable.

When cobalt is used as the transition metal contained in the positive electrode active material 100 at greater than or equal to 75 atomic %, preferably greater than or equal to 90 atomic %, further preferably greater than or equal to 95 atomic %, LiₓCoO₂ with small x is more stable than a composite oxide in which nickel accounts for the majority of the transition metal, such as lithium nickel oxide (LiNiO₂). This is probably because cobalt is less likely to be distorted due to the Jahn-Teller effect than nickel. It is known that the Jahn-Teller effect in a transition metal compound varies in degree according to the number of electrons in the d orbital of the transition metal. The influence of the Jahn-Teller effect is large in a composite oxide having a layered rock-salt structure, such as lithium nickel oxide, in which octahedral coordinated low-spin nickel(III) accounts for the majority of the transition metal, and a layer having an octahedral structure formed of nickel and oxygen is likely to be distorted. Thus, there is a concern that the crystal structure might break in charge and discharge cycles. The size of a nickel ion is larger than the size of a cobalt ion and close to that of a lithium ion. Thus, there is a problem in that cation mixing between nickel and lithium is likely to occur in a composite oxide having a layered rock-salt structure in which nickel accounts for the majority of the transition metal, such as lithium nickel oxide.

As the additive element contained in the positive electrode active material 100, one or more selected from magnesium, fluorine, nickel, aluminum, titanium, zirconium, vanadium, iron, manganese, chromium, niobium, arsenic, zinc, silicon, sulfur, phosphorus, boron, barium, bromine, and beryllium are preferably used. The total percentage of the transition metal among the additive elements is preferably less than 25 atomic %, further preferably less than 10 atomic %, still further preferably less than 5 atomic %.

That is, the positive electrode active material 100 can contain any one or more of lithium cobalt oxide containing magnesium; lithium cobalt oxide containing magnesium and aluminum; lithium cobalt oxide containing magnesium, aluminum, and titanium; lithium cobalt oxide containing magnesium and nickel; lithium cobalt oxide containing magnesium, aluminum, and nickel; lithium cobalt oxide containing magnesium and fluorine; lithium cobalt oxide containing magnesium, fluorine, and titanium; lithium cobalt oxide containing magnesium, fluorine, and aluminum; lithium cobalt oxide containing magnesium, fluorine, titanium, and aluminum; lithium cobalt oxide containing magnesium, fluorine, and nickel; lithium cobalt oxide containing magnesium, fluorine, nickel, and aluminum; and the like.

As the positive electrode active material 100 in a lithium ion battery, any one or more of a positive electrode active material containing cobalt, oxygen, and magnesium; a positive electrode active material containing cobalt, oxygen, magnesium, and aluminum; a positive electrode active material containing cobalt, oxygen, magnesium, aluminum, and titanium; a positive electrode active material containing cobalt, oxygen, magnesium, and nickel; a positive electrode active material containing cobalt, oxygen, magnesium, aluminum, and nickel; a positive electrode active material containing cobalt, oxygen, magnesium, and fluorine; a positive electrode active material containing cobalt, oxygen, magnesium, fluorine, and titanium; a positive electrode active material containing cobalt, oxygen, magnesium, fluorine, and aluminum; a positive electrode active material containing cobalt, oxygen, magnesium, fluorine, titanium, and aluminum; a positive electrode active material containing cobalt, oxygen, magnesium, fluorine, and nickel; a positive electrode active material containing cobalt, oxygen, magnesium, fluorine, nickel, and aluminum; and the like can be used.

The additive element is preferably dissolved in the positive electrode active material 100. For example, in STEM-EDX linear analysis, a position where the amount of the detected additive element increases is preferably at a deeper level than a position where the amount of the detected transition metal M increases, i.e., on the inner portion side of the positive electrode active material 100.

Such additive elements further stabilize the crystal structure of the positive electrode active material 100 as described later. In this specification and the like, an additive element can be rephrased as part of a mixture or a raw material.

Note that as the additive element, magnesium, fluorine, nickel, aluminum, titanium, zirconium, vanadium, iron, manganese, chromium, niobium, arsenic, zinc, silicon, sulfur, phosphorus, boron, barium, bromine, or beryllium is not necessarily contained.

When the positive electrode active material 100 is substantially free from manganese, for example, the above advantages, including relatively easy synthesis, easy handling, and excellent cycle performance, are enhanced. The weight of manganese contained in the positive electrode active material 100 is preferably less than or equal to 600 ppm, further preferably less than or equal to 100 ppm, for example.

The surface portion 100a is a region from which lithium ions are extracted first in charge, and is more likely to have a low lithium concentration than the inner portion 100b. It can be said that bonds between atoms are partly cut on the surface of the particle of the positive electrode active material 100 included in the surface portion 100a. Therefore, the surface portion 100a is regarded as a region that is likely to be unstable and deterioration of its crystal structure is likely to begin. Meanwhile, if the surface portion 100a can have sufficient stability, the layered structure, which is formed of octahedrons of cobalt and oxygen, of the inner portion 100b is difficult to break even when x in LiₓCoO₂ is small, e.g., 0.24 or less. Furthermore, a shift in layers, which are formed of octahedrons of cobalt and oxygen, of the inner portion 100b can be inhibited.

To obtain a stable composition and a stable crystal structure of the surface portion 100a, the surface portion 100a preferably contains the additive element, further preferably a plurality of the additive elements. The surface portion 100a preferably has a higher concentration of one or more selected from the additive elements than the inner portion 100b. The one or more selected from the additive elements contained in the positive electrode active material 100 preferably have a concentration gradient. In addition, it is further preferable that the additive elements contained in the positive electrode active material 100 be differently distributed. For example, it is preferable that the additive elements exhibit concentration peaks at different depths from a surface. The concentration peak here refers to the local maximum value of the concentration in the surface portion 100a or the concentration in 50 nm or less in depth from the surface.

Distribution of the additive elements is described. FIGS. 3A to 3C illustrate enlarged views of a portion near the line A-B in FIG. 2B and describe the edge region 100a1 of the positive electrode active material 100. FIGS. 3D to 3F illustrate enlarged views of a portion near the line C-D in FIG. 2B and describe the basal region 100a2 of the positive electrode active material 100.

For example, some of the additive elements such as magnesium, fluorine, titanium, silicon, phosphorus, boron, and calcium preferably have a concentration gradient as illustrated in FIGS. 3A and 3D by gradation, in which the concentration increases from the inner portion 100b toward the surface. An additive element which has such a concentration gradient is referred to as the additive element X.

Another additive element such as aluminum or manganese preferably has a concentration gradient as represented by hatching in FIGS. 3B and 3E and exhibits a concentration peak in a deeper region than a concentration peek of the additive element X shown in FIGS. 3A and 3D. The concentration peak may be located in the surface portion 100a or located deeper than the surface portion 100a. For example, the concentration peak is preferably located in a region that is 5 nm to 30 nm inclusive in depth from the surface toward the inner portion. An additive element which has such a concentration gradient is referred to as the additive element Y.

FIG. 3C shows dark hatching and FIG. 3F shows no hatching, which means that another additive element such as nickel or barium clearly exists in the edge region 100a1 but does not substantially exist in the basal region 100a2 in some cases. Note that here, “clearly exist” means a case where the energy spectrum of characteristic X-ray of the element is detected in a cross-sectional STEM-EDX analysis of the positive electrode active material 100.

Moreover, “not substantially exist” means a case where the energy spectrum of characteristic X-ray of the element is not detected in the cross-sectional STEM-EDX analysis of the positive electrode active material 100, i.e., the element is lower than or equal to the lower detection limit in the STEM-EDX analysis. An additive element which has such distribution is referred to as the additive element Z.

For example, magnesium, which is an example of the additive element X, is divalent, and a magnesium ion is more stable in lithium sites than in cobalt sites in a layered rock-salt crystal structure; thus, magnesium is likely to enter the lithium sites. An appropriate concentration of magnesium in the lithium sites of the surface portion 100a facilitates maintenance of the layered rock-salt crystal structure. This is probably because magnesium in the lithium sites serves as a column supporting the CoO₂ layers. Moreover, magnesium can inhibit extraction of oxygen therearound in a state where x in LiₓCoO₂ is, for example, 0.24 or less. Magnesium is also expected to increase the density of the positive electrode active material 100. In addition, a high magnesium concentration in the surface portion 100a probably increases the corrosion resistance to hydrofluoric acid generated by the decomposition of the electrolyte solution.

An appropriate magnesium concentration is preferable because an adverse effect on insertion and extraction of lithium in charge and discharge can be prevented and the above-described advantages can be obtained. However, excess magnesium might adversely affect insertion and extraction of lithium. Furthermore, the effect of stabilizing the crystal structure might be reduced. This is probably because magnesium enters the cobalt sites in addition to the lithium sites. Moreover, an excess magnesium compound (e.g., an oxide or a fluoride) which is substituted for neither the lithium site nor the cobalt site might segregate at the surface of the positive electrode active material or the like to serve as a resistance component of a secondary battery. As the magnesium concentration in the positive electrode active material increases, the discharge capacity of the positive electrode active material decreases in some cases. This is probably because excess magnesium enters the lithium sites and the amount of lithium contributing to charge and discharge decreases.

Thus, the entire positive electrode active material 100 preferably contains an appropriate amount of magnesium. For example, the number of magnesium atoms is preferably greater than or equal to 0.001 times and less than or equal to 0.1 times, preferably greater than or equal to 0.01 times and less than or equal to 0.04 times, still further preferably approximately 0.02 times the number of cobalt atoms. The amount of magnesium contained in the entire positive electrode active material 100 may be, for example, a value obtained by element analysis on the entire positive electrode active material 100 with glow discharge mass spectrometry (GD-MS), inductively coupled plasma mass spectrometry (ICP-MS), or the like or may be based on the proportion of a raw material in the formation process of the positive electrode active material 100.

Aluminum, which is an example of the additive element Y, can exist in a cobalt site in a layered rock-salt crystal structure. Since aluminum is a trivalent representative element and its valence does not change, lithium around aluminum is less likely to transfer even in charge and discharge. Thus, aluminum and lithium around aluminum serve as columns to inhibit a change in the crystal structure. Furthermore, aluminum has an effect of inhibiting elution of cobalt around aluminum and improving continuous charge tolerance. Moreover, an Al—O bond is stronger than a Co—O bond and thus extraction of oxygen around aluminum can be inhibited. These effects improve thermal stability. Therefore, a secondary battery including the positive electrode active material 100 containing aluminum as the additive element can have high stability. In addition, the positive electrode active material 100 having a crystal structure that is unlikely to be broken by repeated charge and discharge can be provided.

Moreover, excess aluminum might adversely affect insertion and extraction of lithium.

Thus, the entire positive electrode active material 100 preferably contains an appropriate amount of aluminum. The number of aluminum atoms in the entire positive electrode active material 100 is, for example, preferably greater than or equal to 0.05% and less than or equal to 4%, further preferably greater than or equal to 0.1% and less than or equal to 2%, still further preferably greater than or equal to 0.3% and less than or equal to 1.5% of the number of cobalt atoms. Alternatively, the number of aluminum atoms is preferably greater than or equal to 0.05% and less than or equal to 2% or greater than or equal to 0.1% and less than or equal to 4%. Here, the amount of aluminum contained in the entire positive electrode active material 100 may be a value obtained by element analysis on the entire positive electrode active material 100 with GD-MS, ICP-MS, or the like or may be based on the proportion of a raw material in the formation process of the positive electrode active material 100.

Nickel, which is an example of the additive element Z, can exist in both the cobalt site and the lithium site. Nickel preferably exists in the cobalt site because a lower oxidation-reduction potential can be obtained as compared with the case where only cobalt exists in the cobalt site, leading to an increase in discharge capacity.

In addition, when nickel exists in the lithium site, a shift in the layers, which are formed of octahedrons of cobalt and oxygen, can be inhibited. Moreover, a change in the volume in charge and discharge is inhibited. Furthermore, an elastic modulus becomes large, i.e., hardness increases. This is probably because nickel in the lithium sites also serves as a column supporting the CoO₂ layers. Therefore, in particular, the crystal structure is expected to be more stable in a charged state at high temperatures, e.g., 45° C. or higher, which is preferable.

Meanwhile, excess nickel increases the influence of distortion due to the Jahn-Teller effect, which is not preferable. Moreover, excess nickel might adversely affect insertion and extraction of lithium.

Thus, the entire positive electrode active material 100 preferably contains an appropriate amount of nickel. For example, the number of nickel atoms in the positive electrode active material 100 is preferably greater than 0% and less than or equal to 7.5%, further preferably greater than or equal to 0.05% and less than or equal to 4%, still further preferably greater than or equal to 0.1% and less than or equal to 2%, yet still further preferably greater than or equal to 0.2% and less than or equal to 1% of the number of cobalt atoms. Alternatively, the number of nickel atoms in the positive electrode active material 100 is preferably greater than 0% and less than or equal to 4%, greater than 0% and less than or equal to 2%, greater than or equal to 0.05% and less than or equal to 7.5%, greater than or equal to 0.05% and less than or equal to 2%, greater than or equal to 0.1% and less than or equal to 7.5%, or greater than or equal to 0.1% and less than or equal to 4% of the number of cobalt atoms. The amount of nickel described here may be a value obtained by element analysis on the entire positive electrode active material with GD-MS, ICP-MS, or the like or may be based on the proportion of a raw material in the formation process of the positive electrode active material.

When fluorine, which is a monovalent anion and is an example of the additive element X, is substituted for part of oxygen in the surface portion 100a, the lithium extraction energy is lowered. This is because the change in valence of cobalt ions associated with lithium extraction is trivalent to tetravalent in the case of not containing fluorine and divalent to trivalent in the case of containing fluorine, and the oxidation-reduction potential differs therebetween. It can thus be said that when fluorine is substituted for part of oxygen in the surface portion 100a of the positive electrode active material 100, lithium ions near fluorine are likely to be extracted and inserted smoothly. Thus, a secondary battery including such a positive electrode active material 100 can have improved charge and discharge characteristics, improved large current characteristics, or the like. When fluorine exists in the surface portion 100a, which has a surface in contact with the electrolyte solution, the corrosion resistance to hydrofluoric acid can be effectively increased. As will be described in detail in the following embodiment, a fluoride such as lithium fluoride that has a lower melting point than another additive element source can serve as a fusing agent (also referred to as a flux) for lowering the melting point of another additive element source.

An oxide of titanium, which is an example of the additive element X, is known to have superhydrophilicity. Accordingly, the positive electrode active material 100 including an oxide of titanium at the surface portion 100a presumably has good wettability with respect to a high-polarity solvent. Such a positive electrode active material 100 and a high-polarity electrolyte solution can have favorable contact at the interface therebetween and presumably inhibit an internal resistance increase when a secondary battery is formed using such a positive electrode active material 100.

As illustrated in FIGS. 3A and 3C, when the surface portion 100a contains both magnesium and nickel, divalent nickel might be able to exist more stably in the vicinity of divalent magnesium. Thus, even when x in LiₓCoO₂ is small, elution of magnesium might be inhibited, which might contribute to stabilization of the surface portion 100a.

Additive elements that are differently distributed, such as the additive elements X, Y, and Z are preferably contained at a time, in which case the crystal structure of a wider region can be stabilized. For example, the crystal structure of a wider region can be stabilized in the case where the positive electrode active material 100 contains all of magnesium, which is an example of the additive element X; aluminum, which is an example of the additive element Y; and nickel, which is an example of the additive element Z as compared with the case where only one or two of the additive elements X, Y, and Z are contained. In the case where the positive electrode active material 100 contains all of the additive elements X, Y, and Z as described above, the surface can be sufficiently stabilized by the additive element X such as magnesium and the additive element Z such as nickel; thus, the additive element Y such as aluminum is not necessary for the surface. It is preferable that aluminum be widely distributed in a region deeper than distribution of magnesium and distribution of nickel. For example, it is preferable that aluminum be continuously detected in a region that is 1 nm to 25 nm inclusive in depth from the surface. Wide distribution of aluminum in a region that is 0 nm to 50 nm inclusive, preferably 1 nm to 50 nm inclusive in depth from the surface is preferable because the crystal structure of a wider region can be stabilized.

In the case where a large number of additive elements Z are contained in the edge region 100a1 (also referred to as preferentially contained, selectively contained, or the like) as illustrated in FIGS. 3C and 3F, the stability of the crystal structure of the edge region 100a1 for insertion and extraction of lithium ions into/from the positive electrode active material 100 in charge and discharge of a lithium ion battery is increased, which is preferable. In the case where the additive element Z has such distribution, for example, in the case where the positive electrode active material 100 is lithium cobalt oxide, an influence of adding the additive element Z, such as a decrease in discharge voltage or a decrease in discharge capacity, can be kept to the minimum, which is preferable.

When a plurality of the additive elements are contained as described above, the effects of the additive elements contribute synergistically to further stabilization of the surface portion 100a. In particular, magnesium, nickel, and aluminum are preferably contained because a high effect of stabilizing the composition and the crystal structure can be obtained. In particular, the surface portion 100a of the positive electrode active material 100 preferably includes a region where distribution of magnesium is closer to the surface than distribution of aluminum. In the surface portion 100a of the positive electrode active material 100, it is most preferable that the edge region 100a1 include not only the region where magnesium and aluminum are distributed but also a region where distribution of nickel and distribution of magnesium overlap with each other. “Including a region where distribution of magnesium is closer to the surface than distribution of aluminum” means that, for example, in the STEM-EDX linear analysis, the position exhibiting the local maximum value of the magnesium concentration is closer to the surface side than the position exhibiting the local maximum value of the aluminum concentration.

### <Electrolyte>

For the electrolyte used as one embodiment of the present invention, a material with high lithium ion conductivity in charge and/or discharge (charge and discharge) even in a low-temperature environment (e.g., 0° C., preferably −20° C., further preferably −30° C., still further preferably −40° C., yet further preferably −50° C., most preferably −60° C.) can be used.

Examples of the electrolyte are described below. Note that although the electrolyte described as an example in this embodiment is an organic solvent in which a lithium salt is dissolved and can be referred to as an electrolyte solution, the electrolyte is not limited to a liquid electrolyte (an electrolyte solution) that is liquid at room temperature and can be a solid electrolyte. Alternatively, an electrolyte (a semi-solid electrolyte) including both the liquid electrolyte that is liquid at room temperature and the solid electrolyte that is solid at room temperature can also be used.

The organic solvent described as an example in this embodiment contains ethylene carbonate (EC), ethyl methyl carbonate (EMC), and dimethyl carbonate (DMC). When a total content of EC, EMC, and DMC is set to 100 vol %, an organic solvent in which the volume ratio of EC, EMC, and DMC is x:y:100−x−y (note that 5≤x≤35 and 0<y<65) can be used. More specifically, an organic solvent containing EC, EMC, and DMC at EC:EMC:DMC=30:35:35 in a volume ratio can be used. Note that the volume ratio may be the volume ratio of the organic solvent before mixing, and the organic solvent may be mixed at room temperature (typically 25° C.).

EC is cyclic carbonate and has high dielectric constant, and thus has an effect of promoting dissociation of a lithium salt. Meanwhile, the EC has high viscosity and has a high freezing point (melting point) of 38° C.; thus, it is difficult to use in a low-temperature environment when EC is used alone as the organic solvent. Then, the organic solvent specifically described in one embodiment of the present invention includes not only EC but also EMC and DMC. EMC is a chain-like carbonate and has an effect of decreasing the viscosity of the electrolyte solution, and the freezing point is −54° C. In addition, DMC is also a chain-like carbonate and has an effect of decreasing the viscosity of the electrolyte solution, the freezing point is −43° C. An electrolyte formed using a mixed organic solvent in a volume ratio of x:y:100−x−y (note that 5≤x≤35 and 0<y<65) with a total content of these three organic solvents of EC, EMC, and DMC having such physical properties of 100 vol % has a characteristic in which the freezing point is lower than or equal to −40° C.

A general electrolyte used for a lithium ion battery is solidified at approximately −20° C.; thus, it is difficult to fabricate a battery that can be charged and discharged at −40° C. Since the electrolyte described as an example in this embodiment has a freezing point at lower than or equal to −40° C., a lithium ion battery that can be charged and discharged even in an extremely low-temperature environment such as at −40° C. can be obtained.

A lithium salt can be used for an electrolyte dissolved in the solvent. For example, one of lithium salts such as LiPF₆, LiClO₄, LiAsF₆, LiBF₄, LiAlCl₄, LiSCN, LiBr, LiI, Li₂SO₄, Li₂B₁₀Cl₁₀, Li₂B₁₂Cl₁₂, LiCF₃SO₃, LiC₄F₉SO₃, LiC(CF₃SO₂)₃, LiC(C₂F₅SO₂)₃, LiN(CF₃SO₂)₂, LiN(C₄F₉SO₂) (CF₃SO₂), LiN(C₂F₅SO₂)₂, and lithium bis(oxalate)borate (LiBOB) can be used, or two or more of these lithium salts can be used in an appropriate combination in an appropriate ratio. The electrolyte dissolved in the solvent is preferably more than or equal to 0.5 mol/L and less than or equal to 1.5 mol/L, further preferably more than or equal to 0.7 mol/L and less than or equal to 1.3 mol/L, still further preferably more than or equal to 0.8 mol/L and less than or equal to 1.2 mol/L with respect to the volume of the solvent. A specific usage example is that LiPF₆ is preferably more than or equal to 0.5 mol/L and less than or equal to 1.5 mol/L, further preferably more than or equal to 0.7 mol/L and less than or equal to 1.3 mol/L, still further preferably more than or equal to 0.8 mol/L and less than or equal to 1.2 mol/L with respect to the volume of the solvent.

The electrolyte solution is preferably highly purified and contains a small amount of dust particles and elements other than the constituent elements of the electrolyte solution (hereinafter also simply referred to as impurities). Specifically, the weight ratio of impurities to the electrolyte solution is preferably less than or equal to 1%, further preferably less than or equal to 0.1%, still further preferably less than or equal to 0.01%.

In order to forming a coating film (solid electrolyte interphase film) at the interface between the electrode (active material layer) and the electrolyte solution for the purpose of improvement of the safety or the like, an additive agent such as vinylene carbonate (VC), propane sultone (PS), tert-butylbenzene (TBB), fluoroethylene carbonate (FEC), lithium bis(oxalate)borate (LiBOB), or a dinitrile compound such as succinonitrile or adiponitrile may be added to the electrolyte solution. The concentration of such an additive agent in the solvent is, for example, higher than or equal to 0.1 wt % and lower than or equal to 5 wt %.

Although an example of an electrolyte that can be used for the lithium ion battery of one embodiment of the present invention is described above, the electrolyte that can be used for the lithium ion battery of one embodiment of the present invention should not be construed as being limited to the example. Another material can be used as long as it has high lithium ion conductivity even when the lithium ion battery is charged and discharged in a low-temperature environment.

The lithium ion battery of one embodiment of the present invention contains at least the positive electrode active material and the electrolyte, whereby a lithium ion battery having excellent discharge characteristics and/or excellent charge characteristics even in a low-temperature environment can be obtained. Specifically, a lithium ion battery can be obtained which contains at least the positive electrode active material and the electrolyte, and has, in charge and discharge at −40° C., discharge capacity of higher than or equal to 70% of discharge capacity of a test battery in charge and discharge at 20° C.; the test battery contains a lithium metal as a negative electrode. Note that discharge can be performed under the condition of, for example, a current rate being 0.1 C (note that 1 C=200 mA/g). In this specification and the like, when discharge capacity at T ° C. (T is given temperature (° C.)) can be higher than or equal to 50% of discharge capacity at 20° C., it can be said that the lithium ion battery can be operated at T ° C.

The contents in this embodiment can be freely combined with the contents in any of the other embodiments.

### Embodiment 2

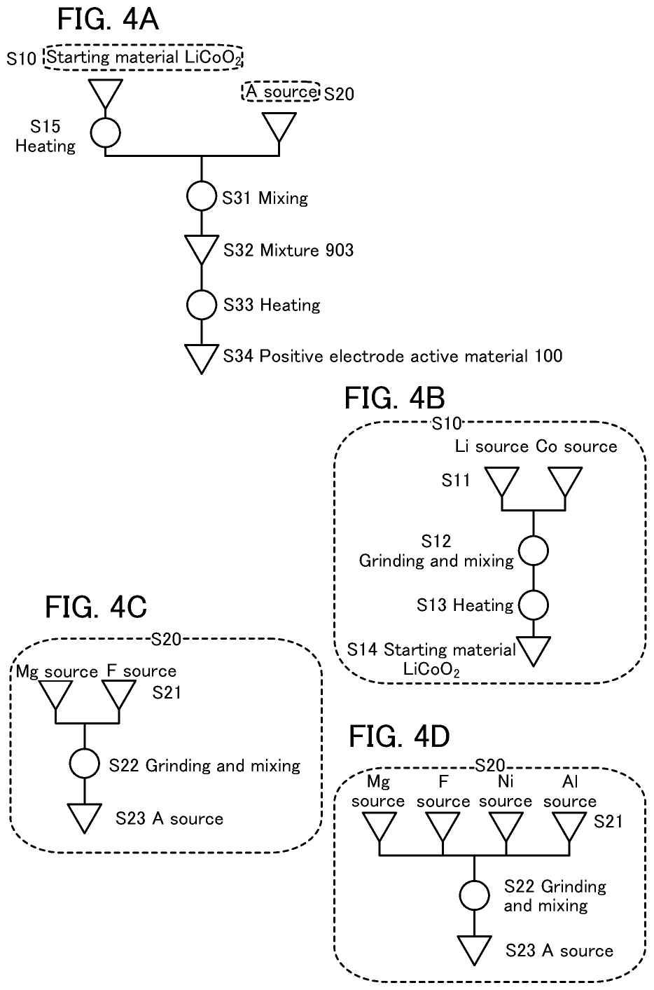

In this embodiment, a formation method of a positive electrode active material applicable to a lithium ion battery having excellent discharge characteristics even in a low-temperature environment is described with reference to FIGS. 4A to 4D, FIG. 5, and FIGS. 6A to 6C.

### Example 1 of Formation Method of Positive Electrode Active Material

An example of a formation method of a positive electrode active material that can be used as one embodiment of the present invention (Example 1 of formation method of positive electrode active material) is described with reference to FIGS. 4A to 4D. Note that in <Example 1 of formation method of positive electrode active material>, the additive elements described as the additive elements X, Y, and Z in Embodiment 1 are collectively referred to as an additive element A.

First, lithium cobalt oxide is prepared as a starting material in Step S10. The particle diameter (strictly, median diameter (D50)) of the lithium cobalt oxide that is a starting material can be less than or equal to 10 μm (preferably less than or equal to 8 μm). Lithium cobalt oxide with a median diameter (D50) of less than or equal to 10 μm may be known or official (in short, commercially available) lithium cobalt oxide or lithium cobalt oxide formed through Steps S11 to S14 shown FIG. 4B. As a typical example of the commercially available lithium cobalt oxide with a median diameter (D50) of less than or equal to 10 μm, lithium cobalt oxide manufactured by NIPPON CHEMICAL INDUSTRIAL CO., LTD. (product name: C-5H) can be given. C-5H has a median diameter (D50) of approximately 7 μm. A method for forming lithium cobalt oxide with a median diameter (D50) of less than or equal to 10 μm through Steps S11 to S14 is described below.

### <Step S11>

In Step S11 shown in FIG. 4B, a lithium source (Li source) and a cobalt source (Co source) are prepared as materials for lithium and a transition metal which are starting materials.

As the lithium source, a lithium-containing compound is preferably used and for example, lithium carbonate, lithium hydroxide, lithium nitrate, lithium fluoride, or the like can be used. The lithium source preferably has a high purity and is preferably a material having a purity of higher than or equal to 99.99%, for example.

As the cobalt source, a cobalt-containing compound is preferably used and for example, cobalt hydroxide, cobalt oxide such as tricobalt tetroxide, or the like can be used. The cobalt source preferably has a high purity and is preferably a material having a purity of higher than or equal to 3N (99.9%), further preferably higher than or equal to 4N (99.99%), still further preferably higher than or equal to 4N5 (99.995%), yet still further preferably higher than or equal to 5N (99.999%), for example. Impurities of the positive electrode active material can be controlled by using such a high-purity material. As a result, a secondary battery with an increased capacity and increased reliability can be obtained.

Furthermore, the cobalt source preferably has high crystallinity and for example, the cobalt source preferably includes single crystal particles. The crystallinity of the cobalt source can be evaluated with a TEM image, a STEM image, a HAADF-STEM image, or an ABF-STEM image or by XRD, electron diffraction, neutron diffraction, or the like. Note that the above methods for evaluating crystallinity can also be employed to evaluate the crystallinity of materials other than the cobalt source.

### <Step S12>

Next, in Step S12 shown in FIG. 4B, the lithium source and the cobalt source are ground and mixed to form a mixed material. The grinding and mixing can be performed by a dry method or a wet method. To obtain lithium cobalt oxide with a median diameter (D50) of less than or equal to 10 μm as a starting material, the grinding and mixing by a wet method are preferred because a material can be crushed into a smaller size. When the grinding and mixing are performed by a wet method, a solvent is prepared. As the solvent, ketone such as acetone, alcohol such as ethanol or isopropanol, ether, dioxane, acetonitrile, N-methyl-2-pyrrolidone (NMP), or the like can be used. An aprotic solvent, which is unlikely to react with lithium, is preferably used. In this embodiment, dehydrated acetone with a purity of higher than or equal to 99.5% is used. It is preferable that the lithium source and the cobalt source be mixed into dehydrated acetone whose moisture content is less than or equal to 10 ppm and which has a purity of higher than or equal to 99.5% in the grinding and mixing. With the use of dehydrated acetone with the above-described purity, impurities that might be mixed can be reduced.

A ball mill, a bead mill, or the like can be used for the grinding, mixing, and the like. When a ball mill is used, aluminum oxide balls or zirconium oxide balls are preferably used as a grinding medium. Zirconium oxide balls are preferable because they release fewer impurities. When a ball mill, a bead mill, or the like is used, the peripheral speed is preferably higher than or equal to 100 mm/s and lower than or equal to 2000 mm/s in order to inhibit contamination from the medium.

### <Step S13>

Next, in Step S13 shown in FIG. 4B, the above mixed material is heated. The heating is preferably performed at higher than or equal to 800° C. and lower than or equal to 1100° C., further preferably at higher than or equal to 900° C. and lower than or equal to 1000° C., still further preferably at approximately 950° C. and lower than or equal to 1000° C. An excessively low temperature might lead to insufficient decomposition and melting of the lithium source and the cobalt source. An excessively high temperature might lead to a defect due to evaporation of lithium from the lithium source and/or excessive reduction of cobalt, for example. An oxygen defect which could be induced by a change of trivalent cobalt into divalent cobalt due to excessive reduction, for example.

When the heating time is too short, lithium cobalt oxide is not synthesized, but when the heating time is too long, the productivity is lowered. Thus, the heating time is longer than or equal to 1 hour and shorter than or equal to 100 hours, preferably longer than or equal to 2 hours and shorter than or equal to 20 hours, still further preferably longer than or equal to 2 hours and shorter than or equal to 10 hours.

A temperature raising rate is preferably higher than or equal to 80° C./h and lower than or equal to 250° C./h although depending on the end-point temperature of the heating. For example, in the case of heating at 1000° C. for 10 hours, the temperature raising rate is preferably 200° C./h.

The heating is preferably performed in an atmosphere with little water such as a dry-air atmosphere and for example, the dew point of the atmosphere is preferably lower than or equal to −50° C., further preferably lower than or equal to −80° C. In this embodiment, the heating is performed in an atmosphere with a dew point of −93° C. To reduce impurities that might enter the material, the concentrations of impurities such as CH₄, CO, CO₂, and H₂ in the heating atmosphere are each preferably lower than or equal to 5 parts per billion (ppb).

The heating atmosphere is preferably an oxygen-containing atmosphere. In a method, a dry air is continuously introduced into a reaction chamber. The flow rate of a dry air in this case is preferably 10 L/min. Continuously introducing oxygen into a reaction chamber to make oxygen flow therein is referred to as “flowing”.

In the case where the heating atmosphere is an oxygen-containing atmosphere, flowing is not necessarily performed. For example, a method may be employed in which the pressure in the reaction chamber is reduced, the reaction chamber is filled (or “purged”) with oxygen, and the exit and entry of the oxygen are prevented. For example, the pressure in the reaction chamber may be reduced to −970 hPa and then, the reaction chamber may be filled with oxygen until the pressure becomes 50 hPa.

Cooling after the heating can be performed by letting the mixed material stand to cool, and the time it takes for the temperature to decrease to room temperature from a predetermined temperature is preferably longer than or equal to 10 hours and shorter than or equal to 50 hours. Note that the temperature does not necessarily need to decrease to room temperature as long as it decreases to a temperature acceptable to the next step.

The heating in this step may be performed with a rotary kiln or a roller hearth kiln. Heating with stirring can be performed in either case of a sequential rotary kiln or a batch-type rotary kiln.

A container used at the time of the heating is preferably a crucible or a sagger made of aluminum oxide. Almost no impurities enter the crucible made of aluminum oxide. In this embodiment, a sagger made of aluminum oxide with a purity of 99.9% is used. The heating is preferably performed with the crucible or the sagger covered with a lid, in which case volatilization of a material can be prevented.

The heated material is ground as needed and may be made to pass through a sieve. Before collection of the heated material, the material may be moved from the crucible to a mortar. As the mortar, a mortar made of zirconium oxide or agate is suitably used. Note that heating conditions equivalent to those in Step S13 can be employed in a later-described heating step other than Step S13.

### <Step S14>

Through the above steps, lithium cobalt oxide (LiCoO₂) can be synthesized as Step S14 in FIG. 4B. The lithium cobalt oxide (LiCoO₂) in Step S14 is an oxide containing a plurality of metal elements in its structure and thus can be referred to as a composite oxide. A composite oxide in this specification and the like refers to an oxide containing a plurality of metal elements in its structure. Note that the lithium cobalt oxide (LiCoO₂) shown in Step S14 may be obtained after adjusting particle size distribution by performing a grinding step and a classification step after Step S13.

Although the example is described in which the composite oxide is formed by a solid phase method as in Steps S11 to S14, the composite oxide may be formed by a coprecipitation method. Alternatively, the composite oxide may be formed by a hydrothermal method.

Through Steps S11 to S14, lithium cobalt oxide that is a starting material of a positive electrode active material applicable to a lithium ion battery having excellent discharge characteristics even in a low-temperature environment can be obtained. Specifically, as the lithium cobalt oxide that is a starting material, lithium cobalt oxide with a median diameter of less than or equal to 10 μm can be obtained.

### <Step S15>

Next, as Step S15 in FIG. 4A, the lithium cobalt oxide that is a starting material is heated. The heating in Step S15 is the first heating performed on the lithium cobalt oxide and thus is sometimes referred to as the initial heating in this specification and the like. The heating is performed before Step S31 described below and thus is sometimes referred to as preheating or pretreatment.

By the initial heating, a lithium compound or the like unintentionally remained on a surface of the lithium cobalt oxide is extracted. In addition, an effect of increasing the crystallinity of an inner portion can be expected. Although the lithium source and/or the cobalt source prepared in Step S11 and the like might contain impurities, impurities in the lithium cobalt oxide that is a starting material can be reduced by the initial heating. The effect of increasing the crystallinity of the inner portion is, for example, an effect of reducing distortion, a shift, or the like derived from differential shrinkage or the like of the lithium cobalt oxide formed in Step S14.

Furthermore, through the initial heating, the surface of the lithium cobalt oxide becomes smooth. A smooth surface in this specification and the like refers to a state where a particle of the composite oxide has little unevenness and is rounded as a whole and its corner portion is rounded. A smooth surface also refers to a surface to which few foreign matters are attached. Foreign matters are deemed to cause unevenness and are preferably not attached to a surface.

For the initial heating, a lithium compound source, an additive element source, or a material functioning as a fusing agent is not necessarily separately prepared.

When the heating time in this step is too short, an efficient effect is not obtained, but when the heating time in this step is too long, the productivity is lowered. For an appropriate range of heating time, for example, any of the heating conditions described in Step S13 can be selected. The heating temperature in Step S15 is preferably lower than that in Step S13 so that the crystal structure of the composite oxide is maintained. The heating time in Step S15 is preferably shorter than that in Step S13 so that the crystal structure of the composite oxide is maintained. For example, the heating is preferably performed at higher than or equal to 700° C. and lower than or equal to 1000° C. (further preferably higher than or equal to 800° C. and lower than or equal to 900° C.) for longer than or equal to 1 hour and shorter than or equal to 20 hours (further preferably longer than or equal to 1 hour and shorter than or equal to 5 hours).

The heating in Step S13 might cause a temperature difference between the surface and the inner portion of the lithium cobalt oxide. The temperature difference sometimes induces differential shrinkage. It can also be deemed that the temperature difference leads to a fluidity difference between the surface and the inner portion, thereby causing differential shrinkage. The energy involved in differential shrinkage causes a difference in internal stress in the lithium cobalt oxide. The difference in internal stress is also called distortion, and the above energy is sometimes referred to as distortion energy. The internal stress is eliminated by the initial heating in Step S15 and in other words, the distortion energy is probably equalized by the initial heating in Step S15. When the distortion energy is equalized, the distortion in the lithium cobalt oxide is relieved. Accordingly, it can be said that the surface of the lithium cobalt oxide becomes smooth, i.e., surface improvement is achieved. That is, performing Step S15 can reduce the differential shrinkage caused in the lithium cobalt oxide to make the surface of the composite oxide smooth.

Such differential shrinkage might cause a micro shift in the lithium cobalt oxide such as a shift in a crystal. To reduce this shift, Step S15 is preferably performed. Performing Step S15 can distribute a shift uniformly in the composite oxide (reduce the shift in a crystal or the like which is caused in the composite oxide or align crystal grains). As a result, the surface of the composite oxide becomes smooth.

In a secondary battery including lithium cobalt oxide with a smooth surface as a positive electrode active material, degradation by charge and discharge is suppressed and a crack in the positive electrode active material can be prevented.

Note that pre-synthesized lithium cobalt oxide with a median diameter of less than or equal to 10 μm may be used in Step S10 as described above. In this case, Steps S11 to S13 can be skipped. When Step S15 is performed on the pre-synthesized lithium cobalt oxide, lithium cobalt oxide with a smooth surface can be obtained.

Note that Step S15 is not essential in one embodiment of the present invention; thus, an embodiment in which Step S15 is skipped is also included in one embodiment of the present invention.

### <Step S20>

Next, details of Step S20 of preparing the additive element A as an A source is described with reference to FIGS. 4C and 4D.

### <Step S21>

Step S20 shown in FIG. 4C includes Steps S21 to S23. In Step S21, the additive element A is prepared. Specific examples of the additive element A include one or more selected from magnesium, fluorine, nickel, aluminum, titanium, zirconium, vanadium, iron, manganese, chromium, niobium, arsenic, zinc, silicon, sulfur, phosphorus, and boron. Furthermore, one or both of bromine and beryllium can be used. FIG. 4C shows the case where a magnesium source (Mg source) and a fluorine source (F source) are prepared. Note that in Step S21, a lithium source may be separately prepared in addition to the additive element A.

When magnesium is selected as the additive element A, an additive element A source can be referred to as a magnesium source. As the magnesium source, magnesium fluoride (MgF₂), magnesium oxide (MgO), magnesium hydroxide (Mg(OH)₂), magnesium carbonate (MgCO₃), or the like can be used. Two or more of these magnesium sources may be used.

When fluorine is selected as the additive element A, an additive element A source can be referred to as a fluorine source. As the fluorine source, for example, lithium fluoride (LiF), magnesium fluoride (MgF₂), aluminum fluoride (AlF₃), titanium fluoride (TiF₄), cobalt fluoride (CoF₂ and CoF₃), nickel fluoride (NiF₂), zirconium fluoride (ZrF₄), vanadium fluoride (VF₅), manganese fluoride, iron fluoride, chromium fluoride, niobium fluoride, zinc fluoride (ZnF₂), calcium fluoride (CaF₂), sodium fluoride (NaF), potassium fluoride (KF), barium fluoride (BaF₂), cerium fluoride (CeF₃ and CeF₄), lanthanum fluoride (LaF₃), sodium aluminum hexafluoride (Na₃AlF₆), or the like can be used. In particular, lithium fluoride is preferable because it is easily melted in a heating process described later owing to its relatively low melting point of 848° C.

Magnesium fluoride can be used as both the fluorine source and the magnesium source. Lithium fluoride can be used also as a lithium source. As the lithium source that can be used in Step S21, lithium carbonate can be given.

The fluorine source may be a gas; for example, fluorine (F₂), carbon fluoride, sulfur fluoride, oxygen fluoride (e.g., OF₂, O₂F₂, O₃F₂, O₄F₂, O₅F₂, O₆F₂, and O₂F), or the like may be used and mixed in the atmosphere in a heating step described later. Two or more of these fluorine sources may be used.

In this embodiment, lithium fluoride (LiF) is prepared as the fluorine source, and magnesium fluoride (MgF₂) is prepared as the fluorine source and the magnesium source. When lithium fluoride (LiF) and magnesium fluoride (MgF₂) are mixed at a molar ratio of approximately 65:35, the effect of lowering the melting point is maximized. When the proportion of lithium fluoride is too high, the cycle performance might deteriorate because of an excessive amount of lithium. Therefore, the molar ratio of lithium fluoride to magnesium fluoride (LiF:MgF₂) is preferably x:1 (0≤x≤1.9), further preferably x:1 (0.1≤x≤0.5), still further preferably x:1 (x=0.33 or an approximate value thereof). Note that unless otherwise specified, the expression “an approximate value of a given value” in this specification and the like means greater than 0.9 times and smaller than 1.1 times the given value.

### <Step S22>

Next, in Step S22 shown in FIG. 4C, the magnesium source and the fluorine source are ground and mixed. Any of the conditions for the grinding and mixing that are described for Step S12 can be selected to perform Step S22.

### <Step S23>

Next, in Step S23 shown in FIG. 4C, the materials ground and mixed in the above step are collected to give the additive element A source (A source). Note that the additive element A source in Step S23 contains a plurality of starting materials and can also be referred to as a mixture.

As for the particle diameter of the mixture, its median diameter (D50) is preferably greater than or equal to 100 nm and less than or equal to 10 μm, further preferably greater than or equal to 300 μm and less than or equal to 5 μm. Also when one kind of material is used as the additive element A source, the median diameter (D50) is preferably greater than or equal to 100 nm and less than or equal to 10 μm, further preferably greater than or equal to 300 μm and less than or equal to 5 μm.

Such a pulverized mixture in Step S22 (which may contain only one kind of additive element) is easily attached to the surface of a lithium cobalt oxide particle uniformly in a later step of mixing with the lithium cobalt oxide. The mixture is preferably attached uniformly to the surface of the lithium cobalt oxide particle, in which case an additive element is easily distributed or dispersed uniformly in the surface portion 100a of the composite oxide after heating.

### <Step S21>

A process different from that in FIG. 4C is described with reference to FIG. 4D. Step S20 shown in FIG. 4D includes Steps S21 to S23.

In Step S21 shown in FIG. 4D, four kinds of additive element A sources to be added to the lithium cobalt oxide are prepared. In other words, FIG. 4D is different from FIG. 4C in the kinds of the additive element A sources. A lithium source may be separately prepared in addition to the additive element A sources.

As the four kinds of additive element A sources, a magnesium source (Mg source), a fluorine source (F source), a nickel source (Ni source), and an aluminum source (A1 source) are prepared. The magnesium source and the fluorine source can be selected from the compounds and the like described with reference to FIG. 4C. As the nickel source, nickel oxide, nickel hydroxide, or the like can be used. As the aluminum source, aluminum oxide, aluminum hydroxide, or the like can be used.

### <Step S22> and <Step S23>

Steps S22 and S23 shown in FIG. 4D are similar to Steps S22 and S23 described with reference to FIG. 4C.

### <Step S31>

Next, in Step S31 shown in FIG. 4A, the lithium cobalt oxide obtained through Step S15 (initial heating) and the additive element A source (A source) are mixed. Here, the atomic ratio of cobalt Co in the lithium cobalt oxide obtained through Step S15 to magnesium Mg in the additive element A (Co:Mg) is preferably 100:y (0.1≤y≤6), further preferably 100:y (0.3≤y≤3). When the additive element A is added to the lithium cobalt oxide that has been subjected to the initial heating, the additive element A can be uniformly added. Thus, the initial heating (Step S15) is preferably performed not after the addition of the additive element A but before the addition of the additive element A.

When nickel is selected as the additive element A, the mixing in Step S31 is preferably performed such that the number of nickel atoms in the nickel source is greater than or equal to 0.05% and less than or equal to 4% of the number of cobalt atoms in the lithium cobalt oxide obtained through Step S15. When aluminum is selected as the additive element A, the mixing in Step S31 is preferably performed such that the number of aluminum atoms in the aluminum source is greater than or equal to 0.05% and less than or equal to 4% of the number of cobalt atoms in the lithium cobalt oxide obtained through Step S15.

The mixing in Step S31 is preferably performed under milder conditions than the mixing in Step S12, in order not to damage the shapes of the lithium cobalt oxide particles. For example, a condition with a smaller number of rotations or a shorter time than that for the mixing in Step S12 is preferable. Moreover, a dry method is regarded as a milder condition than a wet method. For example, a ball mill or a bead mill can be used for the mixing. When a ball mill is used, zirconium oxide balls are preferably used as a medium, for example.

In this embodiment, the mixing is performed with a ball mill using zirconium oxide balls with a diameter of 1 mm by a dry method at 150 rpm for 1 hour. The mixing is performed in a dry room the dew point of which is higher than or equal to −100° C. and lower than or equal to −10° C.

### <Step S32>

Next, in Step S32 in FIG. 4A, the materials mixed in the above step are collected, whereby a mixture 903 is obtained. At the time of the collection, the materials may be crushed as needed and made to pass through a sieve.

### <Step S33>

Next, in Step S33 shown in FIG. 4A, the mixture 903 is heated. The heating in Step S33 is preferably performed at higher than or equal to 800° C. and lower than or equal to 1100° C., further preferably at higher than or equal to 800° C. and lower than or equal to 950° C., still further preferably at higher than or equal to 850° C. and lower than or equal to 900° C. The heating time in Step S33 is longer than or equal to 1 hour and shorter than or equal to 100 hours and is preferably longer than or equal to 1 hour and shorter than or equal to 10 hours. The lower limit of the heating temperature in Step S33 needs to be higher than or equal to the temperature at which a reaction between the lithium cobalt oxide and the additive element A source proceeds. The temperature at which the reaction proceeds is the temperature at which interdiffusion of the elements included in the lithium cobalt oxide and the additive element A source occurs, and may be lower than the melting temperatures of these materials. In the case where an oxide is described as an example, solid phase diffusion occurs at the Tamman temperature T_{d} (0.757 times the melting temperature Tₘ); thus, the heating temperature in Step S33 is higher than or equal to 500° C.

Note that the reaction more easily proceeds at a temperature higher than or equal to the temperature at which one or more selected from the materials contained in the mixture 903 are melted. For example, in the case where LiF and MgF₂ are included in the additive element A source, the lower limit of the heating temperature in Step S33 is preferably higher than or equal to 742° C. because the eutectic point of LiF and MgF₂ is around 742° C.

The mixture 903 obtained by mixing such that LiCoO₂:LiF:MgF₂=100:0.33:1 (molar ratio) exhibits an endothermic peak at around 830° C. in differential scanning calorimetry (DSC) measurement. Therefore, the lower limit of the heating temperature is further preferably higher than or equal to 830° C.

A higher heating temperature is preferable because it facilitates the reaction, shortens the heating time, and enables high productivity.

The upper limit of the heating temperature is lower than the decomposition temperature of the lithium cobalt oxide (1130° C.). At around the decomposition temperature, a slight amount of the lithium cobalt oxide might be decomposed. Thus, the upper limit of the heating temperature is preferably lower than or equal to 1000° C., further preferably lower than or equal to 950° C., still further preferably lower than or equal to 900° C.

In addition, at the time of heating the mixture 903, the partial pressure of fluorine or a fluoride originating from the fluorine source or the like is preferably controlled to be within an appropriate range.

In the formation method described in this embodiment, some of the materials, e.g., LiF as the fluorine source, function as a fusing agent in some cases. Owing to the material functioning as a fusing agent, the heating temperature can be lower than the decomposition temperature of the lithium cobalt oxide, e.g., higher than or equal to 742° C. and lower than or equal to 950° C., which allows distribution of the additive element such as magnesium in the surface portion and formation of a positive electrode active material having favorable characteristics.

Since LiF in a gas phase has a specific gravity less than that of oxygen, heating might volatilize or sublimate LiF and, which might decrease LiF in the mixture 903. In this case, the function of a fusing agent deteriorates. Accordingly, heating is preferably performed while volatilization of LiF is inhibited. Note that even when LiF is not used as the fluorine source or the like, Li at the surface of LiCoO₂ and F of the fluorine source might react to produce LiF, which might be volatilized. Therefore, such inhibition of volatilization is needed also when a fluoride having a higher melting point than LiF is used.

In view of this, the mixture 903 is preferably heated in an atmosphere containing LiF, i.e., the mixture 903 is preferably heated in a state where the partial pressure of LiF in a heating furnace is high. Such heating can inhibit volatilization of LiF in the mixture 903.

The heating in this step is preferably performed such that the particles of the mixture 903 are not adhered to each other. Adhesion of the particles of the mixture 903 during the heating might decrease the area of contact with oxygen in the atmosphere and inhibit a path of diffusion of the additive element (e.g., fluorine), thereby hindering distribution of the additive element (e.g., magnesium and fluorine) in the surface portion.

Uniform distribution of the additive element (e.g., fluorine) in the surface portion leads to a smooth positive electrode active material with little unevenness. Thus, it is preferable that the particles of the mixture 903 not be adhered to each other in order to allow the smooth surface obtained through the heating in Step S15 to be maintained or to be smoother in this step.

In the case of using a rotary kiln for the heating, the flow rate of an oxygen-containing atmosphere in the kiln is preferably controlled during the heating. For example, the flow rate of an oxygen-containing atmosphere is preferably set low, or no flowing of an atmosphere is preferably performed after an atmosphere is purged first and an oxygen atmosphere is introduced into the kiln. Flowing of oxygen is not preferable because it might cause evaporation of the fluorine source, which prevents maintaining the smoothness of the surface.

In the case of using a roller hearth kiln for the heating, the mixture 903 can be heated in an atmosphere containing LiF with the container in which the mixture 903 is put covered with a lid.

### <Step S34>

Next, the heated material is collected in Step S34 shown in FIG. 4A, in which crushing is performed as needed; thus, the positive electrode active material 100 is obtained. Here, the collected particles of the positive electrode active material 100 are preferably made to pass through a sieve. Through the above process, the positive electrode active material 100 (composite oxide) with a median diameter of less than or equal to 12 μm (preferably less than or equal to 10.5 μm, further preferably less than or equal to 8 μm) can be formed. Note that the positive electrode active material 100 contains the additive element A.

<Example 2 of formation method of positive electrode active material>

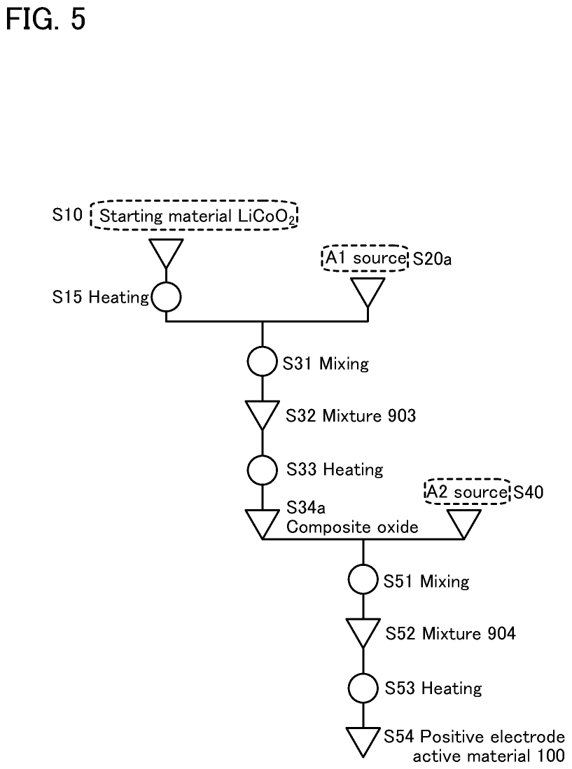

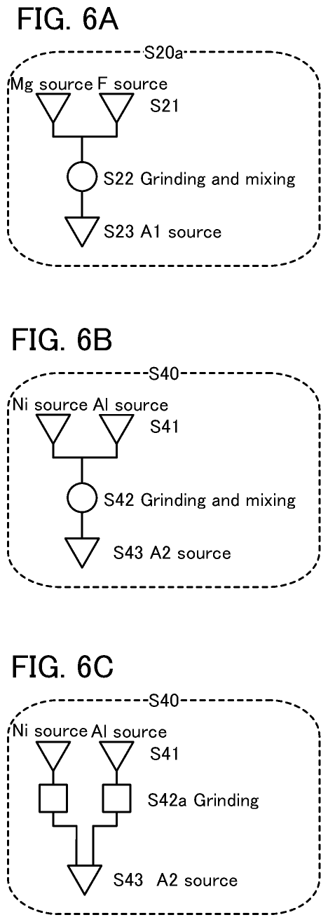

Another example of a formation method of a positive electrode active material that can be used as one embodiment of the present invention (Example 2 of formation method of positive electrode active material) is described with reference to FIG. 5 and FIGS. 6A to 6C. Although <Example 2 of formation method of positive electrode active material> is different from <Example 1 of formation method of positive electrode active material> above in the number of times of adding the additive element and a mixing method, for the description except for the above, the description of <Example 1 of formation method of positive electrode active material> can be referred to. Note that in <Example 2 of formation method of positive electrode active material>, the additive element X described in Embodiment 1 is referred to as an additive element A1. In addition, the additive elements Y and Z described in Embodiment 1 are collectively referred to as an additive element A2.

Steps S10 and S15 in FIG. 5 are performed as in FIG. 4A to prepare lithium cobalt oxide that has been subjected to the initial heating. Note that Step S15 is not essential in one embodiment of the present invention; thus, an embodiment in which Step S15 is skipped is also included in one embodiment of the present invention.

### <Step S20a>

Next, as shown in Step S20a, a first additive element A1 source (A1 source) is prepared. Details of Step S20a is described with reference to FIG. 6A.

### <Step S21>

In Step S21 shown in FIG. 6A, the first additive element A1 source (A1 source) is prepared. For the A1 source, any of the additive elements A described for Step S21 with reference to FIG. 4C can be used. For example, one or more elements selected from magnesium, fluorine, and calcium can be used as the additive element A1 source. FIG. 6A shows an example of using a magnesium source (Mg source) and a fluorine source (F source) as the additive element A1 source.

Steps S21 to S23 shown in FIG. 6A can be performed under conditions similar to those of Steps S21 to S23 shown in FIG. 4C, whereby the additive element A1 source (A1 source) can be obtained in Step S23.

Steps S31 to S33 shown in FIG. 5 can be performed under conditions similar to those of Steps S31 to S33 shown in FIG. 4A.

### <Step S34a>

Next, the material heated in Step S33 is collected to obtain lithium cobalt oxide containing the additive element A1. Here, the composite oxide is called a second composite oxide to be distinguished from the lithium cobalt oxide obtained through Step S15 (first composite oxide).

### <Step S40>

In Step S40 shown in FIG. 5, a second additive element A2 source (A2 source) is prepared. Step S40 is described with reference to FIGS. 6B and 6C.

### <Step S41>

In Step S41 shown in FIG. 6B, the second additive element A2 source (A2 source) is prepared. For the A2 source, any of the additive elements A described for Step S20 with reference to FIG. 4C can be used. For example, one or more elements selected from nickel, titanium, boron, zirconium, and aluminum can be suitably used as the additive element A2 source. FIG. 6B shows an example of using a nickel source (Ni source) and an aluminum source (A1 source) as the additive element A2 source.

Steps S41 to S43 shown in FIG. 6B can be performed under conditions similar to those of Steps S21 to S23 shown in FIG. 4C, whereby the additive element A2 source (A2 source) can be obtained in Step S43.

FIG. 6C showing Steps S41 to S43 is a variation example of FIG. 6B. A nickel source (Ni source) and an aluminum source (A1 source) are prepared in Step S41 shown in FIG. 6C and are separately ground in Step S42a. Accordingly, a plurality of second additive element A2 sources (A2 sources) are prepared in Step S43. As described above, Step S40 in FIG. 6C is different from Step S40 in FIG. 6B in that the additive element sources are separately ground in Step S42a.

### <Steps S51 to S53>

Next, Steps S51 to S53 shown in FIG. 5 can be performed under conditions similar to those of Steps S31 to S34 shown in FIG. 4A. The heating in Step S53 is preferably performed at a lower temperature and/or in a shorter time than the heating in Step S33 shown in FIG. 5. Specifically, the heating is preferably performed at higher than or equal to 800° C. and lower than or equal to 950° C., further preferably at higher than or equal to 820° C. and lower than or equal to 870° C., still further preferably at 850° C.±10° C. The heating time is preferably longer than or equal to 0.5 hours and shorter than or equal to 8 hours, further preferably longer than or equal to 1 hour and shorter than or equal to 5 hours.

When nickel is selected as the additive element A2, the mixing in Step S51 is preferably performed such that the number of nickel atoms in the nickel source is greater than or equal to 0.05% and less than or equal to 4% of the number of cobalt atoms in the lithium cobalt oxide obtained through Step S15. When aluminum is selected as the additive element A2, the mixing in Step S51 is preferably performed such that the number of aluminum atoms in the aluminum source is greater than or equal to 0.05% and less than or equal to 4% of the number of cobalt atoms in the lithium cobalt oxide obtained through Step S15.

### <Step S54>

Next, the heated material is collected in Step S54 shown in FIG. 5, in which crushing is performed as needed; thus, the positive electrode active material 100 is obtained. Through the above process, the positive electrode active material 100 (composite oxide) with a median diameter of less than or equal to 12 μm (preferably less than or equal to 10.5 μm, further preferably less than or equal to 8 μm) can be formed.

Alternatively, the positive electrode active material 100 applicable to a lithium ion battery having excellent discharge characteristics even in a low-temperature environment can be formed. Note that the positive electrode active material 100 contains the additive elements A1 and A2.

As shown in FIG. 5 and FIGS. 6A to 6C, in Example 2 of the formation method above, introduction of the additive element to the lithium cobalt oxide is separated into introduction of the first additive element A1 and that of the second additive element A2. When the elements are separately introduced, the additive elements can have different profiles in the depth direction. For example, the first additive element can have a profile such that the concentration is higher in the surface portion than in the inner portion, and the second additive element can have a profile such that the concentration is higher in the inner portion than in the surface portion. The positive electrode active material 100 formed through the steps in FIGS. 4A and 4D has an advantage of being formed at low cost since a plurality of kinds of additive elements A are added at the same time. Meanwhile, although the formation cost of the positive electrode active material 100 formed through the steps in FIG. 5 and FIGS. 6A to 6C is relatively high since a plurality of kinds of additive element A sources are added in a plurality of steps, a profile of each of the additive elements A in the depth direction can be accurately controlled, which is preferable.

### Embodiment 3

In this embodiment, components included in a lithium ion battery are described.

### [Positive Electrode]

The positive electrode includes a positive electrode active material layer and a positive electrode current collector. The positive electrode active material layer contains a positive electrode active material and may further contain at least one of a conductive material and a binder. The positive electrode active material can be any of the ones described in Embodiment 1.

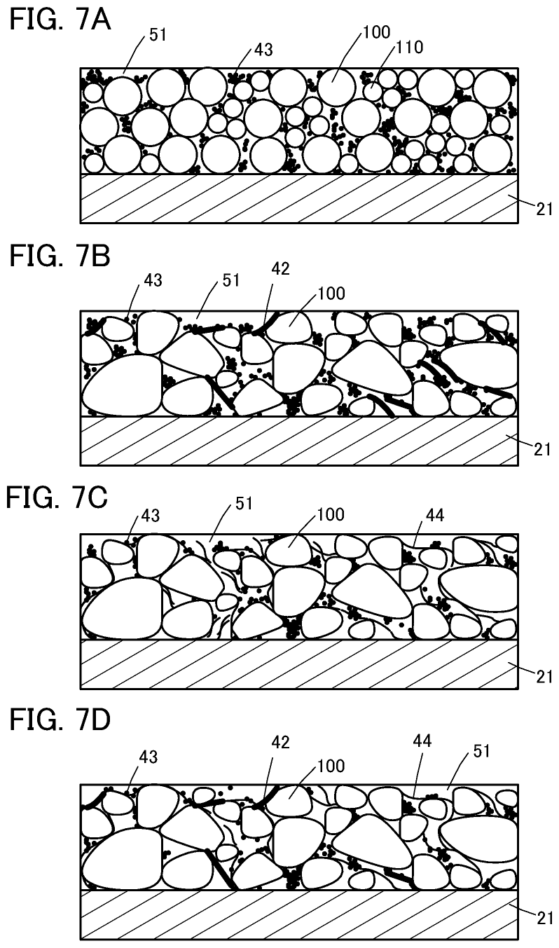

FIG. 7A illustrates an example of a schematic cross-sectional view of the positive electrode.

For example, metal foil can be used for the positive electrode current collector 21. The positive electrode can be formed by applying slurry onto metal foil and drying the slurry. Note that pressing may be performed after drying. The positive electrode is a component obtained by forming an active material layer over the positive electrode current collector 21.

Slurry refers to a material solution that is used to form an active material layer over the positive electrode current collector 21 and includes an active material, a binder, and a solvent, preferably also a conductive material mixed therewith. Slurry may also be referred to as slurry for an electrode or active material slurry; in some cases, slurry for forming a positive electrode active material layer is referred to as slurry for a positive electrode, and slurry for forming a negative electrode active material layer is referred to as slurry for a negative electrode.

The positive electrode active material 100 has functions of taking and releasing lithium ions in accordance with charge and discharge. For the positive electrode active material 100 used as one embodiment of the present invention, a material with less deterioration due to charge and discharge even at high charge voltage can be used. Note that in this specification and the like, unless otherwise specified, charge voltage is shown with reference to the potential of a lithium metal.

For the positive electrode active material 100 used as one embodiment of the present invention, any material can be used as long as it has less deterioration due to charge and discharge even at high charge voltage, and any of the materials described in Embodiment 1 or 2 can be used. Note that for the positive electrode active material 100, two or more kinds of materials having different particle diameters can be used as long as the materials have less deterioration due to charge and discharge even at high charge voltage.

FIGS. 7A to 7D illustrate variation examples of the positive electrode active material layer illustrated in FIG. 1B.

In FIG. 7A illustrates carbon black 43 that is an example of a conductive material and the electrolyte 51 included in a void portion positioned between the particles of the positive electrode active material 100. In the example in FIG. 7A, a second positive electrode active material 110 is also included in addition to the positive electrode active material 100.

In the positive electrode of the secondary battery, a binder (a resin) may be mixed in order to fix the positive electrode current collector 21 such as metal foil and the active material. The binder is also referred to as a binding agent. Since the binder is a high molecular material, a large amount of binder lowers the proportion of the active material in the positive electrode, thereby reducing the discharge capacity of the secondary battery. Therefore, the amount of binder mixed is preferably reduced to a minimum.

Although FIG. 7A illustrates an example in which the positive electrode active material 100 has a spherical shape, there is no particular limitation. For example, the cross-sectional shape of the positive electrode active material 100 may be an ellipse, a rectangle, a trapezoid, a triangle, a polygon with rounded corners, or an asymmetrical shape. For example, FIG. 7B illustrates an example in which the positive electrode active material 100 has a polygon shape with rounded corners.

In the positive electrode in FIG. 7B, graphene 42 is used as a carbon material used as the conductive material. FIG. 7B illustrates a positive electrode active material layer in which the positive electrode active material 100, the graphene 42, and the carbon black 43 are provided over the positive electrode current collector 21.

In the step of mixing the graphene 42 and the carbon black 43 to obtain an electrode slurry, the weight of mixed carbon black is preferably 1.5 times to 20 times, further preferably 2 times to 9.5 times the weight of graphene.

When the graphene 42 and the carbon black 43 are mixed in the above range, the carbon black 43 can be dispersed uniformly and less likely to be aggregated at the time of preparing the slurry. Furthermore, a positive electrode containing the graphene 42 and the carbon black 43 which are mixed in the above range can have higher density than that including only the carbon black 43 as the conductive material. As the electrode density is higher, the capacity per unit weight can be higher. Specifically, the density of the positive electrode active material layer measured by gravimetry can be higher than or equal to 3.5 g/cc.

A positive electrode containing a first carbon material (graphene) and a second carbon material (acetylene black) which are mixed in the above range enables fast charging, which is particularly effective for an in-vehicle secondary battery, through having lower electrode density than a positive electrode containing only graphene as a conductive material.

FIG. 7C illustrates an example of a positive electrode using carbon fiber 44 instead of graphene. FIG. 7C illustrates the example different from that in FIG. 7B. With the use of the carbon fiber 44, aggregation of carbon black 43 can be prevented and the dispersibility can be increased.

In FIG. 7C, a region that is not filled with the positive electrode active material 100, the carbon fiber 44, or the carbon black 43 represents a space or a binder.

FIG. 7D illustrates another example of the positive electrode. FIG. 7D illustrates an example in which the carbon fiber 44 is used in addition to the graphene 42.

With the use of both the graphene 42 and the carbon fiber 44, aggregation of carbon black such as the carbon black 43 can be prevented and the dispersibility can be further increased.

In FIG. 7D, a region that is not filled with the positive electrode active material 100, the carbon fiber 44, the graphene 42, or the carbon black 43 represents a space or a binder.

A secondary battery can be fabricated by using any one of the positive electrodes in FIGS. 7A to 7D; setting, in a container (e.g., an exterior body or a metal can), a stack in which a separator is provided over the positive electrode and a negative electrode is provided over the separator; and filling the container with an electrolyte solution.

### <Binder>

As the binder, a rubber material such as styrene-butadiene rubber (SBR), styrene-isoprene-styrene rubber, acrylonitrile-butadiene rubber, butadiene rubber, or ethylene-propylene-diene copolymer is preferably used, for example. Alternatively, fluororubber can be used as the binder.

As the binder, for example, water-soluble polymers are preferably used. As the water-soluble polymers, a polysaccharide can be used, for example. Examples of the polysaccharide include a cellulose derivative such as carboxymethyl cellulose (CMC), methyl cellulose, ethyl cellulose, hydroxypropyl cellulose, diacetyl cellulose, and regenerated cellulose, or starch. It is further preferable that such water-soluble polymers be used in combination with any of the above rubber materials.

Alternatively, as the binder, a material such as polystyrene, poly(methyl acrylate), poly(methyl methacrylate) (PMMA), sodium polyacrylate, polyvinyl alcohol (PVA), polyethylene oxide (PEO), polypropylene oxide, polyimide, polyvinyl chloride, polytetrafluoroethylene, polyethylene, polypropylene, polyisobutylene, polyethylene terephthalate, nylon, polyvinylidene fluoride (PVDF), polyacrylonitrile (PAN), ethylene-propylene-diene polymer, polyvinyl acetate, or nitrocellulose is preferably used.

At least two of the above materials may be used in combination for the binder.

For example, a material having a significant viscosity modifying effect and another material may be used in combination. For example, a rubber material or the like has high adhesion and high elasticity but may have difficulty in viscosity modification when mixed in a solvent. In such a case, a rubber material or the like is preferably mixed with a material having a significant viscosity modifying effect, for example. As a material having a significant viscosity modifying effect, for instance, a water-soluble polymer is preferably used. An example of a water-soluble polymer having a significant viscosity modifying effect is the above-mentioned polysaccharide; for instance, a cellulose derivative such as carboxymethyl cellulose (CMC), methyl cellulose, ethyl cellulose, hydroxypropyl cellulose, diacetyl cellulose, or regenerated cellulose, or starch can be used.

Note that a cellulose derivative such as carboxymethyl cellulose obtains a higher solubility when converted into a salt such as a sodium salt or an ammonium salt of carboxymethyl cellulose, and thus easily exerts an effect as a viscosity modifier. A high solubility can also increase the dispersibility of an active material or other components in the formation of slurry for an electrode. In this specification and the like, cellulose and a cellulose derivative used as a binder of an electrode include salts thereof.

A water-soluble polymer stabilizes the viscosity by being dissolved in water and allows stable dispersion of the active material and another material combined as a binder, such as styrene-butadiene rubber, in an aqueous solution. Furthermore, a water-soluble polymer is expected to be easily and stably adsorbed onto an active material surface because it has a functional group. Many cellulose derivatives, such as carboxymethyl cellulose, have a functional group such as a hydroxyl group or a carboxyl group. Because of functional groups, polymers are expected to interact with each other and cover an active material surface in a large area.

In the case where the binder that covers or is in contact with the active material surface forms a film, the film is expected to serve also as a passivation film to suppress the decomposition of the electrolyte solution. Here, a passivation film refers to a film without electric conductivity or a film with extremely low electric conductivity, and can inhibit the decomposition of an electrolyte solution at a potential at which a battery reaction occurs when the passivation film is formed on the active material surface, for example. It is preferred that the passivation film can conduct lithium ions while suppressing electrical conduction.

### <Conductive Material>

A conductive material is also referred to as a conductivity-imparting agent and a conductive additive, and a carbon material is used as the conductive material. A conductive material is attached between a plurality of active materials, whereby the plurality of active materials are electrically connected to each other, and the conductivity increases. Note that the term “attach” refers not only to a state where an active material and a conductive material are physically in close contact with each other, and includes, for example, the following concepts: the case where covalent bonding occurs, the case where bonding with the Van der Waals force occurs, the case where a conductive material covers part of the surface of an active material, the case where a conductive material is embedded in surface roughness of an active material, and the case where an active material and a conductive material are electrically connected to each other without being in contact with each other.

An active material layer such as a positive electrode active material layer or a negative electrode active material layer preferably contains a conductive material.

As the conductive material, for example, one or more kinds of carbon black such as acetylene black or furnace black, graphite such as artificial graphite or natural graphite, carbon fiber such as carbon nanofiber or carbon nanotube, and a graphene compound can be used.

Examples of the carbon fiber include mesophase pitch-based carbon fiber and isotropic pitch-based carbon fiber. As the carbon fiber, carbon nanofiber, carbon nanotube, or the like can be used. Carbon nanotube can be formed by, for example, a vapor deposition method.

A graphene compound in this specification and the like refers to graphene, multilayer graphene, multi graphene, graphene oxide, multilayer graphene oxide, multi graphene oxide, reduced graphene oxide, reduced multilayer graphene oxide, reduced multi graphene oxide, graphene quantum dots, and the like. A graphene compound contains carbon, has a plate-like shape, a sheet-like shape, or the like, and has a two-dimensional structure formed of a six-membered ring composed of carbon atoms. The two-dimensional structure formed of the six-membered ring composed of carbon atoms may be referred to as a carbon sheet. A graphene compound may include a functional group. The graphene compound is preferably bent. The graphene compound may be rounded like a carbon nanofiber.

The content of the conductive material to the total amount of the active material layer is preferably greater than or equal to 1 wt % and less than or equal to 10 wt %, further preferably greater than or equal to 1 wt % and less than or equal to 5 wt %.

Unlike a particulate conductive material such as carbon black, which makes point contact with an active material, the graphene compound is capable of making low-resistance surface contact; accordingly, the electrical conduction between the particulate active material and the graphene compound can be improved with a smaller amount of the graphene compound than that of a normal conductive material. This can increase the proportion of the active material in the active material layer. Accordingly, the discharge capacity of a battery can be increased.

A compound containing particulate carbon such as carbon black or graphite or a compound containing fibrous carbon such as carbon nanotube easily enters a microscopic space. A microscopic space refers to, for example, a region between a plurality of active materials. When a carbon-containing compound that easily enters a microscopic space and a compound containing sheet-like carbon, such as graphene, that can impart conductivity to a plurality of particles are used in combination, the density of the electrode increases and an excellent conductive path can be formed. The battery obtained by the fabrication method of one embodiment of the present invention can have high capacitive density and stability, and is effective as an in-vehicle battery.

### <Positive Electrode Current Collector>

The positive electrode current collector can be formed using a material that has high conductivity, such as a metal like stainless steel, gold, platinum, aluminum, or titanium, or an alloy thereof. It is preferred that a material used for the positive electrode current collector not dissolve at the potential of the positive electrode. It is also possible to use an aluminum alloy to which an element that improves heat resistance, such as silicon, titanium, neodymium, scandium, or molybdenum, is added. A metal element that forms silicide by reacting with silicon may be used. Examples of the metal element that forms silicide by reacting with silicon include zirconium, titanium, hafnium, vanadium, niobium, tantalum, chromium, molybdenum, tungsten, cobalt, and nickel. The current collector can have a foil-like shape, a plate-like shape, a sheet-like shape, a net-like shape, a punching-metal shape, an expanded-metal shape, or the like as appropriate. The current collector preferably has a thickness greater than or equal to 5 μm and less than or equal to 30 μm.

### [Negative Electrode]

The negative electrode includes a negative electrode active material layer and a negative electrode current collector. The negative electrode active material layer contains a negative electrode active material, and may also contain a conductive material and a binder.

### <Negative Electrode Active Material>

As the negative electrode active material, for example, an alloy-based material or a carbon material can be used.

As the negative electrode active material, an element that enables charge and discharge reactions by alloying and dealloying reactions with lithium can be used. For example, a material containing at least one of silicon, tin, gallium, aluminum, germanium, lead, antimony, bismuth, silver, zinc, cadmium, indium, and the like can be used. Such elements have higher capacity than carbon. In particular, silicon has a high theoretical capacity of 4200 mAh/g. For this reason, silicon is preferably used as the negative electrode active material. Alternatively, a compound containing any of the above elements may be used. Examples of the compound include SiO, Mg₂Si, Mg₂Ge, SnO, SnO₂, Mg₂Sn, SnS₂, V₂Sn₃, FeSn₂, CoSn₂, Ni₃Sn₂, Cu₆Sn₅, Ag₃Sn, Ag₃Sb, Ni₂MnSb, CeSb₃, LaSn₃, La₃Co₂Sn₇, CoSb₃, InSb, and SbSn. Here, an element that enables charge and discharge reactions by alloying and dealloying reactions with lithium, a compound containing the element, and the like may be referred to as an alloy-based material.

In this specification and the like, SiO refers to silicon monoxide, for example. Note that SiO can alternatively be expressed as SiOₓ. Here, it is preferred that x be 1 or have an approximate value of 1. For example, x is preferably more than or equal to 0.2 and less than or equal to 1.5, further preferably more than or equal to 0.3 and less than or equal to 1.2.

As the carbon material, graphite, graphitizing carbon (soft carbon), non-graphitizing carbon (hard carbon), carbon fiber (carbon nanotube), graphene, carbon black, or the like can be used.

Examples of graphite include artificial graphite and natural graphite. Examples of artificial graphite include mesocarbon microbeads (MCMB), coke-based artificial graphite, and pitch-based artificial graphite. As artificial graphite, spherical graphite having a spherical shape can be used. For example, MCMB is preferably used because it may have a spherical shape. Moreover, MCMB may preferably be used because it can relatively easily have a small surface area. Examples of natural graphite include flake graphite and spherical natural graphite.

Graphite has a low potential substantially equal to that of a lithium metal (higher than or equal to 0.05 V and lower than or equal to 0.3 V vs. Li/Li⁺) when lithium ions are intercalated into the graphite (while a lithium-graphite intercalation compound is generated). For this reason, a lithium ion battery using graphite can have a high operating voltage. In addition, graphite is preferred because of its advantages such as a relatively high capacity per unit volume, relatively small volume expansion, low cost, and higher level of safety than that of a lithium metal.

As the negative electrode active material, an oxide such as titanium dioxide (TiO₂), lithium titanium oxide (Li₄Ti₅O₁₂), a lithium-graphite intercalation compound (LiₓC₆), niobium pentoxide (Nb₂O₅), tungsten oxide (WO₂), or molybdenum oxide (MoO₂) can be used.

Alternatively, as the negative electrode active material, Li₃₋ₓMₓN (M is Co, Ni, or Cu) with a Li₃N structure, which is a nitride containing lithium and a transition metal, can be used. For example, Li_{2.6}Co_{0.4}N₃ is preferable because of high discharge capacity (900 mAh/g and 1890 mAh/cm³).

A nitride containing lithium and a transition metal is preferably used, in which case lithium ions are contained in the negative electrode active material and thus the negative electrode active material can be used in combination with a positive electrode active material that does not contain lithium ions, such as V₂O₅ or Cr₃O₈. Note that in the case of using a material containing lithium ions as a positive electrode active material, the nitride containing lithium and a transition metal can be used as the negative electrode active material by extracting the lithium ions contained in the positive electrode active material in advance.

Alternatively, a material that causes a conversion reaction can be used as the negative electrode active material. For example, a transition metal oxide that does not form an alloy with lithium, such as cobalt oxide (CoO), nickel oxide (NiO), and iron oxide (FeO), may be used. Other examples of the material that causes a conversion reaction include oxides such as Fe₂O₃, CuO, Cu₂O, RuO₂, and Cr₂O₃, sulfides such as CoS_{0.89}, NiS, and CuS, nitrides such as Zn₃N₂, Cu₃N, and Ge₃N₄, phosphides such as NiP₂, FeP₂, and CoP₃, and fluorides such as FeF₃ and BiF₃.

As another mode of the negative electrode, a negative electrode that does not contain a negative electrode active material after completion of the fabrication of the battery may be used. As the negative electrode that does not contain a negative electrode active material, for example, a negative electrode can be used in which only a negative electrode current collector is included after completion of the fabrication of the battery and in which lithium ions extracted from the positive electrode active material due to charge of the battery are deposited as a lithium metal over the negative electrode current collector and form the negative electrode active material layer. A battery including such a negative electrode is referred to as a negative electrode-free (anode-free) battery, a negative electrodeless (anodeless) battery, or the like in some cases.

When the negative electrode that does not contain a negative electrode active material is used, a film may be included over a negative electrode current collector for uniforming lithium deposition. For the film for uniforming lithium deposition, for example, a solid electrolyte having lithium ion conductivity can be used. As the solid electrolyte, a sulfide-based solid electrolyte, an oxide-based solid electrolyte, a polymer-based solid electrolyte, or the like can be used. In particular, the polymer-based solid electrolyte can be uniformly formed as a film over a negative electrode current collector relatively easily, and thus is preferable as the film for uniforming lithium deposition. Moreover, as the film for uniforming lithium deposition, for example, a metal film that forms an alloy with lithium can be used. As the metal film that forms an alloy with lithium, for example, a magnesium metal film can be used. Lithium and magnesium form a solid solution in a wide range of compositions, and thus is suitable for the film for uniforming lithium deposition.

When the negative electrode that does not contain a negative electrode active material is used, a negative electrode current collector having unevenness can be used. When the negative electrode current collector having unevenness is used, a depression of the negative electrode current collector becomes a hollow in which lithium contained in the negative electrode current collector is easily deposited, so that the lithium can be prevented from having a dendrite-like shape when being deposited.

For the conductive material and the binder that can be included in the negative electrode active material layer, materials similar to those for the conductive material and the binder that can be included in the positive electrode active material layer can be used.

### <Negative Electrode Current Collector>

For the negative electrode current collector, copper or the like can be used in addition to a material similar to that for the positive electrode current collector. Note that a material that is not alloyed with carrier ions of lithium or the like is preferably used for the negative electrode current collector.

### [Electrolyte]

As the electrolyte, any of the electrolytes described in Embodiment 1 can be used.

### [Separator]

When the electrolyte includes an electrolyte solution, the separator is positioned between the positive electrode and the negative electrode. The separator can be formed using, for example, a fiber containing cellulose, such as paper, nonwoven fabric, glass fiber, ceramics, or synthetic fiber containing nylon (polyamide), vinylon (polyvinyl alcohol-based fiber), polyester, acrylic, polyolefin, or polyurethane. The separator is preferably processed into a bag-like shape to enclose one of the positive electrode and the negative electrode.

The separator may have a multilayer structure. For example, an organic material film of polypropylene, polyethylene, or the like can be coated with a ceramics-based material, a fluorine-based material, a polyamide-based material, a mixture thereof, or the like. Examples of the ceramics-based material include aluminum oxide particles and silicon oxide particles. Examples of the fluorine-based material include PVDF and polytetrafluoroethylene. Examples of the polyamide-based material include nylon and aramid (meta-based aramid and para-based aramid).

When the separator is coated with the ceramics-based material, the oxidation resistance is improved; hence, deterioration of the separator in charge at high voltage and discharge can be suppressed and thus the reliability of the secondary battery can be improved. When the separator is coated with the fluorine-based material, the separator is easily brought into close contact with an electrode, resulting in high output characteristics. When the separator is coated with the polyamide-based material, in particular, aramid, the safety of the secondary battery is improved because heat resistance is improved.

For example, both surfaces of a polypropylene film may be coated with a mixed material of aluminum oxide and aramid. Alternatively, a surface of a polypropylene film that is in contact with the positive electrode may be coated with a mixed material of aluminum oxide and aramid, and a surface of the polypropylene film that is in contact with the negative electrode may be coated with the fluorine-based material.

With the use of a separator having a multilayer structure, the capacity per volume of the secondary battery can be increased because the safety of the secondary battery can be maintained even when the total thickness of the separator is small.

### [Exterior Body]

For an exterior body included in the secondary battery, a metal material such as aluminum or a resin material can be used, for example. A film-like exterior body can also be used. As the film, for example, it is possible to use a film having a three-layer structure in which a highly flexible metal thin film of aluminum, stainless steel, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided over the metal thin film as the outer surface of the exterior body.

### Embodiment 4

This embodiment describes examples of shapes of a secondary battery including a positive electrode formed by the formation method described in the foregoing embodiments.

### [Coin-Type Secondary Battery]

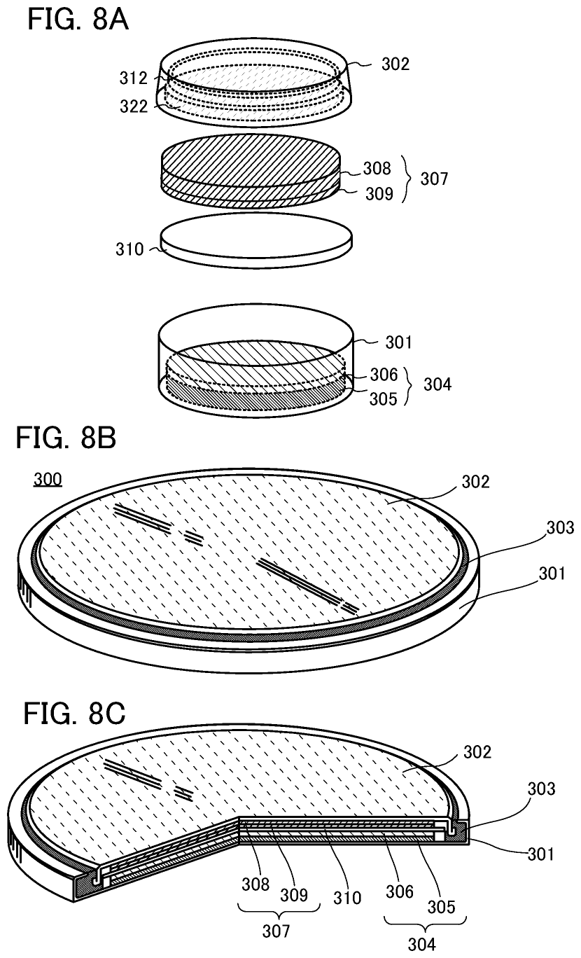

An example of a coin-type secondary battery is described. FIG. 8A, FIG. 8B, and FIG. 8C are an exploded perspective view, an external view, and a cross-sectional view of a coin-type (single-layer flat) secondary battery. Coin-type secondary batteries are mainly used in small electronic devices.

For easy understanding, FIG. 8A is a schematic view illustrating overlap (a vertical relation and a positional relation) between components. Thus, FIG. 8A and FIG. 8B do not completely correspond with each other.

In FIG. 8A, a positive electrode 304, a separator 310, a negative electrode 307, a spacer 322, and a washer 312 are overlaid. They are sealed with a negative electrode can 302, a positive electrode can 301, and a gasket. Note that the gasket for sealing is not illustrated in FIG. 8A. The spacer 322 and the washer 312 are used to protect the inside or fix the position of the components inside the cans at the time when the positive electrode can 301 and the negative electrode can 302 are bonded with pressure. For the spacer 322 and the washer 312, stainless steel or an insulating material is used.

The positive electrode 304 is a stack in which a positive electrode active material layer 306 is formed over a positive electrode current collector 305.

FIG. 8B is a perspective view of a completed coin-type secondary battery.

In a coin-type secondary battery 300, the positive electrode can 301 doubling as a positive electrode terminal and the negative electrode can 302 doubling as a negative electrode terminal are insulated from each other and sealed by a gasket 303 made of polypropylene or the like. The positive electrode 304 includes the positive electrode current collector 305 and the positive electrode active material layer 306 provided in contact with the positive electrode current collector 305. The negative electrode 307 includes a negative electrode current collector 308 and a negative electrode active material layer 309 provided in contact with the negative electrode current collector 308. The negative electrode 307 is not limited to having a stacked-layer structure, and lithium metal foil or lithium-aluminum alloy foil may be used.

Note that only one surface of each of the positive electrode 304 and the negative electrode 307 used for the coin-type secondary battery 300 is provided with an active material layer.

For the positive electrode can 301 and the negative electrode can 302, a metal having corrosion resistance to an electrolyte solution, such as nickel, aluminum, or titanium, an alloy of such a metal, or an alloy of such a metal and another metal (e.g., stainless steel) can be used. The positive electrode can 301 and the negative electrode can 302 are preferably covered with nickel, aluminum, or the like in order to prevent corrosion due to the electrolyte solution, for example. The positive electrode can 301 and the negative electrode can 302 are electrically connected to the positive electrode 304 and the negative electrode 307, respectively.

The negative electrode 307, the positive electrode 304, and the separator 310 are immersed in the electrolyte solution. Then, as illustrated in FIG. 8C, the positive electrode 304, the separator 310, the negative electrode 307, and the negative electrode can 302 are stacked in this order with the positive electrode can 301 positioned at the bottom, and the positive electrode can 301 and the negative electrode can 302 are bonded with pressure with the gasket 303 therebetween. In this manner, the coin-type secondary battery 300 is fabricated.

With the above structure, the coin-type secondary battery 300 can have high capacity, high discharge capacity, and excellent cycle performance.

### [Cylindrical Secondary Battery]

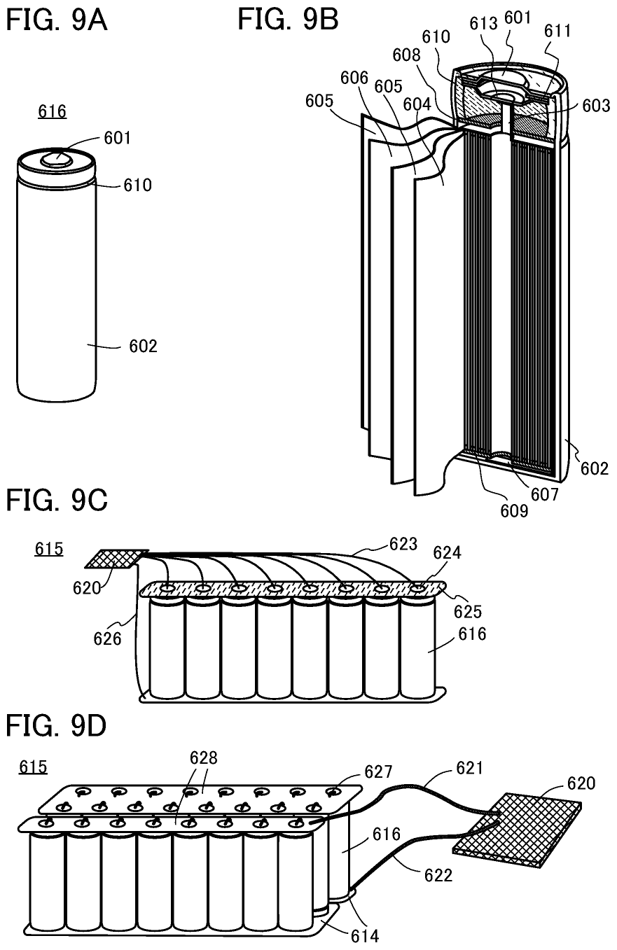

An example of a cylindrical secondary battery is described with reference to FIG. 9A. As illustrated in FIG. 9A, a cylindrical secondary battery 616 includes a positive electrode cap (battery cap) 601 on the top surface and a battery can (outer can) 602 on the side surface and bottom surface. The positive electrode cap 601 and the battery can 602 are insulated from each other by a gasket (insulating gasket) 610.

FIG. 9B schematically illustrates a cross section of a cylindrical secondary battery. The cylindrical secondary battery illustrated in FIG. 9B includes the positive electrode cap (battery cap) 601 on the top surface and the battery can (outer can) 602 on the side and bottom surfaces. The positive electrode cap 601 and the battery can 602 are insulated from each other by the gasket (insulating gasket) 610.

Inside the battery can 602 having a hollow cylindrical shape, a battery element in which a strip-like positive electrode 604 and a strip-like negative electrode 606 are wound with a strip-like separator 605 located therebetween is provided. Although not illustrated, the battery element is wound around the central axis. One end of the battery can 602 is close and the other end thereof is open. For the battery can 602, a metal having corrosion resistance to an electrolyte solution, such as nickel, aluminum, or titanium, an alloy of such a metal, or an alloy of such a metal and another metal (e.g., stainless steel) can be used. The battery can 602 is preferably covered with nickel, aluminum, and the like in order to prevent corrosion due to the electrolyte solution. Inside the battery can 602, the battery element in which the positive electrode, the negative electrode, and the separator are wound is provided between a pair of insulating plates 608 and 609 that face each other. The inside of the battery can 602 provided with the battery element is filled with a nonaqueous electrolyte solution (not illustrated). As the nonaqueous electrolyte solution, an electrolyte solution similar to that for the coin-type secondary battery can be used.

Since the positive electrode and the negative electrode of the cylindrical storage battery are wound, active materials are preferably formed on both sides of the current collectors.

The positive electrode active material 100 obtained in Embodiments 1, 2, and the like is used in the positive electrode 604, whereby the cylindrical secondary battery 616 can have high capacity, high discharge capacity, and excellent cycle performance.

A positive electrode terminal (positive electrode current collecting lead) 603 is connected to the positive electrode 604, and a negative electrode terminal (negative electrode current collecting lead) 607 is connected to the negative electrode 606. Both the positive electrode terminal 603 and the negative electrode terminal 607 can be formed using a metal material such as aluminum. The positive electrode terminal 603 and the negative electrode terminal 607 are resistance-welded to a safety valve mechanism 613 and the bottom of the battery can 602, respectively. The safety valve mechanism 613 is electrically connected to the positive electrode cap 601 through a positive temperature coefficient (PTC) element 611. The safety valve mechanism 613 cuts off electrical connection between the positive electrode cap 601 and the positive electrode 604 when the internal pressure of the battery exceeds a predetermined threshold. The PTC element 611, which is a thermally sensitive resistor whose resistance increases as temperature rises, limits the amount of current by increasing the resistance, in order to prevent abnormal heat generation. Barium titanate (BaTiO₃)-based semiconductor ceramic or the like can be used for the PTC element.

FIG. 9C illustrates an example of a power storage system 615. The power storage system 615 includes a plurality of secondary batteries 616. The positive electrodes of the secondary batteries are in contact with and electrically connected to conductors 624 isolated by an insulator 625. The conductor 624 is electrically connected to a control circuit 620 through a wiring 623. The negative electrodes of the secondary batteries are electrically connected to the control circuit 620 through a wiring 626. As the control circuit 620, a charge and discharge control circuit for performing charge, discharge, and the like or a protection circuit for preventing overcharge and/or overdischarge can be used.

FIG. 9D illustrates an example of the power storage system 615. The power storage system 615 includes a plurality of secondary batteries 616, and the plurality of secondary batteries 616 are sandwiched between a conductive plate 628 and a conductive plate 614. The plurality of secondary batteries 616 are electrically connected to the conductive plate 628 and the conductive plate 614 through a wiring 627. The plurality of secondary batteries 616 may be connected in parallel or connected in series. With the power storage system 615 including the plurality of secondary batteries 616, large electric power can be extracted.

The plurality of secondary batteries 616 may be connected in series after being connected in parallel.

A temperature control device may be provided between the plurality of secondary batteries 616. The secondary batteries 616 can be cooled with the temperature control device when overheated, whereas the secondary batteries 616 can be heated with the temperature control device when cooled too much. Thus, the performance of the power storage system 615 is less likely to be influenced by the outside temperature.

In FIG. 9D, the power storage system 615 is electrically connected to the control circuit 620 through a wiring 621 and a wiring 622. The wiring 621 is electrically connected to the positive electrodes of the plurality of secondary batteries 616 through the conductive plate 628. The wiring 622 is electrically connected to the negative electrodes of the plurality of secondary batteries 616 through the conductive plate 614.

### [Other Structure Examples of Secondary Battery]

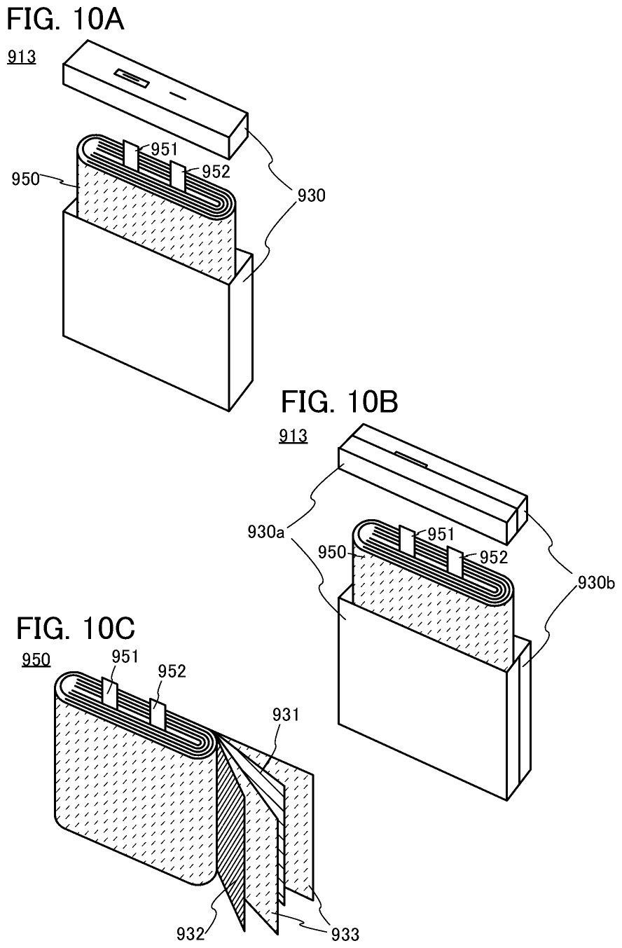

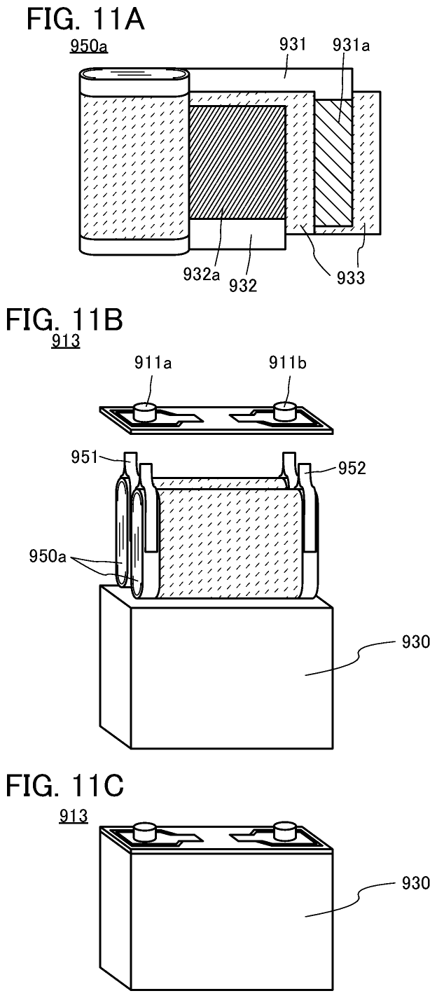

Structure examples of secondary batteries are described with reference to FIGS. 10A to 10C and FIGS. 11A to 11C.

A secondary battery 913 illustrated in FIG. 10A includes a wound body 950 provided with a terminal 951 and a terminal 952 inside a housing 930. The wound body 950 is immersed in an electrolyte solution inside the housing 930. The terminal 952 is in contact with the housing 930. The use of an insulator or the like inhibits contact between the terminal 951 and the housing 930. Note that in FIG. 10A, the housing 930 divided into two pieces is illustrated for convenience; however, in the actual structure, the wound body 950 is covered with the housing 930, and the terminal 951 and the terminal 952 extend to the outside of the housing 930. For the housing 930, a metal material (e.g., aluminum) or a resin material can be used.

Note that as illustrated in FIG. 10B, the housing 930 in FIG. 10A may be formed using a plurality of materials. For example, in the secondary battery 913 in FIG. 10B, a housing 930a and a housing 930b are attached to each other, and the wound body 950 is provided in a region surrounded by the housing 930a and the housing 930b.

For the housing 930a, an insulating material such as an organic resin can be used. In particular, when a material such as an organic resin is used for the side on which an antenna is formed, blocking of an electric field by the secondary battery 913 can be inhibited. When an electric field is not significantly blocked by the housing 930a, an antenna may be provided inside the housing 930a. For the housing 930b, a metal material can be used, for example.

FIG. 10C illustrates the structure of the wound body 950. The wound body 950 includes a negative electrode 931, a positive electrode 932, and separators 933. The wound body 950 is obtained by winding a sheet of a stack in which the negative electrode 931 and the positive electrode 932 overlap with the separator 933 therebetween. Note that a plurality of stacks each including the negative electrode 931, the positive electrode 932, and the separators 933 may be overlaid.

As illustrated in FIGS. 11A to 11C, the secondary battery 913 may include a wound body 950a. The wound body 950a illustrated in FIG. 11A includes the negative electrode 931, the positive electrode 932, and the separators 933. The negative electrode 931 includes a negative electrode active material layer 931a. The positive electrode 932 includes a positive electrode active material layer 932a.

The positive electrode active material 100 obtained in Embodiments 1, 2 and the like is used in the positive electrode 932, whereby the secondary battery 913 can have high capacity, high discharge capacity, and excellent cycle performance.

The separator 933 has a larger width than the negative electrode active material layer 931a and the positive electrode active material layer 932a, and is wound to overlap the negative electrode active material layer 931a and the positive electrode active material layer 932a. In terms of safety, the width of the negative electrode active material layer 931a is preferably larger than that of the positive electrode active material layer 932a. The wound body 950a having such a shape is preferable because of its high degree of safety and high productivity.

As illustrated in FIG. 11B, the negative electrode 931 is electrically connected to the terminal 951 by ultrasonic bonding, welding, or pressure bonding. The terminal 951 is electrically connected to a terminal 911a. The positive electrode 932 is electrically connected to the terminal 952 by ultrasonic bonding, welding, or pressure bonding. The terminal 952 is electrically connected to a terminal 911b.

As illustrated in FIG. 11C, the wound body 950a and an electrolyte solution are covered with the housing 930, whereby the secondary battery 913 is completed. The housing 930 is preferably provided with a safety valve, an overcurrent protection element, and the like. A safety valve is a valve to be released by a predetermined internal pressure of the housing 930 in order to prevent the battery from exploding.

As illustrated in FIG. 11B, the secondary battery 913 may include a plurality of wound bodies 950a. The use of the plurality of wound bodies 950a enables the secondary battery 913 to have higher discharge capacity. The description of the secondary battery 913 in FIGS. 10A to 10C can be referred to for the other components of the secondary battery 913 in FIGS. 11A and 11B.

### <Laminated Secondary Battery>

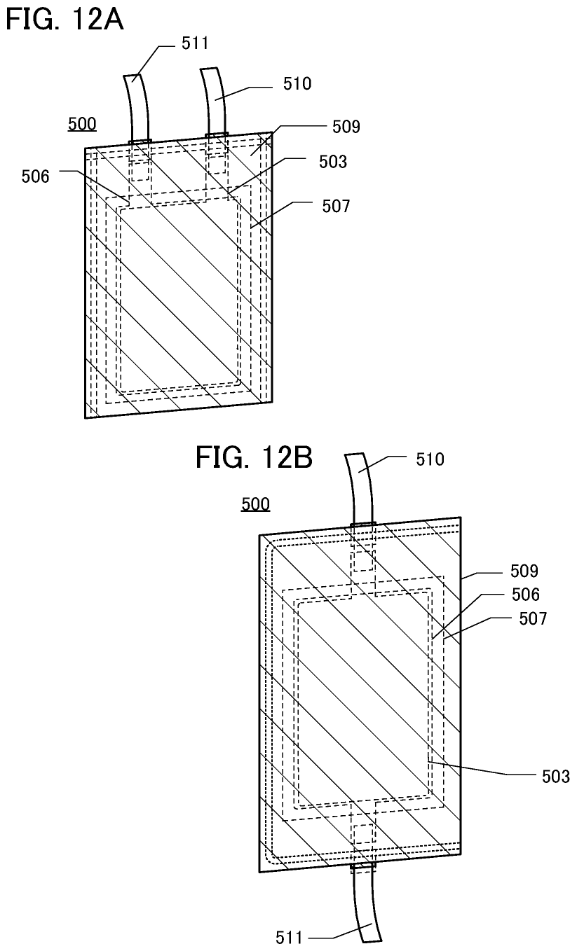

Next, examples of the appearance of a laminated secondary battery are illustrated in FIGS. 12A and 12B. FIGS. 12A and 12B each illustrate a positive electrode 503, a negative electrode 506, a separator 507, an exterior body 509, a positive electrode lead electrode 510, and a negative electrode lead electrode 511.

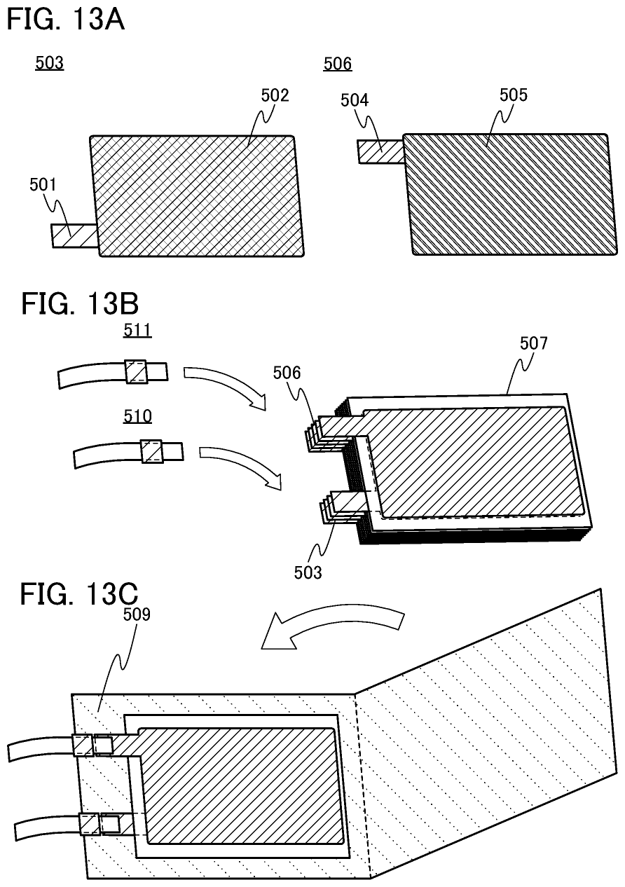

FIG. 13A illustrates the appearance of the positive electrode 503 and the negative electrode 506. The positive electrode 503 includes a positive electrode current collector 501, and a positive electrode active material layer 502 is formed on a surface of the positive electrode current collector 501. The positive electrode 503 also includes a region where the positive electrode current collector 501 is partly exposed (hereinafter referred to as a tab region). The negative electrode 506 includes a negative electrode current collector 504, and a negative electrode active material layer 505 is formed on a surface of the negative electrode current collector 504. The negative electrode 506 also includes a region where the negative electrode current collector 504 is partly exposed, that is, a tab region. The areas or the shapes of the tab regions included in the positive electrode and the negative electrode are not limited to those illustrated in FIG. 13A.

### <Method for Fabricating Laminated Secondary Battery>

An example of a method for fabricating the laminated secondary battery having the appearance illustrated in FIG. 12A will be described with reference to FIGS. 13B and 13C.

First, the negative electrode 506, the separator 507, and the positive electrode 503 are stacked. FIG. 13B illustrates the negative electrodes 506, the separators 507, and the positive electrodes 503 that are stacked. The secondary battery described here as an example includes five negative electrodes and four positive electrodes. The component at this stage can also be referred to as a stack including the negative electrodes, the separators, and the positive electrodes. Next, the tab regions of the positive electrodes 503 are bonded to each other, and the positive electrode lead electrode 510 is bonded to the tab region of the positive electrode on the outermost surface. The bonding can be performed by ultrasonic welding, for example. In a similar manner, the tab regions of the negative electrodes 506 are bonded to each other, and the negative electrode lead electrode 511 is bonded to the tab region of the negative electrode on the outermost surface.

Then, the negative electrodes 506, the separators 507, and the positive electrodes 503 are placed over the exterior body 509.

Subsequently, the exterior body 509 is folded along a dashed line as illustrated in FIG. 13C. Then, the outer edges of the exterior body 509 are bonded to each other. The bonding can be performed by thermocompression, for example. At this time, a part (or one side) of the exterior body 509 is left unbonded (to provide an inlet) so that an electrolyte solution can be introduced later.

Next, the electrolyte solution is introduced into the exterior body 509 from the inlet of the exterior body 509. The electrolyte solution is preferably introduced in a reduced pressure atmosphere or in an inert atmosphere. Lastly, the inlet is sealed by bonding. In this manner, the laminated secondary battery 500 can be manufactured.

The positive electrode active material 100 obtained in Embodiments 1, 2, and the like is used in the positive electrodes 503, whereby the secondary battery 500 can have high capacity, high discharge capacity, and excellent cycle performance.

### [Examples of Battery Pack]

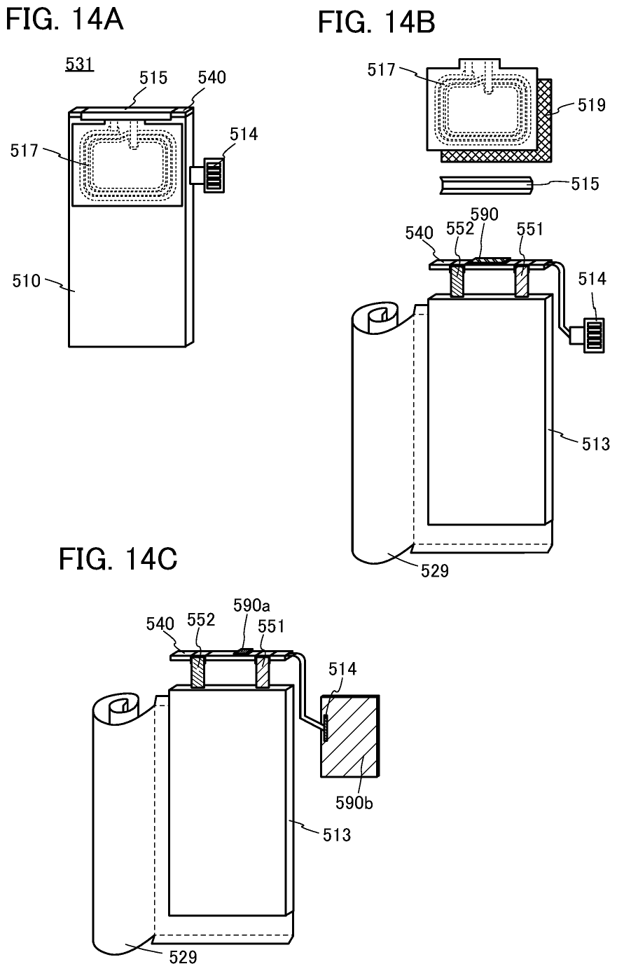

Examples of a secondary battery pack of one embodiment of the present invention that is capable of wireless charging using an antenna will be described with reference to FIGS. 14A to 14C.

FIG. 14A illustrates the appearance of a secondary battery pack 531 that has a rectangular solid shape with a small thickness (also referred to as a flat plate shape with a certain thickness). FIG. 14B illustrates the structure of the secondary battery pack 531. The secondary battery pack 531 includes a circuit board 540 and a secondary battery 513. A label 529 is attached to the secondary battery 513. The circuit board 540 is fixed by a sealant 515. The secondary battery pack 531 also includes an antenna 517.

As for the internal structure of the secondary battery 513, the secondary battery 513 may include a wound body or a stack.

In the secondary battery pack 531, a control circuit 590 is provided over the circuit board 540 as illustrated in FIG. 14B, for example. The circuit board 540 is electrically connected to a terminal 514. Moreover, the circuit board 540 is electrically connected to the antenna 517 and a positive electrode lead and a negative electrode lead 551 and 552 of the secondary battery 513.

Alternatively, as illustrated in FIG. 14C, a circuit system 590a provided over the circuit board 540 and a circuit system 590b electrically connected to the circuit board 540 through the terminal 514 may be included.

Note that the shape of the antenna 517 is not limited to a coil shape and may be a linear shape or a plate shape, for example. Furthermore, a planar antenna, an aperture antenna, a traveling-wave antenna, an EH antenna, a magnetic-field antenna, a dielectric antenna, or the like may be used. Alternatively, the antenna 517 may be a flat-plate conductor. The flat-plate conductor can serve as one of conductors for electric field coupling. That is, the antenna 517 can function as one of two conductors of a capacitor. Thus, electric power can be transmitted and received not only by an electromagnetic field or a magnetic field but also by an electric field.

The secondary battery pack 531 includes a layer 519 between the antenna 517 and the secondary battery 513. The layer 519 has a function of blocking an electromagnetic field from the secondary battery 513, for example. As the layer 519, a magnetic material can be used, for example.

### Embodiment 5

In this embodiment, examples of vehicles each including the secondary battery of one embodiment of the present invention are described.

The secondary battery can be used in vehicles, typically automobiles. Examples of the automobiles include next-generation clean energy vehicles such as hybrid vehicles (HVs), electric vehicles (EVs), and plug-in hybrid vehicles (also referred to as PHEVs or PHVs). The secondary battery can be used as one of the power sources provided in the automobiles. The vehicle is not limited to an automobile. Examples of the vehicles include a train, a monorail train, a ship, a submarine (a deep-submergence vehicle and an unmanned submarine), a flying object (a helicopter, an unmanned aircraft (a drone), an airplane, a rocket, and artificial satellite), an electric bicycle, and an electric motorcycle. The secondary battery of one embodiment of the present invention can be used in these vehicles.

The electric vehicle is provided with first batteries 1301a and 1301b as main secondary batteries for driving and a second battery 1311 that supplies electric power to an inverter 1312 for starting a motor 1304. The second battery 1311 is also referred to as a cranking battery and a starter battery. The second battery 1311 specifically needs high output and does not necessarily have high capacity, and the capacity of the second battery 1311 is lower than that of the first batteries 1301a and 1301b.

The internal structure of the first battery 1301a may be the wound structure illustrated in FIG. 10C or FIG. 11A or the stacked structure illustrated in FIG. 12A or FIG. 12B. Alternatively, the first battery 1301a may be the all-solid-state battery in Embodiment 6. Using the all-solid-state battery in Embodiment 6 as the first battery 1301a achieves high capacity, a high degree of safety, and reduction in size and weight.

Although this embodiment shows an example where the two first batteries 1301a and 1301b are connected in parallel, three or more batteries may be connected in parallel. In the case where the first battery 1301a can store sufficient electric power, the first battery 1301b may be omitted. By constituting a battery pack including a plurality of secondary batteries, large electric power can be extracted. The plurality of secondary batteries may be connected in parallel, connected in series, or connected in series after being connected in parallel. A plurality of secondary batteries can be collectively referred to as an assembled battery.

An in-vehicle secondary battery includes a service plug or a circuit breaker that can cut off high voltage without the use of equipment in order to cut off electric power from a plurality of secondary batteries. The first battery 1301a is provided with such a service plug or a circuit breaker.

Electric power from the first batteries 1301a and 1301b is mainly used to rotate the motor 1304 and is also supplied to in-vehicle parts for 42 V (such as an electric power steering 1307, a heater 1308, and a defogger 1309) through a DC-DC circuit 1306. In the case where there is a rear motor 1317 for the rear wheels, the first battery 1301a is used to rotate the rear motor 1317.

The second battery 1311 supplies electric power to in-vehicle parts for 14V (such as an audio 1313, power windows 1314, and lamps 1315) through a DC-DC circuit 1310.

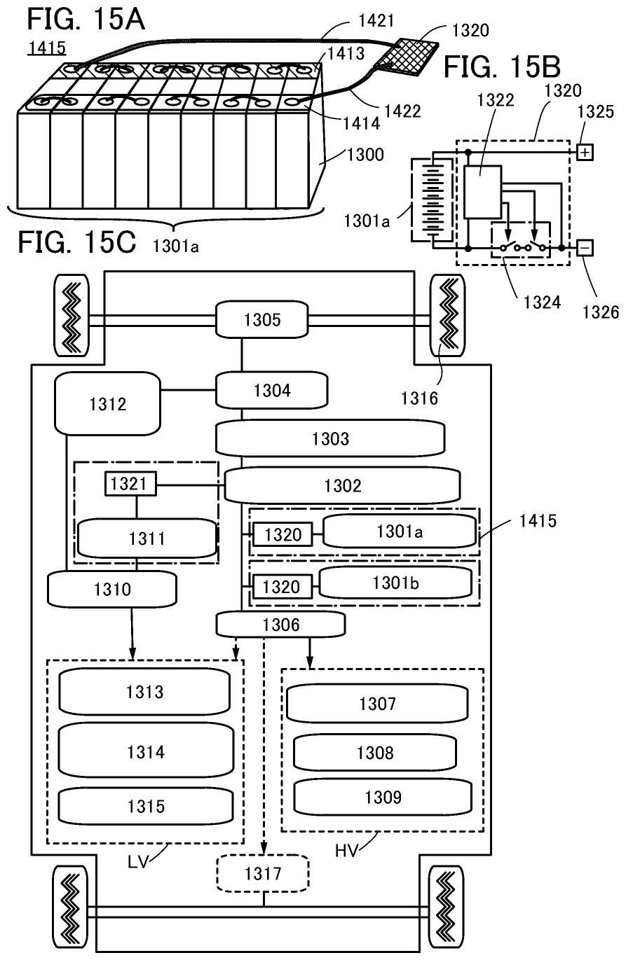

Next, the first battery 1301a is described with reference to FIG. 15A.

FIG. 15A illustrates an example in which nine rectangular secondary batteries 1300 form one battery pack 1415. The nine rectangular secondary batteries 1300 are connected in series; one electrode of each battery is fixed by a fixing portion 1413 made of an insulator, and the other electrode of each battery is fixed by a fixing portion 1414 made of an insulator. Although this embodiment shows an example in which the secondary batteries are fixed by the fixing portions 1413 and 1414, they may be stored in a battery container box (also referred to as a housing). Since a vibration or a jolt is assumed to be given to the vehicle from the outside (e.g., a road surface), the plurality of secondary batteries are preferably fixed by the fixing portions 1413 and 1414, a battery container box, or the like. Furthermore, the one electrode of each battery is electrically connected to a control circuit portion 1320 through a wiring 1421. The other electrode of each battery is electrically connected to the control circuit portion 1320 through a wiring 1422.

The control circuit portion 1320 may include a memory circuit including a transistor using an oxide semiconductor. A charge control circuit or a battery control system that includes a memory circuit including a transistor using an oxide semiconductor may be referred to as a battery operating system or a battery oxide semiconductor (BTOS).

A metal oxide functioning as an oxide semiconductor is preferably used. For example, as the metal oxide, a metal oxide such as an In-M-Zn oxide (the element M is one or more kinds selected from aluminum, gallium, yttrium, copper, vanadium, beryllium, boron, titanium, iron, nickel, germanium, zirconium, molybdenum, lanthanum, cerium, neodymium, hafnium, tantalum, tungsten, magnesium, and the like) is preferably used. In particular, the In-M-Zn oxide that can be used as the metal oxide is preferably a c-axis aligned crystal oxide semiconductor (CAAC-OS) or a cloud-aligned composite oxide semiconductor (CAC-OS). Alternatively, an In—Ga oxide or an In—Zn oxide may be used as the metal oxide. The CAAC-OS is an oxide semiconductor that has a plurality of crystal regions each of which has c-axis alignment in a particular direction. Note that the particular direction refers to the thickness direction of a CAAC-OS film, the normal direction of the surface where the CAAC-OS film is formed, or the normal direction of the surface of the CAAC-OS film. The crystal region refers to a region having a periodic atomic arrangement. When an atomic arrangement is regarded as a lattice arrangement, the crystal region also refers to a region with a uniform lattice arrangement.

Note that the CAC-OS has a composition in which materials are separated into a first region and a second region to form a mosaic pattern, and the first regions are distributed in the film. This composition is hereinafter also referred to as a cloud-like composition. That is, the CAC-OS is a composite metal oxide having a composition in which the first regions and the second regions are mixed. Note that a clear boundary between the first region and the second region cannot be observed in some cases.

For example, energy dispersive X-ray spectroscopy (EDX) is used to obtain EDX mapping, and according to the EDX mapping, the CAC-OS in the In—Ga—Zn oxide has a structure in which the region containing. In as its main component (the first region) and the region containing Ga as its main component (the second region) are unevenly distributed and mixed.

In the case where the CAC-OS is used for a transistor, a switching function (on/off switching function) can be given to the CAC-OS owing to the complementary action of the conductivity derived from the first region and the insulating property derived from the second region. That is, the CAC-OS has a conducting function in part of the material and has an insulating function in another part of the material; as a whole, the CAC-OS has a function of a semiconductor. Separation of the conducting function and the insulating function can maximize each function. Thus, when the CAC-OS is used for a transistor, high on-state current (Iₒₙ), high field-effect mobility (μ), and excellent switching operation can be achieved.

An oxide semiconductor can have any of various structures that show various different properties. Two or more of an amorphous oxide semiconductor, a polycrystalline oxide semiconductor, an a-like OS, the CAC-OS, an nc-OS, and the CAAC-OS may be included in an oxide semiconductor of one embodiment of the present invention.

The control circuit portion 1320 preferably uses a transistor using an oxide semiconductor because the transistor using an oxide semiconductor can be used in a high-temperature environment. For the process simplicity, the control circuit portion 1320 may be formed using transistors of the same conductivity type. A transistor using an oxide semiconductor in its semiconductor layer has an operating ambient temperature range of −40° C. to 150° C. inclusive, which is wider than that of a single crystal Si transistor, and thus shows a smaller change in characteristics than the single crystal Si transistor when the secondary battery is overheated. The off-state current of the transistor using an oxide semiconductor is lower than or equal to the lower measurement limit even at 150° C. independently of the temperature; meanwhile, the off-state current of the single crystal Si transistor largely depends on the temperature. For example, at 150° C., the off-state current of the single crystal Si transistor increases, and a sufficiently high current on/off ratio cannot be obtained. The control circuit portion 1320 can improve the degree of safety. When the control circuit portion 1320 is used in combination with a secondary battery having a positive electrode using the positive electrode active material 100 obtained in Embodiments 1, 2, and the like, the synergy on safety can be obtained. The secondary battery including the positive electrode using the positive electrode active material 100 obtained in Embodiments 1, 2, and the like and the control circuit portion 1320 can contribute greatly to elimination of accidents due to secondary batteries, such as fires.

The control circuit portion 1320 that uses a memory circuit including a transistor using an oxide semiconductor can also function as an automatic control device for the secondary battery to resolve causes of instability, such as a micro-short circuit. Examples of functions of resolving the causes of instability of the secondary battery include prevision of overcharge, prevention of overcurrent, control of overheating during charge, maintenance of cell balance of an assembled battery, prevention of overdischarge, a battery indicator, automatic control of charge voltage and current amount according to temperature, control of the amount of charge current according to the degree of deterioration, abnormal behavior detection for a micro-short circuit, and anomaly prediction regarding a micro-short circuit. The control circuit portion 1320 has at least one of these functions. Furthermore, the automatic control device for the secondary battery can be extremely small in size.

A micro-short circuit refers to a minute short circuit caused in a secondary battery. A micro-short circuit refers to not a state where the positive electrode and the negative electrode of a secondary battery are short-circuited so that charge and discharge are impossible, but a phenomenon in which a slight short-circuit current flows through a minute short-circuit portion. Since a large voltage change is caused even when a micro-short circuit occurs in a relatively short time in a minute area, the abnormal voltage value might adversely affect estimation to be performed subsequently.

One of the supposed causes of a micro-short circuit is as follows. Uneven distribution of a positive electrode active material due to multiple charges and discharges causes local current concentration at part of the positive electrode and part of the negative electrode; thus, a malfunction of part of a separator is caused. Another supposed cause is generation of a by-product due to a side reaction.

It can be said that the control circuit portion 1320 not only detects a micro-short circuit but also detects a terminal voltage of the secondary battery and controls the charge and discharge state of the secondary battery. For example, to prevent overcharge, the control circuit portion 1320 can turn off an output transistor of a charge circuit and an interruption switch substantially at the same time.

Next, FIG. 15B illustrates an example of a block diagram of the battery pack 1415 illustrated in FIG. 15A.

The control circuit portion 1320 includes a switch portion 1324 that includes at least a switch for preventing overcharge and a switch for preventing overdischarge, a control circuit 1322 for controlling the switch portion 1324, and a portion for measuring the voltage of the first battery 1301a. The control circuit portion 1320 is set to have the upper limit voltage and the lower limit voltage of the secondary battery used, and imposes the upper limit of current from the outside, the upper limit of output current to the outside, or the like. The range from the lower limit voltage to the upper limit voltage of the secondary battery falls within the recommended voltage range. When a voltage falls outside the range, the switch portion 1324 operates and functions as a protection circuit. The control circuit portion 1320 can also be referred to as a protection circuit because it controls the switch portion 1324 to prevent overdischarge and/or overcharge. For example, when the control circuit 1322 detects a voltage that is likely to cause overcharge, current is interrupted by turning off the switch in the switch portion 1324. Furthermore, a function of interrupting current in accordance with a temperature rise may be set by providing a PTC element in the charge and discharge path. The control circuit portion 1320 includes an external terminal 1325 (+IN) and an external terminal 1326 (−IN).

The switch portion 1324 can be formed by a combination of an n-channel transistor and a p-channel transistor. The switch portion 1324 is not limited to including a switch having a Si transistor using single crystal silicon; the switch portion 1324 may be formed using a power transistor containing germanium (Ge), silicon germanium (SiGe), gallium arsenide (GaAs), gallium aluminum arsenide (GaAlAs), indium phosphide (InP), silicon carbide (SiC), zinc selenide (ZnSe), gallium nitride (GaN), gallium oxide (GaOₓ, where x is a real number greater than 0), or the like. A memory element using an OS transistor can be freely placed by being stacked over a circuit using a Si transistor, for example; hence, integration can be easy. Furthermore, an OS transistor can be manufactured with a manufacturing apparatus similar to that for a Si transistor and thus can be manufactured at low cost. That is, the control circuit portion 1320 using OS transistors can be stacked over the switch portion 1324 so that they can be integrated into one chip. Since the area occupied by the control circuit portion 1320 can be reduced, a reduction in size is possible.

The first batteries 1301a and 1301b mainly supply electric power to in-vehicle parts for 42 V (for a high-voltage system HV), and the second battery 1311 supplies electric power to in-vehicle parts for 14 V (for a low-voltage system LV). A lead battery is usually used for the second battery 1311 due to cost advantage. Lead storage batteries have disadvantages compared with lithium ion batteries in that they have a larger amount of self-discharge and are more likely to deteriorate due to a phenomenon called sulfation. There is an advantage that the second battery 1311 can be maintenance-free when a lithium ion battery is used; however, in the case of long-term use, for example three years or more, anomaly that is difficult to determine at the time of manufacturing might occur. In particular, when the second battery 1311 that starts the inverter becomes inoperative, the motor cannot be started even when the first batteries 1301a and 1301b have remaining capacity; thus, in order to prevent this, in the case where the second battery 1311 is a lead storage battery, the second battery is supplied with electric power from the first battery to constantly maintain a fully-charged state.

In this embodiment, an example in which a lithium ion battery is used as both the first battery 1301a and the second battery 1311 is described (FIG. 15C). As the second battery 1311, a lead storage battery, an all-solid-state battery, or an electric double layer capacitor may alternatively be used. For example, the all-solid-state battery in Embodiment 6 may be used. Using the all-solid-state battery in Embodiment 6 as the second battery 1311 achieves high capacity, and reduction in size and weight.

Regenerative energy generated by rolling of tires 1316 is transmitted to the motor 1304 through a gear 1305, and is stored in the second battery 1311 through a motor controller 1303, a battery controller 1302, or the control circuit portion 1321. Alternatively, the regenerative energy is stored in the first battery 1301a through the battery controller 1302 and the control circuit portion 1320. Alternatively, the regenerative energy is stored in the first battery 1301b through the battery controller 1302 and the control circuit portion 1320. For efficient charge with regenerative energy, the first batteries 1301a and 1301b are preferably capable of fast charge.

The battery controller 1302 can set the charge voltage, charge current, and the like of the first batteries 1301a and 1301b. The battery controller 1302 can set charge conditions in accordance with charge characteristics of a secondary battery used, so that fast charge can be performed.

Although not illustrated, when the electric vehicle is connected to an external charger, a plug of the charger or a connection cable of the charger is electrically connected to the battery controller 1302. Electric power supplied from the external charger is stored in the first batteries 1301a and 1301b through the battery controller 1302. Some chargers are provided with a control circuit, in which case the function of the battery controller 1302 is not used; to prevent overcharge, the first batteries 1301a and 1301b are preferably charged through the control circuit portion 1320. In addition, a plug of the charger or a connection cable of the charger is sometimes provided with a control circuit. The control circuit portion 1320 is also referred to as an electronic control unit (ECU). The ECU is connected to a controller area network (CAN) provided in the electric motor vehicle. The CAN is a type of a serial communication standard used as an in-vehicle LAN. The ECU includes a microcomputer. Moreover, the ECU uses a CPU or a GPU.

External chargers installed at charge stations and the like have a 100 V outlet, a 200 V outlet, or a three-phase 200V outlet with 50 kW, for example. Furthermore, charge can be performed by electric power supplied from external charge equipment with a contactless power feeding method or the like.

For fast charge, secondary batteries that can withstand charge at high voltage have been desired to perform charge in a short time.

It is possible to achieve a secondary battery in which graphene is used as a conductive material, the electrode layer is formed thick to suppress a reduction in capacity while increasing the loading amount, and the electrical characteristics are significantly improved in synergy with maintenance of high capacity. This secondary battery is particularly effectively used in a vehicle and can achieve a vehicle that has a long range, specifically a driving range per charge of 500 km or greater, without increasing the proportion of the weight of the secondary battery to the weight of the entire vehicle.

Specifically, in the secondary battery in this embodiment, the use of the positive electrode active material 100 described in Embodiments 1, 2, and the like can increase the operating voltage, and the increase in charge voltage can increase the available capacity. Moreover, using the positive electrode active material 100 described in Embodiments 1, 2, and the like in the positive electrode can provide an automotive secondary battery having excellent cycle performance.

Next, examples in which the secondary battery of one embodiment of the present invention is mounted on a vehicle, typically a transport vehicle, will be described.

Mounting the secondary battery illustrated in any one of FIG. 9D, FIG. 11C, and FIG. 15A on vehicles can achieve next-generation clean energy vehicles such as hybrid vehicles (HVs), electric vehicles (EVs), and plug-in hybrid vehicles (PHVs). The secondary battery can also be mounted on agricultural machines, motorized bicycles including motor-assisted bicycles, motorcycles, electric wheelchairs, electric carts, vessels, submarines, aircraft, rockets, artificial satellites, space probes, planetary probes, or spacecraft. The secondary battery of one embodiment of the present invention can have high capacity. Thus, the secondary battery of one embodiment of the present invention is suitable for reduction in size and weight and is preferably used in transport vehicles.

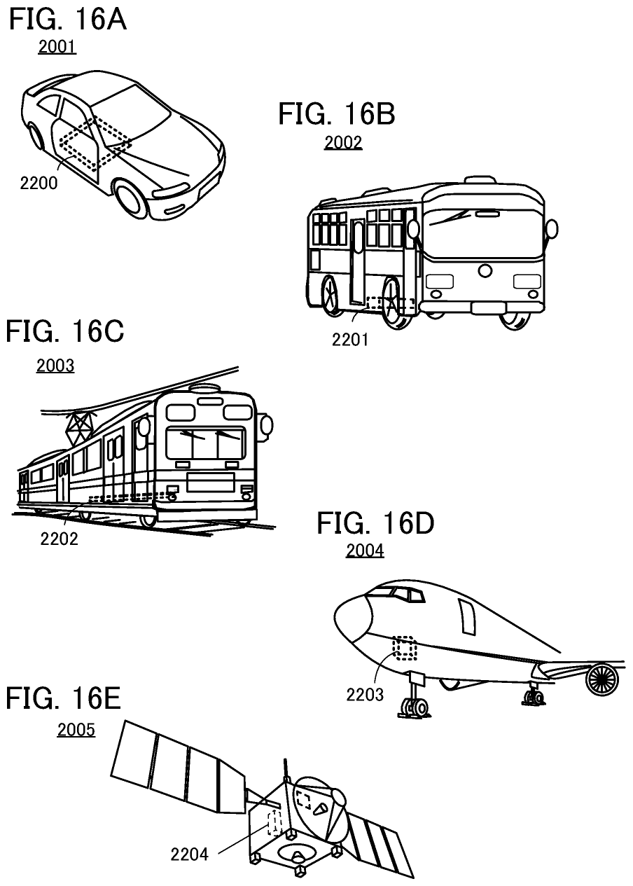

FIGS. 16A to 16D illustrate examples of transport vehicles using one embodiment of the present invention. An automobile 2001 illustrated in FIG. 16A is an electric vehicle that runs on the power of an electric motor. Alternatively, the automobile 2001 is a hybrid electric vehicle capable of driving using either an electric motor or an engine as appropriate. In the case where the secondary battery is mounted on the vehicle, the secondary battery exemplified in Embodiment 4 is provided at one position or several positions. The automobile 2001 illustrated in FIG. 16A includes a battery pack 2200, and the battery pack includes a secondary battery module in which a plurality of secondary batteries are connected to each other. Moreover, the battery pack preferably includes a charge control device that is electrically connected to the secondary battery module.

The automobile 2001 can be charged when the secondary battery included in the automobile 2001 is supplied with electric power through external charge equipment by a plug-in system, a contactless power feeding system, or the like. In charge, a given method such as CHAdeMO (registered trademark) or Combined Charging System can be employed as a charge method, the standard of a connector, and the like as appropriate. Charge equipment may be a charge station provided in a commerce facility or a power source in a house. For example, with the use of the plug-in technique, the power storage device mounted on the automobile 2001 can be charged by being supplied with electric power from outside. The charge can be performed by converting AC electric power into DC electric power through a converter such as an AC-DC converter.

Although not illustrated, the vehicle may include a power receiving device so that it can be charged by being supplied with electric power from an above-ground power transmitting device in a contactless manner. In the case of the contactless power feeding system, by fitting a power transmitting device in a road or an exterior wall, charge can be performed not only when the vehicle is stopped but also when driven. In addition, the contactless power feeding system may be utilized to perform transmission and reception of electric power between two vehicles. Furthermore, a solar cell may be provided in the exterior of the vehicle to charge the secondary battery when the vehicle stops or moves. To supply electric power in such a contactless manner, an electromagnetic induction method or a magnetic resonance method can be used.

FIG. 16B illustrates a large transporter 2002 having a motor controlled by electricity as an example of a transport vehicle. A secondary battery module of the transporter 2002 includes a cell unit of four secondary batteries with a nominal voltage of 3.0 V or higher and 5.0 V or lower, for example, and 48 cells are connected in series to have a maximum voltage of 170 V. A battery pack 2201 has the same function as that in FIG. 16A except, for example, the number of secondary batteries configuring the secondary battery module; thus, the description is omitted.

FIG. 16C illustrates a large transportation vehicle 2003 having a motor controlled by electricity as an example. A secondary battery module of the transportation vehicle 2003 has 100 or more secondary batteries with a nominal voltage of 3.0 V or higher and 5.0 V or lower connected in series, and the maximum voltage is 600 V. Thus, the secondary batteries are required to have few variations in the characteristics. With the use of a secondary battery with the positive electrode active material 100 described in Embodiments 1, 2, and the like, a secondary battery with stable battery characteristics can be fabricated, which enables the volume production at low costs in terms of the yield. A battery pack 2202 has the same function as that in FIG. 16A except, for example, the number of secondary batteries configuring the secondary battery module; thus, the description is omitted.

FIG. 16D illustrates an aircraft 2004 having a combustion engine as an example. The aircraft 2004 illustrated in FIG. 16D is regarded as a kind of transportation vehicles because it has wheels for takeoff and landing, and includes a battery pack 2203 that includes a charge control device and a secondary battery module configured by connecting a plurality of secondary batteries.

The secondary battery module of the aircraft 2004 has eight 4 V secondary batteries connected in series and has a maximum voltage of 32 V, for example. The battery pack 2203 has the same function as that in FIG. 16A except, for example, the number of secondary batteries configuring the secondary battery module; thus, the description is omitted.

FIG. 16E illustrates an artificial satellite 2005 including a secondary battery 2204 as an example. Because the artificial satellite 2005 is used in an ultra-low-temperature cosmic space, the secondary battery 2204 having excellent low temperature resistance of one embodiment of the present invention is preferably provided. It is further preferable that the secondary battery 2204 be mounted inside the artificial satellite 2005 while being covered with a heat-retaining member.

### Embodiment 6

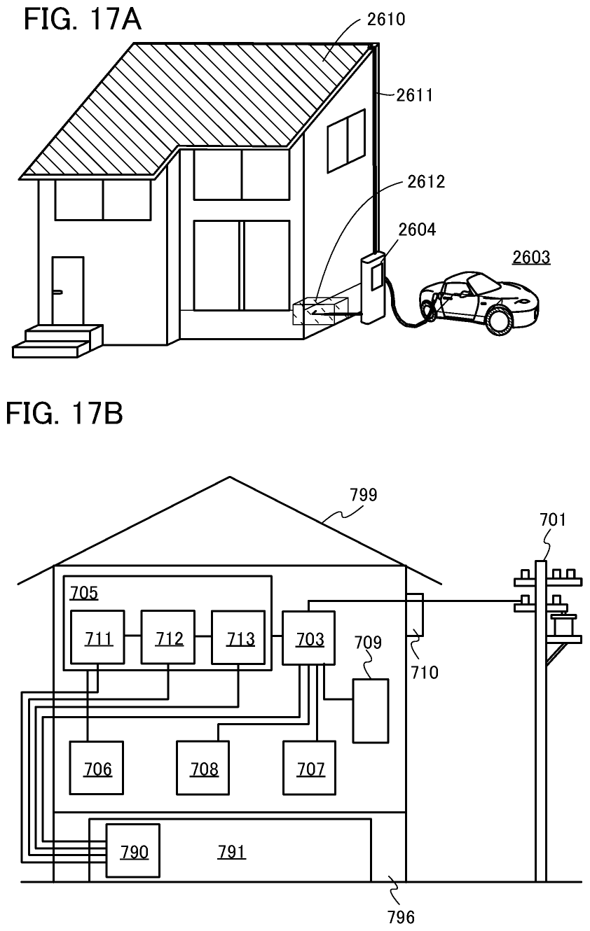

In this embodiment, examples in which the secondary battery of one embodiment of the present invention is mounted on a building are described with reference to FIGS. 17A and 17B.

A house illustrated in FIG. 17A includes a power storage device 2612 including the secondary battery of one embodiment of the present invention and a solar panel 2610.

The power storage device 2612 is electrically connected to the solar panel 2610 through a wiring 2611 or the like. The power storage device 2612 may be electrically connected to a ground-based charging device 2604. The power storage device 2612 can be charged with electric power generated by the solar panel 2610. A secondary battery included in a vehicle 2603 can be charged with the electric power stored in the power storage device 2612 through the charging device 2604. The power storage device 2612 is preferably provided in the underfloor space, in which case the space on the floor can be effectively used. Alternatively, the power storage device 2612 may be provided on the floor.

The electric power stored in the power storage device 2612 can also be supplied to other electronic devices in the house. Thus, the electronic devices can be operated with the use of the power storage device 2612 of one embodiment of the present invention as an uninterruptible power source even when electric power cannot be supplied from the commercial power supply due to power failure or the like.

FIG. 17B illustrates an example of a power storage device of one embodiment of the present invention. As illustrated in FIG. 17B, a power storage device 791 of one embodiment of the present invention is provided in an underfloor space 796 of a building 799. The power storage device 791 may be provided with the control circuit described in Embodiment 5, and can have synergy on safety when using a secondary battery including a positive electrode containing the positive electrode active material 100 obtained in Embodiments 1, 2, and the like. The secondary battery including the control circuit described in Embodiment 5 and the positive electrode using the positive electrode active material 100 described in Embodiments 1, 2, and the like can contribute greatly to elimination of accidents due to the power storage device 791 including secondary batteries, such as fires.

The power storage device 791 is provided with a control device 790, and the control device 790 is electrically connected to a distribution board 703, a power storage controller (also referred to as control device) 705, an indicator 706, and a router 709 through wirings.

Electric power is transmitted from a commercial power source 701 to the distribution board 703 through a service wire mounting portion 710. Moreover, electric power is transmitted to the distribution board 703 from the power storage device 791 and the commercial power source 701, and the distribution board 703 supplies the transmitted electric power to a general load 707 and a power storage load 708 through outlets (not illustrated).

The general load 707 is, for example, an electrical device such as a TV or a personal computer. The power storage load 708 is, for example, an electrical device such as a microwave, a refrigerator, or an air conditioner.

The power storage controller 705 includes a measuring portion 711, a predicting portion 712, and a planning portion 713. The measuring portion 711 has a function of measuring the amount of electric power consumed by the general load 707 and the power storage load 708 during a day (e.g., from midnight to midnight). The measuring portion 711 may also have a function of measuring the amount of electric power of the power storage device 791 and the amount of electric power supplied from the commercial power source 701. The predicting portion 712 has a function of predicting, on the basis of the amount of electric power consumed by the general load 707 and the power storage load 708 during a given day, the demand for electric power consumed by the general load 707 and the power storage load 708 during the next day. The planning portion 713 has a function of making a charge and discharge plan of the power storage device 791 on the basis of the demand for electric power predicted by the predicting portion 712.

The indicator 706 can show the amount of electric power consumed by the general load 707 and the power storage load 708 that is measured by the measuring portion 711. An electrical device such as a TV or a personal computer can also show it through the router 709. Furthermore, a portable electronic terminal such as a smartphone or a tablet can also show it through the router 709. The indicator 706, the electrical device, and the portable electronic terminal can also show, for example, the demand for electric power depending on a time period (or per hour) that is predicted by the predicting portion 712.

### Embodiment 7

This embodiment describes examples in which the lithium ion battery of one embodiment of the present invention is mounted on a two-wheeled vehicle and a bicycle as examples of mounting a secondary battery in a vehicle.

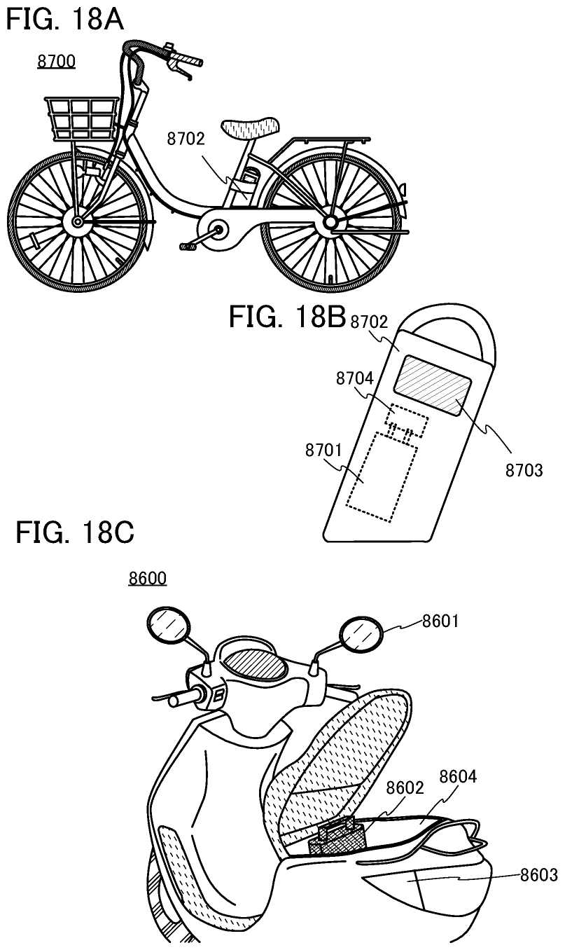

FIG. 18A illustrates an example of an electric bicycle using the power storage device of one embodiment of the present invention. The power storage device of one embodiment of the present invention can be used for an electric bicycle 8700 in FIG. 18A. The power storage device of one embodiment of the present invention includes a plurality of storage batteries and a protection circuit, for example.

The electric bicycle 8700 is provided with a power storage device 8702. The power storage device 8702 can supply electric power to a motor that assists a rider. The power storage device 8702 is portable, and FIG. 18B illustrates the state where the power storage device 8702 is removed from the electric bicycle. The power storage device 8702 incorporates a plurality of storage batteries 8701 included in the power storage device of one embodiment of the present invention, and can display the remaining battery level and the like on a display portion 8703. The power storage device 8702 includes a control circuit 8704 capable of charge control or anomaly detection for the secondary battery, which is exemplified in Embodiment 5. The control circuit 8704 is electrically connected to a positive electrode and a negative electrode of the storage battery 8701. When the control circuit 8704 is used in combination with a secondary battery having a positive electrode using the positive electrode active material 100 obtained in Embodiments 1, 2, and the like, the synergy on safety can be obtained. The secondary battery having the positive electrode using the positive electrode active material 100 obtained in Embodiments 1, 2, and the like and the control circuit 8704 can contribute greatly to elimination of accidents due to secondary batteries, such as fires.

FIG. 18C illustrates an example of a two-wheeled vehicle using the power storage device of one embodiment of the present invention. A motor scooter 8600 illustrated in FIG. 18C includes a power storage device 8602, side mirrors 8601, and indicators 8603. The power storage device 8602 can supply electric power to the indicators 8603. The power storage device 8602 including a plurality of secondary batteries having a positive electrode using the positive electrode active material 100 obtained in Embodiments 1, 2, and the like can have high capacity and contribute to a reduction in size.

In the motor scooter 8600 illustrated in FIG. 18C, the power storage device 8602 can be held in an under-seat storage unit 8604. The power storage device 8602 can be held in the under-seat storage unit 8604 even with a small size.

### Embodiment 8

In this embodiment, examples of electronic devices each including the secondary battery of one embodiment of the present invention are described. Examples of the electronic device including the secondary battery include a television device (also referred to as a television or a television receiver), a monitor of a computer and the like, a digital camera, a digital video camera, a digital photo frame, a mobile phone (also referred to as a cellular phone or a mobile phone device), a portable game console, a portable information terminal, an audio reproducing device, and a large-sized game machine such as a pachinko machine. Examples of the portable information terminal include a laptop personal computer, a tablet terminal, an e-book reader, and a mobile phone.

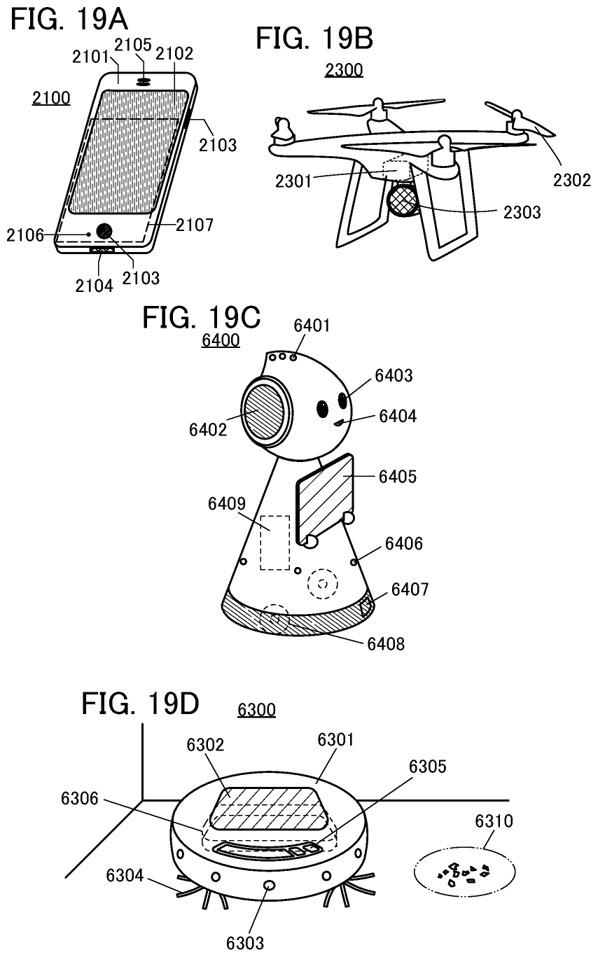

FIG. 19A illustrates an example of a mobile phone. A mobile phone 2100 includes a housing 2101 in which a display portion 2102 is incorporated, an operation button 2103, an external connection port 2104, a speaker 2105, a microphone 2106, and the like. The mobile phone 2100 includes a secondary battery 2107. The use of the secondary battery 2107 having a positive electrode using the positive electrode active material 100 described in Embodiments 1, 2, and the like achieves high capacity and a structure that accommodates space saving due to a reduction in size of the housing.

The mobile phone 2100 is capable of executing a variety of applications such as mobile phone calls, e-mailing, viewing and editing texts, music reproduction, Internet communication, and a computer game.

With the operation button 2103, a variety of functions such as time setting, power on/off, on/off of wireless communication, setting and cancellation of a silent mode, and setting and cancellation of a power saving mode can be performed. For example, the functions of the operation button 2103 can be set freely by the operating system incorporated in the mobile phone 2100.

The mobile phone 2100 can employ near field communication based on an existing communication standard. For example, mutual communication between the mobile phone 2100 and a headset capable of wireless communication can be performed, and thus hands-free calling is possible.

Moreover, the mobile phone 2100 includes the external connection port 2104, and data can be directly transmitted to and received from another information terminal via a connector. In addition, charge can be performed via the external connection port 2104. Note that the charge operation may be performed by wireless power feeding without using the external connection port 2104.

The mobile phone 2100 preferably includes a sensor. As the sensor, a human body sensor such as a fingerprint sensor, a pulse sensor, or a temperature sensor, a touch sensor, a pressure sensitive sensor, or an acceleration sensor is preferably mounted, for example.

FIG. 19B illustrates an unmanned aircraft 2300 including a plurality of rotors 2302. The unmanned aircraft 2300 is also referred to as a drone. The unmanned aircraft 2300 includes a secondary battery 2301 of one embodiment of the present invention, a camera 2303, and an antenna (not illustrated). The unmanned aircraft 2300 can be remotely controlled through the antenna. A secondary battery including a positive electrode using the positive electrode active material 100 obtained in Embodiments 1, 2, and the like has a high energy density and a high degree of safety, and thus can be used safely for a long time over a long period of time and is preferable as the secondary battery included in the unmanned aircraft 2300.

FIG. 19C illustrates an example of a robot. A robot 6400 illustrated in FIG. 19C includes a secondary battery 6409, an illuminance sensor 6401, a microphone 6402, an upper camera 6403, a speaker 6404, a display portion 6405, a lower camera 6406, an obstacle sensor 6407, a moving mechanism 6408, an arithmetic device, and the like.

The microphone 6402 has a function of detecting a speaking voice of a user, an environmental sound, and the like. The speaker 6404 has a function of outputting sound. The robot 6400 can communicate with the user using the microphone 6402 and the speaker 6404.

The display portion 6405 has a function of displaying various kinds of information. The robot 6400 can display information desired by the user on the display portion 6405. The display portion 6405 may be provided with a touch panel. Moreover, the display portion 6405 may be a detachable information terminal, in which case charge and data communication can be performed when the display portion 6405 is set at the home position of the robot 6400.

The upper camera 6403 and the lower camera 6406 each have a function of taking an image of the surroundings of the robot 6400. The obstacle sensor 6407 can detect an obstacle in the direction where the robot 6400 advances with the moving mechanism 6408. The robot 6400 can move safely by recognizing the surroundings with the upper camera 6403, the lower camera 6406, and the obstacle sensor 6407.

The robot 6400 further includes, in its inner region, the secondary battery 6409 of one embodiment of the present invention and a semiconductor device or an electronic component. A secondary battery including a positive electrode using the positive electrode active material 100 obtained in Embodiments 1, 2, and the like has a high energy density and a high degree of safety, and thus can be used safely for a long time over a long period of time and is preferable as the secondary battery 6409 included in the robot 6400.

FIG. 19D illustrates an example of a cleaning robot. A cleaning robot 6300 includes a display portion 6302 placed on the top surface of a housing 6301, a plurality of cameras 6303 placed on the side surface of the housing 6301, a brush 6304, operation buttons 6305, a secondary battery 6306, a variety of sensors, and the like. Although not illustrated, the cleaning robot 6300 is provided with a tire, an inlet, and the like. The cleaning robot 6300 is self-propelled, detects dust 6310, and sucks up the dust through the inlet provided on the bottom surface.

The cleaning robot 6300 can determine whether there is an obstacle such as a wall, furniture, or a step by analyzing images taken by the cameras 6303. In the case where the cleaning robot 6300 detects an object that is likely to be caught in the brush 6304 (e.g., a wire) by image analysis, the rotation of the brush 6304 can be stopped. The cleaning robot 6300 further includes, in its inner region, the secondary battery 6306 of one embodiment of the present invention and a semiconductor device or an electronic component. A secondary battery including a positive electrode using the positive electrode active material 100 obtained in Embodiments 1, 2, and the like has a high energy density and a high degree of safety, and thus can be used safely for a long time over a long period of time and is preferable as the secondary battery 6306 included in the cleaning robot 6300.

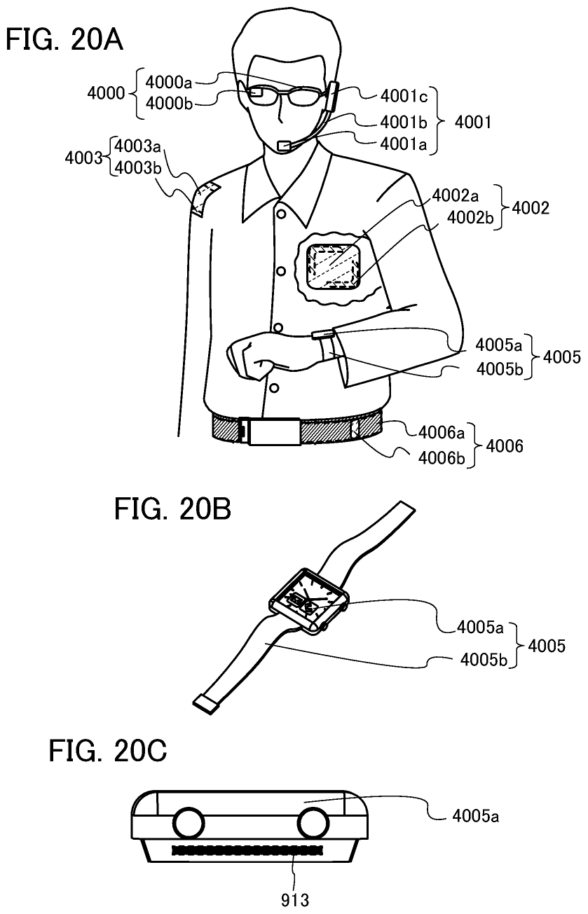

FIG. 20A illustrates examples of wearable devices. A secondary battery is used as a power source of a wearable device. To have improved splash resistance, water resistance, or dust resistance in daily use or outdoor use by a user, a wearable device is desirably capable of being charged with and without a wire whose connector portion for connection is exposed.

For example, the secondary battery of one embodiment of the present invention can be provided in a glasses-type device 4000 illustrated in FIG. 20A. The glasses-type device 4000 includes a frame 4000a and a display portion 4000b. The secondary battery is provided in a temple of the frame 4000a having a curved shape, whereby the glasses-type device 4000 can be lightweight, can have a well-balanced weight, and can be used continuously for a long time. A secondary battery including a positive electrode using the positive electrode active material 100 obtained in Embodiments 1, 2, and the like has a high energy density and achieves a structure that accommodates space saving due to a reduction in size of the housing.

The secondary battery of one embodiment of the present invention can be provided in a headset-type device 4001. The headset-type device 4001 includes at least a microphone part 4001a, a flexible pipe 4001b, and an earphone portion 4001c. The secondary battery can be provided in the flexible pipe 4001b or the earphone portion 4001c. A secondary battery including a positive electrode using the positive electrode active material 100 obtained in Embodiments 1, 2, and the like has a high energy density and achieves a structure that accommodates space saving due to a reduction in size of the housing.

The secondary battery of one embodiment of the present invention can be provided in a device 4002 that can be attached directly to a body. A secondary battery 4002b can be provided in a thin housing 4002a of the device 4002. A secondary battery including a positive electrode using the positive electrode active material 100 obtained in Embodiments 1, 2, and the like has a high energy density and achieves a structure that accommodates space saving due to a reduction in size of the housing.

The secondary battery of one embodiment of the present invention can be provided in a device 4003 that can be attached to clothes. A secondary battery 4003b can be provided in a thin housing 4003a of the device 4003. A secondary battery including a positive electrode using the positive electrode active material 100 obtained in Embodiments 1, 2, and the like has a high energy density and achieves a structure that accommodates space saving due to a reduction in size of the housing.

The secondary battery of one embodiment of the present invention can be provided in a belt-type device 4006. The belt-type device 4006 includes a belt portion 4006a and a wireless power feeding and receiving portion 4006b, and the secondary battery can be provided in the inner region of the belt portion 4006a. A secondary battery including a positive electrode using the positive electrode active material 100 obtained in Embodiments 1, 2, and the like has a high energy density and achieves a structure that accommodates space saving due to a reduction in size of the housing.

The secondary battery of one embodiment of the present invention can be provided in a watch-type device 4005. The watch-type device 4005 includes a display portion 4005a and a belt portion 4005b, and the secondary battery can be provided in the display portion 4005a or the belt portion 4005b. A secondary battery including a positive electrode using the positive electrode active material 100 obtained in Embodiments 1, 2, and the like has a high energy density and achieves a structure that accommodates space saving due to a reduction in size of the housing.

The display portion 4005a can display various kinds of information such as time and reception information of an e-mail or an incoming call.

The watch-type device 4005 is a wearable device that is wound around an arm directly; thus, a sensor that measures the pulse, the blood pressure, or the like of the user may be incorporated therein. Data on the exercise quantity and health of the user can be stored to be used for health maintenance.

FIG. 20B is a perspective view of the watch-type device 4005 that is detached from an arm.

FIG. 20C is a side view of the watch-type device 4005. FIG. 20C illustrates a state where the secondary battery 913 is incorporated in the inner region. The secondary battery 913 is the secondary battery described in Embodiment 4. The secondary battery 913 is provided to overlap the display portion 4005a, can have a high density and high capacity, and is small and lightweight.

Since the secondary battery in the watch-type device 4005 is required to be small and lightweight, the use of the positive electrode active material 100 obtained in Embodiments 1, 2, and the like in the positive electrode enables the secondary battery 913 to have a high energy density and a small size.

### Example 1

<Fabrication method of Sample 1>

This example explains that the positive electrode active material 100 (Sample 1) with a median diameter of less than or equal to 12 μm can be obtained based on the description in Embodiment 1 and FIG. 5, FIGS. 6A to 6C, and the like.

As the lithium cobalt oxide (LiCoO₂) that is a starting material in Step S10 in FIG. 5, commercially available lithium cobalt oxide (C-5H produced by NIPPON CHEMICAL INDUSTRIAL CO., LTD.) (hereinafter simply referred to as “C-5H” in this specification and the like) not containing any additive element was prepared. The median diameter of C-5H is approximately 7.0 μm, which satisfies the condition where the median diameter is less than or equal to 10 μm.

Next, the heating in Step S15 was performed on C-5H, which was put in a sagger (container) covered with a lid, in a muffle furnace at 850° C. for 2 hours. No flowing was performed after the muffle furnace was filled with an oxygen atmosphere (i.e., O₂ purging was performed).

Next, in accordance with Step S20a shown in FIG. 6A, the additive element A1 source was formed. First, lithium fluoride (LiF) and magnesium fluoride (MgF₂) were prepared as the F source and the Mg source, respectively. The LiF and the MgF₂ were weighed so that LiF:MgF₂=1:3 (molar ratio). Then, the LiF and the MgF₂ were mixed into dehydrated acetone and the mixture was stirred at a rotating speed of 500 rpm for 20 hours. In the mixing, a ball mill was used and a grinding medium was zirconium oxide balls. In the mixing ball mill with a capacity of 45 mL, the additive element A1 source weighing approximately 10 g in total was put together with 20 mL of dehydrated acetone and 22 g of zirconium oxide balls (1 mm ϕ) and mixed. Then, the mixture was made to pass through a sieve with an aperture of 300 μm, whereby the additive element A1 source was obtained.

Next, in accordance with Step S31 shown in FIG. 5, the lithium cobalt oxide (lithium cobalt oxide subjected to the initial heating) obtained by the heating in Step S15 and the additive element A1 source obtained in Step S20a were mixed. Specifically, the materials were weighed so that the number of magnesium atoms was 1 atom % of the number of cobalt atoms in the lithium cobalt oxide, and then the lithium cobalt oxide subjected to the initial heating and the additive element A1 source were mixed by a dry method. At this time, stirring was performed at a rotating speed of 150 rpm for 1 hour. Then, the mixture was made to pass through a sieve with an aperture of 300 μm, whereby the mixture 903 was obtained (Step S32).

Next, as Step S33, the mixture 903 was heated. The heating was performed at 900° C. for 5 hours. During the heating, the mixture 903 was in a sagger covered with a lid. The sagger was filled with an atmosphere containing oxygen and entry and exit of the oxygen were blocked (purged). By the heating, a composite oxide containing Mg and F (lithium cobalt oxide containing Mg and F) was obtained (Step S34a).

Next, in accordance with Step S40 shown in FIG. 6C, the additive element A2 source was formed. First, nickel hydroxide (Ni(OH)₂) and aluminum hydroxide (Al(OH)₃) were prepared as the Ni source and the A1 source, respectively. Next, the nickel hydroxide and the aluminum hydroxide were separately stirred in dehydrated acetone at a rotating speed of 500 rpm for 20 hours. In the mixing, a ball mill was used and a grinding medium was zirconium oxide balls. In the mixing ball mill with a capacity of 45 mL, the nickel hydroxide and the aluminum hydroxide each weighing approximately 10 g were put together with 20 mL of dehydrated acetone and 22 g of zirconium oxide balls (1 mm ϕ) and stirred. Then, each of the nickel hydroxide and the aluminum hydroxide were made to pass through a sieve with an aperture of 300 μm, whereby the additive element A2 source was obtained.

Next, as Step S51, the composite oxide containing Mg and F and the additive element A2 source were mixed by a dry method specifically, the mixing was performed by being stirred at a rotating speed of 150 rpm for 1 hour. The mixture ratio was set so that each of the number of moles of the nickel hydroxide and the number of moles of the aluminum hydroxide contained in the additive element A2 source was 0.5 mol % of the number of moles of the lithium cobalt oxide. In the mixing, a ball mill was used and a grinding medium was zirconium oxide balls. In the mixing ball mill with a capacity of 45 mL, the Ni source, the A1 source, and the composite oxide (lithium cobalt oxide containing Mg and F) obtained in Step S34 weighing approximately 7.5 g in total were put together with 22 g of zirconium oxide balls (1 mm ϕ) and mixed. Finally, the mixture was made to pass through a sieve with an aperture of 300 μm, whereby a mixture 904 was obtained (Step S52).

Next, as Step S53, the mixture 904 was heated. The heating was performed at 850° C. for 2 hours. During the heating, the mixture 904 was in a sagger covered with a lid in a muffle furnace. No flowing was performed after the muffle furnace was filled with an oxygen atmosphere (i.e., O₂ purging was performed). By the heating, lithium cobalt oxide (composite oxide) containing Mg, F, Ni, and Al was obtained (Step S54). In this specification and the like, the lithium cobalt oxide containing Mg, F, Ni, and Al obtained in this example is hereinafter referred to as Sample 1 in some cases. Note that as the result of the STEM-EDX analysis of Sample 1, Mg has distribution as illustrated in FIGS. 3A and 3D, Al has distribution as illustrated in FIGS. 3B and 3E, and Ni has distribution as illustrated in FIGS. 3C and 3F.

### <Median Diameter of Sample 1>

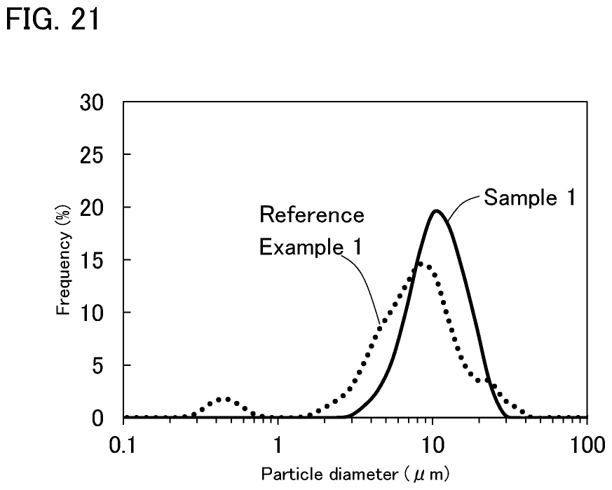

FIG. 21 shows particle size distribution of Sample 1 by a solid line. The median diameter (D50) of Sample 1 was approximately 9.7 μm. As a result, it was found that the median diameter of Sample 1 was less than or equal to 12 μm (less than or equal to 10.5 μm). Note that the median diameter (D50) can be, for example, measured with a particle size distribution analyzer or the like using a laser diffraction and scattering method or by observation with a scanning electron microscope (SEM) or a TEM. In this example, a laser diffraction particle size analyzer SALD-2200 produced by Shimadzu Corporation was used for the measurement.

Note that FIG. 21 shows particle size distribution by a dotted line. Reference Example 1 was the commercially available lithium cobalt oxide (C-5H produced by NIPPON CHEMICAL INDUSTRIAL CO., LTD.) and did not contain any additive element used as a starting material in this example. The median diameter (D50) of C-5H was approximately 7.0 μm.

### Example 2

### <Fabrication of Half Cell Using Sample 1 as Positive Electrode Active Material>

In this example, fabrication conditions of coin-type half cells (half cells 1 and 2) in which Sample 1 fabricated in Example 1 was used as a positive electrode active material are described.

First, Sample 1, acetylene black (AB), and polyvinylidene fluoride (PVDF) were prepared as a positive electrode active material, a conductive material, and a binding agent, respectively. Then, the positive electrode active material, AB, and PVDF were mixed in a weight ratio of 95:3:2 to prepare a slurry, and the slurry was applied on an aluminum positive electrode current collector. As a solvent of the slurry, N-methyl-2-pyrrolidone (NMP) was used.

Next, after the positive electrode current collector was coated with slurry, the solvent was volatilized, and a positive electrode active material layer was formed over the positive electrode current collector.

After that, pressing was performed with a roller press machine to increase the density of the positive electrode active material layer over the positive electrode current collector. The pressing was performed with linear pressure of 210 kN/m. Note that the temperature of an upper roll and a lower roll of the roller press machine was 120° C.

Through the above steps, the positive electrode was obtained. In the positive electrode, the loading level of the active material was approximately 7 mg/cm².

The electrolyte solution used for the half cells 1 and 2 contains an organic solvent. The organic solvent contains ethylene carbonate (EC), ethyl methyl carbonate (EMC), and dimethyl carbonate (DMC). When a total content of EC, EMC, and DMC was set to 100 vol %, an organic solvent in which the volume ratio of EC, EMC, and DMC was x:y:100−x−y (note that 5≤x≤35 and 0<y<65) was prepared. More specifically, an organic solvent containing EC, EMC, and DMC at EC:EMC:DMC=30:35:35 in a volume ratio was prepared. A solution in which lithium hexafluorophosphate (LiPF₆) was dissolved in this organic solvent at a concentration of 1 mol/L was used as the electrolyte solution.

A general electrolyte solution used for a lithium ion battery can be solidified at approximately −20° C.; thus, it is difficult to fabricate a battery that can be charged and discharged at −40° C. The electrolyte solution used in this example has a freezing point at lower than or equal to −40° C., which is one of the conditions to achieve a lithium ion battery that can be charged and discharged even in an extremely low-temperature environment such as at −40° C.

As a separator, a polypropylene porous film was used. As a negative electrode (counter electrode), a lithium metal was used. The coin-type half cells (the half cells 1 and 2) were fabricated using the separator and the negative electrode.

### Example 3

In this example, measurement results of the half cells 1 and 2 fabricated in Example 2 are described.

### <Aging of Half Cell>

As aging of the half cells 1 and 2, charge and discharge were repeated three times at 25° C. The charge was performed in the following manner: constant current charge was performed at charge current of 0.1 C (1 C=200 mA/g) until the voltage reached 4.60 V, and constant voltage charge was successively performed at 4.60 V until the charge current was lower than or equal to 0.01 C. In the discharge, constant current discharge was performed at a discharge rate of 0.1 C until the voltage reached 2.5 V (cutoff voltage). Note that the current of 0.1 C can be referred to as current of 20 mA/g per positive electrode active material weight, and the current of 0.01 C can be referred to as current of 2 mA/g per positive electrode active material weight.

### <Discharge Capacity Measurement at Each Temperature>

With the use of the half cell 1 on which the aging treatment was performed, charge capacity and discharge capacity were measured in a low-temperature environment as discharge capacity measurement at each temperature. As the measurement, charge capacity and discharge capacity were measured at each temperature in the following order: charge and discharge at 20° C.; charge and discharge at −40° C.; charge and discharge at −30° C.; charge and discharge at −20° C.; charge and discharge at −10° C.; and charge and discharge at 0° C.

At each temperature, the charge was performed in the following manner: constant current charge was performed at charge current of 0.1 C until the voltage reached 4.60 V, and constant voltage charge was successively performed at 4.60 V until the charge current was lower than or equal to 0.01 C. In the discharge, constant current discharge was performed at a discharge rate of 0.1 C until the voltage reached 2.5 V (cutoff voltage). Note that the current of 0.1 C can be referred to as current of 20 mA/g per positive electrode active material weight, and the current of 0.01 C can be referred to as current of 2 mA/g per positive electrode active material weight.

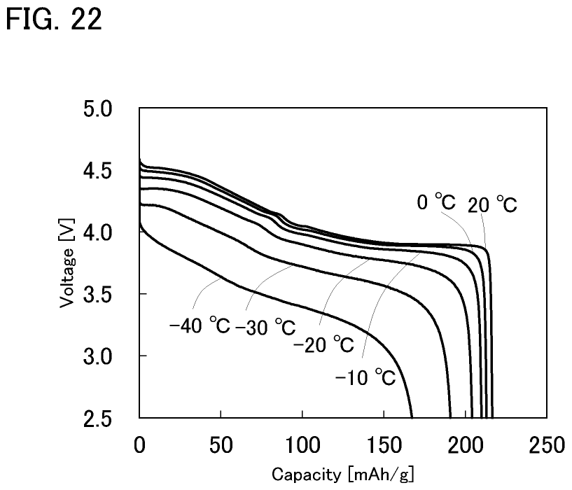

Table 1 shows the measurement results. In Table 1, the first column represents temperature conditions, the second column represents charge capacity per positive electrode active material weight, the third column represents discharge capacity per positive electrode active material weight, and the fourth column represents discharge capacity of the half cell 1. In the fifth column, discharge capacity at each temperature is shown as a discharge capacity rate (%) when discharge capacity at 20° C. is 100%. FIG. 22 shows discharge curves at each temperature.

TABLE 1

| | Charge | | | Discharge |
|---|---|---|---|---|
| Temper- | capacity | Discharge | Discharge | capacity rate |
| ature | [mAh/g] | capacity [mAh/g] | capacity [mAh] | [%] |
| 20° C. | 219.0 | 216.6 | 1.75 | 100.0 |
| −40° C. | 181.3 | 167.3 | 1.35 | 77.2 |
| −30° C. | 185.3 | 190.9 | 1.54 | 88.1 |
| −20° C. | 201.7 | 204.1 | 1.65 | 94.2 |
| −10° C. | 209.3 | 210.0 | 1.69 | 96.9 |
| 0° C. | 213.3 | 213.1 | 1.72 | 98.4 |

According to the measurement results of charge and discharge in a low-temperature environment, the following favorable results of the half cell 1 that is the secondary battery of one embodiment of the present invention were obtained when the discharge capacity value measured in charge and discharge at 20° C. was 100%. The discharge capacity value measured in charge and discharge at −40° C. was 77.2%, which is a favorable result of exceeding 75%. The discharge capacity value measured in charge and discharge at −30° C. was 88.1%, which is a favorable result of exceeding 85%. The discharge capacity value measured in charge and discharge at −20° C. was 94.2%, which is a favorable result of exceeding 90%. The discharge capacity value measured in charge and discharge at −10° C. was 96.9%, which is a favorable result of exceeding 95%. The discharge capacity value measured in charge and discharge at 0° C. was 98.1%, which is a favorable result of exceeding 98%.

### <Discharge Capacity Measurement at Each Rate>

With the use of the half cell 2 on which the aging treatment was performed, charge capacity and discharge capacity were measured at −40° C. as discharge capacity measurement at each rate (also referred to as at each discharge current value, at each discharge speed, or the like) under six kinds of discharge conditions. The discharge current value varies under the six kinds of discharge conditions, and the measurement was performed at 0.02 C, 0.1 C, 0.2 C, 0.3 C, 0.5 C, and 1 C in this order. Before the discharge under each of the discharge conditions, charge was performed under the common charge condition. Note that the current of 0.02 C can be referred to as current of 4 mA/g per positive electrode active material weight, the current of 0.1 C can be referred to as current of 20 mA/g per positive electrode active material weight, the current of 0.2 C can be referred to as current of 40 mA/g per positive electrode active material weight, the current of 0.3 C can be referred to as current of 60 mA/g per positive electrode active material weight, the current of 0.5 C can be referred to as current of 100 mA/g per positive electrode active material weight, and the current of 1 C can be referred to as current of 200 mA/g current per positive electrode active material weight.

The charge was performed in the following manner: constant current charge was performed at charge current of 0.1 C until the voltage reached 4.60 V, and constant voltage charge was successively performed at 4.60 V until the charge current was lower than or equal to 0.01 C. In the discharge, constant current discharge was performed under the six kinds of conditions until the voltage reached 2.5 V (cutoff voltage).

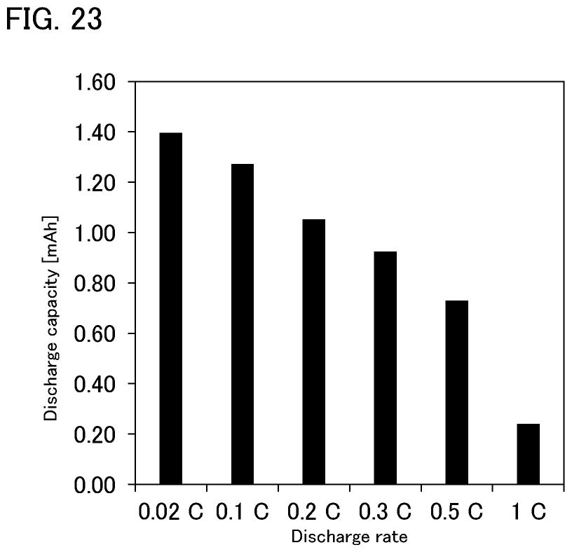

Table 2 shows the measurement results. In Table 2, the first column represents discharge current conditions, the second column represents charge capacity per positive electrode active material weight, the third column represents discharge capacity per positive electrode active material weight, and the fourth column represents discharge capacity of the half cell 2. In the fifth column, discharge capacity under each discharge current condition is shown as a discharge capacity rate (%) when discharge capacity of 0.1 C is 100%. FIG. 23 is a graph showing discharge capacity at each discharge rate.

TABLE 2

| | Charge | | | Discharge |
|---|---|---|---|---|
| Discharge | capacity | Discharge | Discharge | capacity rate |
| rate [C] | [mAh/g] | capacity [mAh/g] | capacity [mAh] | [%] |
| 0.02 | 173.2 | 167.6 | 1.40 | 109.7 |
| 0.1 | 170.5 | 152.7 | 1.27 | 100.0 |
| 0.2 | 150.4 | 126.4 | 1.05 | 82.7 |
| 0.3 | 125.2 | 111.0 | 0.92 | 72.7 |
| 0.5 | 111.2 | 87.5 | 0.73 | 57.3 |
| 1 | 88.2 | 28.8 | 0.24 | 18.8 |

According to the measurement results of charge and discharge at −40° C., the following favorable results of the half cell 2 that is the secondary battery of one embodiment of the present invention were obtained when the discharge capacity value measured at discharge current of 0.1 C was 100%. The discharge capacity value measured at discharge current of 0.2 C was 82.7%, which is a favorable result of exceeding 80%. The discharge capacity value measured at discharge current of 0.3 C was 72.7%, which is a favorable result of exceeding 70%. The discharge capacity value measured at discharge current of 0.5 C was 57.3%, which is a favorable result of exceeding 50%. Note that the half cell 2 can be discharged even at discharge current of 1 C, and the discharge capacity value was 18.8%. That is, it can be said that the secondary battery of one embodiment of the present invention has high discharge characteristics at −40° C.

The charge and discharge measurement at −40° C. revealed that charge and discharge efficiency (proportion of discharge capacity to charge capacity) was high at discharge current of 0.02 C.

As described in the above examples, it was found that a lithium ion battery including the positive electrode active material obtained by the formation method described in Embodiment 2 and the like can be charged and discharged at least in a temperature range of higher than or equal to −40° C. and lower than or equal to 20° C. It was also found that the lithium ion battery further including the electrolyte described in Embodiment 1 can be extremely excellent in charge and discharge in a temperature range of higher than or equal to −40° C. and lower than or equal to 20° C.

This application is based on Japanese Patent Application Serial No. 2022-052082 filed with Japan Patent Office on Mar. 28, 2022, the entire contents of which are hereby incorporated by reference.

What is claimed is:

1. A lithium ion battery comprising:
a positive electrode active material; and
an electrolyte,
wherein the positive electrode active material contains cobalt, oxygen, magnesium, aluminum, and nickel,
wherein the electrolyte contains lithium hexafluorophosphate, ethylene carbonate, ethyl methyl carbonate, and dimethyl carbonate,
wherein second discharge capacity of the lithium ion battery is higher than or equal to 70% of first discharge capacity,
wherein the first discharge capacity is obtained by performing first charge at 20° C. and then performing first discharge at 20° C.,
wherein the second discharge capacity is obtained by performing second charge at −40° C. and then performing second discharge at −40° C., and
wherein each of the first discharge and the second discharge is performed by constant current discharge with current of 20 mA/g per positive electrode active material weight.

2. The lithium ion battery according to claim 1,
wherein the positive electrode active material contains magnesium and aluminum in a surface portion,
wherein the surface portion is a region from a surface of the positive electrode active material to a depth of 50 nm, and
wherein the positive electrode active material comprises a region where distribution of magnesium is closer to the surface than distribution of aluminum.

3. The lithium ion battery according to claim 2,
wherein the positive electrode active material has a layered rock-salt crystal structure of a space group R-3m,
wherein the surface portion comprises a basal region having a surface of the positive electrode active material parallel to a (001) plane of the layered rock-salt crystal structure, and an edge region having a surface of the positive electrode active material exposed in a direction intersecting with the (001) plane,
wherein the edge region contains nickel, and
wherein distribution of magnesium and distribution of nickel comprise a region overlapping with each other in the edge region.

4. The lithium ion battery according to claim 3, wherein the basal region does not substantially contain nickel.

5. The lithium ion battery according to claim 3, wherein a median diameter of the positive electrode active material is greater than or equal to 1 μm and less than or equal to 12 μm.

6. The lithium ion battery according to claim 1,
wherein in the electrolyte, a volume ratio of the ethylene carbonate, the ethyl methyl carbonate, and the dimethyl carbonate is x:y:100−x−y when a total content of the ethylene carbonate, the ethyl methyl carbonate, and the dimethyl carbonate is 100 vol %, and
wherein x is 5≤x≤35 and y is 0<y<65.

7. The lithium ion battery according to claim 6,
wherein the electrolyte contains the lithium hexafluorophosphate, and
wherein the amount of the lithium hexafluorophosphate is more than or equal to 0.5 mol/L and less than or equal to 1.5 mol/L with respect to the total content of the ethylene carbonate, the ethyl methyl carbonate, and the dimethyl carbonate.

8. The lithium ion battery according to claim 1,
wherein each of the first charge and the second charge is performed by constant current charge with current of 20 mA/g per the positive electrode active material weight until voltage reaches 4.60 V and constant voltage charge at 4.60 V until current is lower than or equal to 2 mA/g per the positive electrode active material weight.

9. An electronic device comprising the lithium ion battery according to claim 1.

10. A vehicle comprising the lithium ion battery according to claim 1.

11. A lithium ion battery comprising:
a positive electrode active material; and
an electrolyte,
wherein the positive electrode active material contains cobalt, oxygen, magnesium, aluminum, and nickel,
wherein a concentration peak of aluminum is positioned deeper than a concentration peak of magnesium,
wherein the electrolyte contains lithium hexafluorophosphate, ethylene carbonate, ethyl methyl carbonate, and dimethyl carbonate,
wherein second discharge capacity of the lithium ion battery is higher than or equal to 70% of first discharge capacity,
wherein the first discharge capacity is obtained by performing first charge at 20° C. and then performing first discharge at 20° C.,
wherein the second discharge capacity is obtained by performing second charge at −40° C. and then performing second discharge at −40° C., and
wherein each of the first discharge and the second discharge is performed by constant current discharge with current of 20 mA/g per positive electrode active material weight.

12. The lithium ion battery according to claim 11,
wherein the positive electrode active material contains magnesium and aluminum in a surface portion, and
wherein the surface portion is a region from a surface of the positive electrode active material to a depth of 50 nm.

13. The lithium ion battery according to claim 12,
wherein the positive electrode active material has a layered rock-salt crystal structure of a space group R-3m,
wherein the surface portion comprises a basal region having a surface of the positive electrode active material parallel to a (001) plane of the layered rock-salt crystal structure, and an edge region having a surface of the positive electrode active material exposed in a direction intersecting with the (001) plane,
wherein the edge region contains nickel, and
wherein distribution of magnesium and distribution of nickel comprise a region overlapping with each other in the edge region.

14. The lithium ion battery according to claim 13, wherein the basal region does not substantially contain nickel.

15. The lithium ion battery according to claim 13, wherein a median diameter of the positive electrode active material is greater than or equal to 1 μm and less than or equal to 12 μm.

16. The lithium ion battery according to claim 11,
wherein in the electrolyte, a volume ratio of the ethylene carbonate, the ethyl methyl carbonate, and the dimethyl carbonate is x:y:100−x−y when a total content of the ethylene carbonate, the ethyl methyl carbonate, and the dimethyl carbonate is 100 vol %, and
wherein x is 5≤x≤35 and y is 0<y<65.

17. The lithium ion battery according to claim 16,
wherein the electrolyte contains the lithium hexafluorophosphate, and
wherein the amount of the lithium hexafluorophosphate is more than or equal to 0.5 mol/L and less than or equal to 1.5 mol/L with respect to the total content of the ethylene carbonate, the ethyl methyl carbonate, and the dimethyl carbonate.

18. The lithium ion battery according to claim 11,
wherein each of the first charge and the second charge is performed by constant current charge with current of 20 mA/g per the positive electrode active material weight until voltage reaches 4.60 V and constant voltage charge at 4.60 V until current is lower than or equal to 2 mA/g per the positive electrode active material weight.

19. An electronic device comprising the lithium ion battery according to claim 11.

20. A vehicle comprising the lithium ion battery according to claim 11.
